(19) United States
(12) Patent Application Publication
(10) Pub. No.: US 2026/0080167 A1
(43) Pub. Date: Mar. 19, 2026

(54) SYSTEM AND METHOD FOR VALIDATING LANGUAGE MODEL OUTPUT WITH NATURAL LANGUAGE PROCESSING

(71) Applicant: SAS Institute Inc., Cary, NC (US)

(72) Inventors: Teresa S. Jade, Cary, NC (US); Federica Citterio, Lissone (IT); Xiao Li, Beijing (CN); Fan Wang, Beijing (CN); Seng Lee, Raleigh, NC (US)

(73) Assignee: SAS Institute Inc., Cary, NC (US)

(21) Appl. No.: 19/256,590

(22) Filed: Jul. 1, 2025

Related U.S. Application Data
(60) Provisional application No. 63/667,303, filed on Jul. 3, 2024.
(60) Provisional application No. 63/669,341, filed on Jul. 10, 2024.
(60) Provisional application No. 63/673,873, filed on Jul. 22, 2024.
(60) Provisional application No. 63/678,191, filed on Aug. 1, 2024.
(60) Provisional application No. 63/696,449, filed on Sep. 19, 2024.
(60) Provisional application No. 63/697,677, filed on Sep. 23, 2024.

(51) Int. Cl. G06F 40/226; G06F 40/247; G06F 40/284; G06F 40/289

(52) U.S. Cl. CPC G06F 40/226; G06F 40/247; G06F 40/284; G06F 40/289

(57) ABSTRACT

A data processing system and method for validating a language model includes executing the language model to extract a plurality of strings from a set of documents and for each string, parsing the string to generate a plurality of tokens, lemmatizing the plurality of tokens, applying a part-of-speech label to the plurality of tokens, executing a filtering operation to obtain a plurality of filtered tokens, automatically building a weighted categorization rule based on the plurality of filtered tokens, applying the weighted categorization rule to the set of documents to identify one or more text spans from the set of documents, computing a relevancy score for each of the one or more text spans extracted from the set of documents, and selecting the one or more text spans extracted from the set of documents having the relevancy score greater than a predetermined threshold.

### CROSS-REFERENCE TO RELATED APPLICATIONS

This application is a non-provisional of U.S. Provisional Application No. 63/667,303, filed on Jul. 3, 2024, U.S. Provisional Application No. 63/669,341, filed on Jul. 10, 2024, U.S. Provisional Application No. 63/673,873, filed on Jul. 22, 2024, U.S. Provisional Application No. 63/696,449, filed on Sep. 19, 2024, U.S. Provisional Application No. 63/678,191, filed on Aug. 1, 2024, and U.S. Provisional Application No. 63/697,677, filed on Sep. 23, 2024, the entireties of which are incorporated by reference herein.

### BACKGROUND

Large Language Models (LLMs) are advanced artificial intelligence models designed to analyze and generate human-like text. LLMs may be used across a wide range of applications across industries. For example, LLMs may be used for content generation (e.g., to create blog posts, articles, marketing materials, etc.), customer support (e.g., via LLM powered chatbots), code assistance (e.g., for debugging code, code generation, etc.), healthcare (e.g., assist with medical research, summarizing patient healthcare records, etc.), education (e.g., generating study materials, answering questions, etc.), legal & compliance (e.g., analyzing contracts, summarizing legal documents, etc.), finance (fraud detection, risk assessment, etc.), e-commerce (e.g., product recommendations, generating shopping experiences, etc.), among many other applications. Although LLMs are powerful, they suffer from limitations such as computational constraints, hallucinations and inaccuracies, limited knowledge, lack of long-term memory, etc. These limitations adversely impact the operability and applicability of LLMs.

### SUMMARY

In accordance with at least some aspects of the present disclosure, a non-transitory computer-readable medium having computer-readable instructions stored thereon is disclosed. The computer-readable instructions when executed by a processor cause the processor to execute a language model to extract a plurality of strings from a set of documents based on a prompt; and validate the language model by confirming that information in the plurality of strings is found in at least one document of the set of documents, wherein to validate the language model, for each string of the plurality of strings, the computer-readable instructions further cause the processor to: parse the string to generate a plurality of tokens; lemmatize each of the plurality of tokens; apply a part-of-speech label to each of the plurality of tokens; execute a filtering operation on each of the plurality of tokens that have been lemmatized and to which the part-of-speech labels have been applied to obtain a plurality of filtered tokens; automatically build a weighted categorization rule based on the plurality of filtered tokens, wherein building the weighted categorization rule comprises computing a term weight for each token of the plurality of filtered tokens; apply the weighted categorization rule to the set of documents to identify one or more text spans from the set of documents; compute a relevancy score for each of the one or more text spans extracted from the set of documents; and select the one or more text spans extracted from the set of documents having the relevancy score greater than a predetermined threshold, wherein the greater the relevancy score, the greater a match between a text span of the one or more text spans and the string of the plurality of strings.

In accordance with at least some other aspects of the present disclosure, a system is disclosed. The system includes a memory having computer-readable instructions stored thereon and a processor that executes the computer-readable instructions to execute a language model to extract a plurality of strings from a set of documents based on a prompt; and validate the language model by confirming that information in the plurality of strings is found in at least one document of the set of documents, wherein to validate the language model, for each string of the plurality of strings, the computer-readable instructions further cause the processor to: parse the string to generate a plurality of tokens; lemmatize each of the plurality of tokens; apply a part-of-speech label to each of the plurality of tokens; execute a filtering operation on each of the plurality of tokens that have been lemmatized and to which the part-of-speech labels have been applied to obtain a plurality of filtered tokens; automatically build a weighted categorization rule based on the plurality of filtered tokens, wherein building the weighted categorization rule comprises computing a term weight for each token of the plurality of filtered tokens; apply the weighted categorization rule to the set of documents to identify one or more text spans from the set of documents; compute a relevancy score for each of the one or more text spans extracted from the set of documents; and select the one or more text spans extracted from the set of documents having the relevancy score greater than a predetermined threshold, wherein the greater the relevancy score, the greater a match between a text span of the one or more text spans and the string of the plurality of strings.

In accordance with at least some other aspects of the present disclosure, a method is disclosed. The method includes executing, by a processor executing computer-readable instructions stored on a memory, a language model to extract a plurality of strings from a set of documents based on a prompt; and validating, by the processor, the language model by confirming that information in the plurality of strings is found in at least one document of the set of documents, wherein to validate the language model, for each string of the plurality of strings, the method comprises: parsing, by the processor, the string to generate a plurality of tokens; lemmatizing, by the processor, each of the plurality of tokens; applying, by the processor, a part-of-speech label to each of the plurality of tokens; executing, by the processor, a filtering operation on each of the plurality of tokens that have been lemmatized and to which the part-of-speech labels have been applied to obtain a plurality of filtered tokens; automatically building, by the processor, a weighted categorization rule based on the plurality of filtered tokens, wherein building the weighted categorization rule comprises computing a term weight for each token of the plurality of filtered tokens; applying, by the processor, the weighted categorization rule to the set of documents to identify one or more text spans from the set of documents; computing, by the processor, a relevancy score for each of the one or more text spans extracted from the set of documents; and selecting, by the processor, the one or more text spans extracted from the set of documents having the relevancy score greater than a predetermined threshold, wherein the greater the relevancy score, the greater a match between a text span of the one or more text spans and the string of the plurality of strings.

The foregoing summary is illustrative only and is not intended to be limiting in any way. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 illustrates a block diagram that provides an illustration of the hardware components of a computing system, according to some embodiments of the present technology.

FIG. 2 illustrates an example network including an example set of devices communicating with each other over an exchange system and via a network, according to some embodiments of the present technology.

FIG. 3 illustrates a representation of a conceptual model of a communications protocol system, according to some embodiments of the present technology.

FIG. 4 illustrates a communications grid computing system including a variety of control and worker nodes, according to some embodiments of the present technology.

FIG. 5 illustrates a flow chart showing an example process for adjusting a communications grid or a work project in a communications grid after a failure of a node, according to some embodiments of the present technology.

FIG. 6 illustrates a portion of a communications grid computing system including a control node and a worker node, according to some embodiments of the present technology.

FIG. 7 illustrates a flow chart showing an example process for executing a data analysis or processing project, according to some embodiments of the present technology.

FIG. 8 illustrates a block diagram including components of an Event Stream Processing Engine (ESPE), according to embodiments of the present technology.

FIG. 9 illustrates a flow chart showing an example process including operations performed by an event stream processing engine, according to some embodiments of the present technology.

FIG. 10 illustrates an ESP system interfacing between a publishing device and multiple event subscribing devices, according to embodiments of the present technology.

FIG. 11 illustrates a flow chart of an example of a process for generating and using a machine-learning model according to some aspects, according to embodiments of the present technology.

FIG. 12 illustrates an example of a machine-learning model as a neural network, according to embodiments of the present technology.

FIG. 13 illustrates various aspects of the use of containers as a mechanism to allocate processing, storage and/or other resources of a processing system to the performance of various analyses, according to embodiments of the present technology.

FIG. 14 illustrates a block diagram of an example validation system, according to embodiments of the present technology.

FIG. 15 illustrates a block diagram of an example validation application of the validation system of FIG. 14, according to embodiments of the present technology

FIG. 16 illustrates a flowchart outlining example operations for validating a language model using the validation system of FIG. 14, according to embodiments of the present technology.

FIG. 17 illustrates a flowchart outlining example operations of FIG. 16 in greater detail, according to embodiments of the present technology.

FIGS. 18A-18C illustrate an example of certain operations of FIG. 17, according to embodiments of the present technology.

FIG. 19 illustrates a flowchart outlining example operations for building a weighted categorization rule used in the process of FIG. 17, according to embodiments of the present technology.

FIG. 20 illustrates a flowchart outlining example operations for synonym augmentation used in the process of FIG. 17, according to embodiments of the present technology.

FIG. 21 illustrates an example screenshot showing an example of synonym augmentation, according to embodiments of the present technology.

The foregoing and other features of the present disclosure will become apparent from the following description and appended claims, taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

### DETAILED DESCRIPTION

In the following description, for the purposes of explanation, specific details are set forth in order to provide a thorough understanding of embodiments of the technology. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the technology as set forth in the appended claims.

Specific details are given in the following description to provide a thorough understanding of the embodiments. However, it will be understood by one of ordinary skills in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional operations not included in a figure. A process may correspond to a method, a function, a procedure, a subroutine, a subprogram, etc. When a process corresponds to a function, its termination can correspond to a return of the function to the calling function or the main function.

Systems depicted in some of the figures may be provided in various configurations. In some embodiments, the systems may be configured as a distributed system where one or more components of the system are distributed across one or more networks in a cloud computing system.

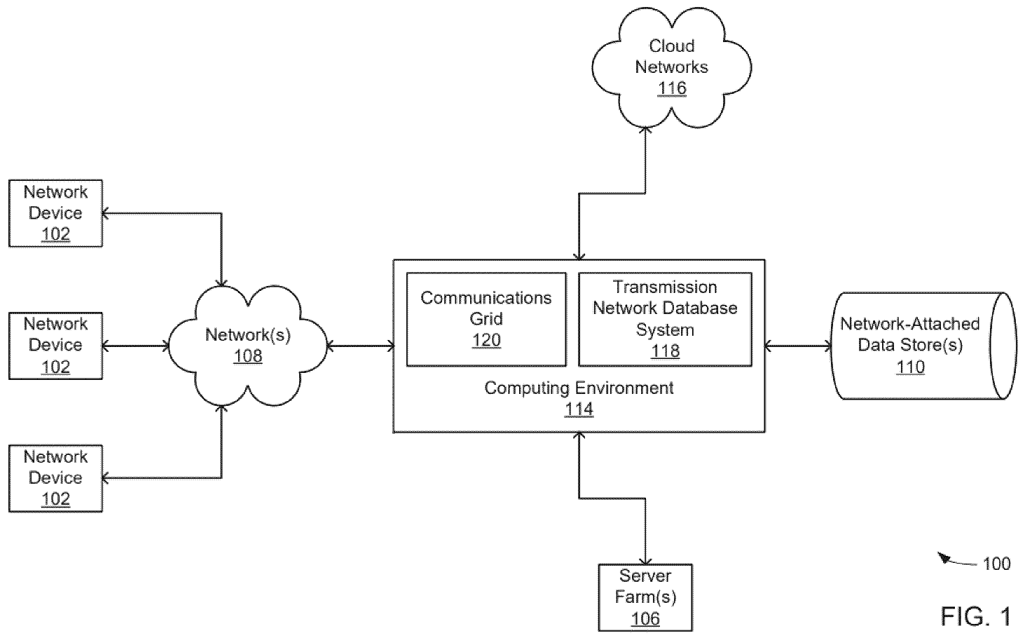

FIG. 1 is a block diagram that provides an illustration of the hardware components of a data transmission network 100, according to embodiments of the present technology. Data transmission network 100 is a specialized computer system that may be used for processing large amounts of data where a large number of computer processing cycles are required.

Data transmission network 100 may also include computing environment 114. Computing environment 114 may be a specialized computer or other machine that processes the data received within the data transmission network 100. Data transmission network 100 also includes one or more network devices 102. Network devices 102 may include client devices that attempt to communicate with computing environment 114. For example, network devices 102 may send data to the computing environment 114 to be processed, may send signals to the computing environment 114 to control different aspects of the computing environment or the data it is processing, among other reasons. Network devices 102 may interact with the computing environment 114 through a number of ways, such as, for example, over one or more networks 108. As shown in FIG. 1, computing environment 114 may include one or more other systems. For example, computing environment 114 may include a database system 118 and/or a communications grid 120.

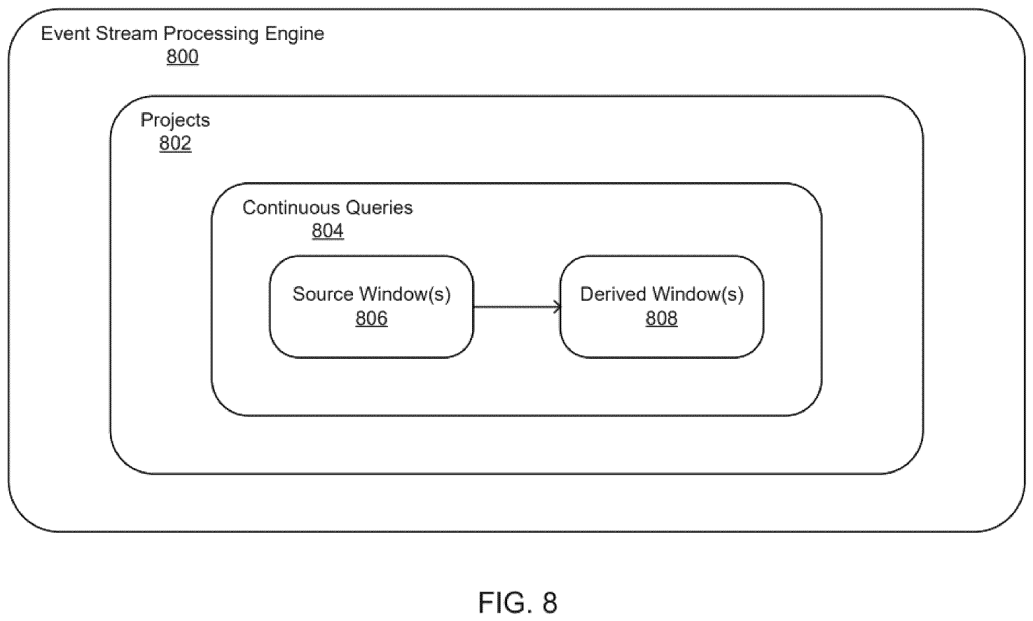

In other embodiments, network devices may provide a large amount of data, either all at once or streaming over a period of time (e.g., using event stream processing (ESP), described further with respect to FIGS. 8-10), to the computing environment 114 via networks 108. For example, network devices 102 may include network computers, sensors, databases, or other devices that may transmit or otherwise provide data to computing environment 114. For example, network devices may include local area network devices, such as routers, hubs, switches, or other computer networking devices. These devices may provide a variety of stored or generated data, such as network data or data specific to the network devices themselves. Network devices may also include sensors that monitor their environment or other devices to collect data regarding that environment or those devices, and such network devices may provide data they collect over time. Network devices may also include devices within the internet of things, such as devices within a home automation network. Some of these devices may be referred to as edge devices and may involve edge computing circuitry. Data may be transmitted by network devices directly to computing environment 114 or to network-attached data stores, such as network-attached data stores 110 for storage so that the data may be retrieved later by the computing environment 114 or other portions of data transmission network 100.

Data transmission network 100 may also include one or more network-attached data stores 110. Network-attached data stores 110 are used to store data to be processed by the computing environment 114 as well as any intermediate or final data generated by the computing system in non-volatile memory. However, in certain embodiments, the configuration of the computing environment 114 allows its operations to be performed such that intermediate and final data results can be stored solely in volatile memory (e.g., RAM), without a requirement that intermediate or final data results be stored to non-volatile types of memory (e.g., disk). This can be useful in certain situations, such as when the computing environment 114 receives ad hoc queries from a user and when responses, which are generated by processing large amounts of data, need to be generated on-the-fly. In this non-limiting situation, the computing environment 114 may be configured to retain the processed information within memory so that responses can be generated for the user at different levels of detail as well as allow a user to interactively query against this information.

Network-attached data stores may store a variety of different types of data organized in a variety of different ways and from a variety of different sources. For example, network-attached data storage may include storage other than primary storage located within computing environment 114 that is directly accessible by processors located therein. Network-attached data storage may include secondary, tertiary or auxiliary storage, such as large hard drives, servers, virtual memory, among other types. Storage devices may include portable or non-portable storage devices, optical storage devices, and various other mediums capable of storing, containing data. A machine-readable storage medium or computer-readable storage medium may include a non-transitory medium in which data can be stored and that does not include carrier waves and/or transitory electronic signals. Examples of a non-transitory medium may include, for example, a magnetic disk or tape, optical storage media such as compact disk or digital versatile disk, flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. Furthermore, the data stores may hold a variety of different types of data. For example, network-attached data stores 110 may hold unstructured (e.g., raw) data, such as manufacturing data (e.g., a database containing records identifying products being manufactured with parameter data for each product, such as colors and models) or product sales databases (e.g., a database containing individual data records identifying details of individual product sales).

The unstructured data may be presented to the computing environment 114 in different forms such as a flat file or a conglomerate of data records, and may have data values and accompanying time stamps. The computing environment 114 may be used to analyze the unstructured data in a variety of ways to determine the best way to structure (e.g., hierarchically) that data, such that the structured data is tailored to a type of further analysis that a user wishes to perform on the data. For example, after being processed, the unstructured time stamped data may be aggregated by time (e.g., into daily time period units) to generate time series data and/or structured hierarchically according to one or more dimensions (e.g., parameters, attributes, and/or variables). For example, data may be stored in a hierarchical data structure, such as a ROLAP OR MOLAP database, or may be stored in another tabular form, such as in a flat-hierarchy form.

Data transmission network 100 may also include one or more server farms 106. Computing environment 114 may route select communications or data to the one or more sever farms 106 or one or more servers within the server farms. Server farms 106 can be configured to provide information in a predetermined manner. For example, server farms 106 may access data to transmit in response to a communication. Server farms 106 may be separately housed from each other device within data transmission network 100, such as computing environment 114, and/or may be part of a device or system.

Server farms 106 may host a variety of different types of data processing as part of data transmission network 100. Server farms 106 may receive a variety of different data from network devices, from computing environment 114, from cloud network 116, or from other sources. The data may have been obtained or collected from one or more sensors, as inputs from a control database, or may have been received as inputs from an external system or device. Server farms 106 may assist in processing the data by turning raw data into processed data based on one or more rules implemented by the server farms. For example, sensor data may be analyzed to determine changes in an environment over time or in real-time.

Data transmission network 100 may also include one or more cloud networks 116. Cloud network 116 may include a cloud infrastructure system that provides cloud services. In certain embodiments, services provided by the cloud network 116 may include a host of services that are made available to users of the cloud infrastructure system on demand. Cloud network 116 is shown in FIG. 1 as being connected to computing environment 114 (and therefore having computing environment 114 as its client or user), but cloud network 116 may be connected to or utilized by any of the devices in FIG. 1. Services provided by the cloud network can dynamically scale to meet the needs of its users. The cloud network 116 may include one or more computers, servers, and/or systems. In some embodiments, the computers, servers, and/or systems that make up the cloud network 116 are different from the user's own on-premises computers, servers, and/or systems. For example, the cloud network 116 may host an application, and a user may, via a communication network such as the Internet, on demand, order and use the application.

While each device, server and system in FIG. 1 is shown as a single device, it will be appreciated that multiple devices may instead be used. For example, a set of network devices can be used to transmit various communications from a single user, or remote server 140 may include a server stack. As another example, data may be processed as part of computing environment 114.

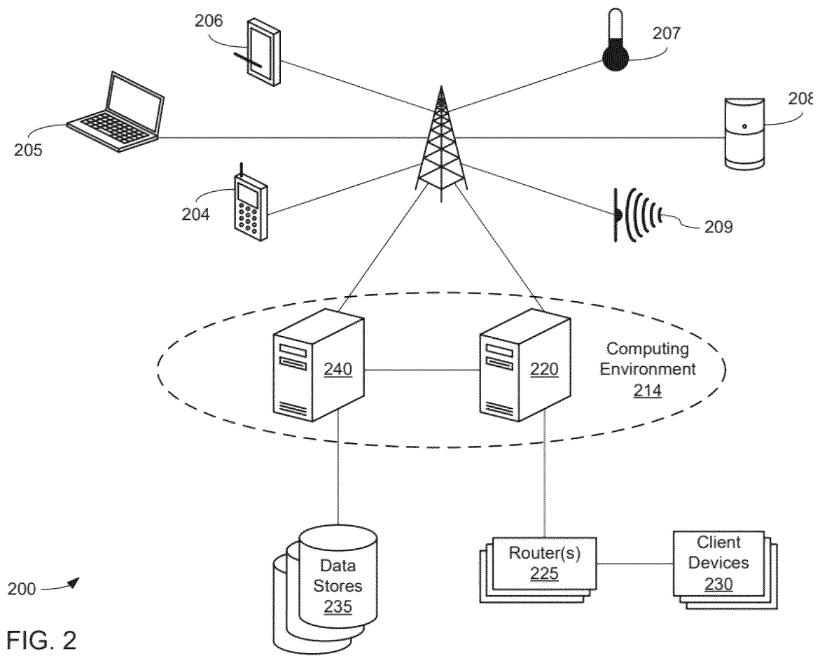

Each communication within data transmission network 100 (e.g., between client devices, between servers 106 and computing environment 114 or between a server and a device) may occur over one or more networks 108. Networks 108 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or combination of wireless interfaces. As an example, a network in the one or more networks 108 may include a short-range communication channel, such as a BLUETOOTH® communication channel or a BLUETOOTH® Low Energy communication channel. A wired network may include a wired interface. The wired and/or wireless networks may be implemented using routers, access points, bridges, gateways, or the like, to connect devices in the network 114, as will be further described with respect to FIG. 2. The one or more networks 108 can be incorporated entirely within or can include an intranet, an extranet, or a combination thereof. In one embodiment, communications between two or more systems and/or devices can be achieved by a secure communications protocol, such as secure sockets layer (SSL) or transport layer security (TLS). In addition, data and/or transactional details may be encrypted.

Some aspects may utilize the Internet of Things (IOT), where things (e.g., machines, devices, phones, sensors) can be connected to networks and the data from these things can be collected and processed within the things and/or external to the things. For example, the IoT can include sensors in many different devices, and high value analytics can be applied to identify hidden relationships and drive increased efficiencies. This can apply to both big data analytics and real-time (e.g., ESP) analytics. This will be described further below with respect to FIG. 2.

As noted, computing environment 114 may include a communications grid 120 and a transmission network database system 118. Communications grid 120 may be a grid-based computing system for processing large amounts of data. The transmission network database system 118 may be for managing, storing, and retrieving large amounts of data that are distributed to and stored in the one or more network-attached data stores 110 or other data stores that reside at different locations within the transmission network database system 118. The compute nodes in the grid-based computing system 120 and the transmission network database system 118 may share the same processor hardware, such as processors that are located within computing environment 114.

FIG. 2 illustrates an example network including an example set of devices communicating with each other over an exchange system and via a network, according to embodiments of the present technology. As noted, each communication within data transmission network 100 may occur over one or more networks. System 200 includes a network device 204 configured to communicate with a variety of types of client devices, for example client devices 230, over a variety of types of communication channels.

As shown in FIG. 2, network device 204 can transmit a communication over a network (e.g., a cellular network via a base station 210). The communication can be routed to another network device, such as network devices 205-209, via base station 210. The communication can also be routed to computing environment 214 via base station 210. For example, network device 204 may collect data either from its surrounding environment or from other network devices (such as network devices 205-209) and transmit that data to computing environment 214.

Although network devices 204-209 are shown in FIG. 2 as a mobile phone, laptop computer, tablet computer, temperature sensor, motion sensor, and audio sensor respectively, the network devices may be or include sensors that are sensitive to detecting aspects of their environment. For example, the network devices may include sensors such as water sensors, power sensors, electrical current sensors, chemical sensors, optical sensors, pressure sensors, geographic or position sensors (e.g., GPS), velocity sensors, acceleration sensors, flow rate sensors, among others. Examples of characteristics that may be sensed include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, and electrical current, among others. The sensors may be mounted to various components used as part of a variety of different types of systems (e.g., an oil drilling operation). The network devices may detect and record data related to the environment that it monitors, and transmit that data to computing environment 214.

As noted, one type of system that may include various sensors that collect data to be processed and/or transmitted to a computing environment according to certain embodiments includes an oil drilling system. For example, the one or more drilling operation sensors may include surface sensors that measure a hook load, a fluid rate, a temperature and a density in and out of the wellbore, a standpipe pressure, a surface torque, a rotation speed of a drill pipe, a rate of penetration, a mechanical specific energy, etc. and downhole sensors that measure a rotation speed of a bit, fluid densities, downhole torque, downhole vibration (axial, tangential, lateral), a weight applied at a drill bit, an annular pressure, a differential pressure, an azimuth, an inclination, a dog leg severity, a measured depth, a vertical depth, a downhole temperature, etc. Besides the raw data collected directly by the sensors, other data may include parameters either developed by the sensors or assigned to the system by a client or other controlling device. For example, one or more drilling operation control parameters may control settings such as a mud motor speed to flow ratio, a bit diameter, a predicted formation top, seismic data, weather data, etc. Other data may be generated using physical models such as an earth model, a weather model, a seismic model, a bottom hole assembly model, a well plan model, an annular friction model, etc. In addition to sensor and control settings, predicted outputs, of for example, the rate of penetration, mechanical specific energy, hook load, flow in fluid rate, flow out fluid rate, pump pressure, surface torque, rotation speed of the drill pipe, annular pressure, annular friction pressure, annular temperature, equivalent circulating density, etc. may also be stored in the data warehouse.

In another example, another type of system that may include various sensors that collect data to be processed and/or transmitted to a computing environment according to certain embodiments includes a home automation or similar automated network in a different environment, such as an office space, school, public space, sports venue, or a variety of other locations. Network devices in such an automated network may include network devices that allow a user to access, control, and/or configure various home appliances located within the user's home (e.g., a television, radio, light, fan, humidifier, sensor, microwave, iron, and/or the like), or outside of the user's home (e.g., exterior motion sensors, exterior lighting, garage door openers, sprinkler systems, or the like). For example, network device 102 may include a home automation switch that may be coupled with a home appliance. In another embodiment, a network device can allow a user to access, control, and/or configure devices, such as office-related devices (e.g., copy machine, printer, or fax machine), audio and/or video related devices (e.g., a receiver, a speaker, a projector, a DVD player, or a television), media-play back devices (e.g., a compact disc player, a CD player, or the like), computing devices (e.g., a home computer, a laptop computer, a tablet, a personal digital assistant (PDA), a computing device, or a wearable device), lighting devices (e.g., a lamp or recessed lighting), devices associated with a security system, devices associated with an alarm system, devices that can be operated in an automobile (e.g., radio devices, navigation devices), and/or the like. Data may be collected from such various sensors in raw form, or data may be processed by the sensors to create parameters or other data either developed by the sensors based on the raw data or assigned to the system by a client or other controlling device.

In another example, another type of system that may include various sensors that collect data to be processed and/or transmitted to a computing environment according to certain embodiments includes a power or energy grid. A variety of different network devices may be included in an energy grid, such as various devices within one or more power plants, energy farms (e.g., wind farm, solar farm, among others) energy storage facilities, factories, homes and businesses of consumers, among others. One or more of such devices may include one or more sensors that detect energy gain or loss, electrical input or output or loss, and a variety of other efficiencies. These sensors may collect data to inform users of how the energy grid, and individual devices within the grid, may be functioning and how they may be made more efficient.

Network device sensors may also perform processing on data it collects before transmitting the data to the computing environment 114, or before deciding whether to transmit data to the computing environment 114. For example, network devices may determine whether data collected meets certain rules, for example by comparing data or values calculated from the data and comparing that data to one or more thresholds. The network device may use this data and/or comparisons to determine if the data should be transmitted to the computing environment 214 for further use or processing.

Computing environment 214 may include machines 220 and 240. Although computing environment 214 is shown in FIG. 2 as having two machines, 220 and 240, computing environment 214 may have only one machine or may have more than two machines. The machines that make up computing environment 214 may include specialized computers, servers, or other machines that are configured to individually and/or collectively process large amounts of data. The computing environment 214 may also include storage devices that include one or more databases of structured data, such as data organized in one or more hierarchies, or unstructured data. The databases may communicate with the processing devices within computing environment 214 to distribute data to them. Since network devices may transmit data to computing environment 214, that data may be received by the computing environment 214 and subsequently stored within those storage devices. Data used by computing environment 214 may also be stored in data stores 235, which may also be a part of or connected to computing environment 214.

Computing environment 214 can communicate with various devices via one or more routers 225 or other inter-network or intra-network connection components. For example, computing environment 214 may communicate with devices 230 via one or more routers 225. Computing environment 214 may collect, analyze and/or store data from or pertaining to communications, client device operations, client rules, and/or user-associated actions stored at one or more data stores 235. Such data may influence communication routing to the devices within computing environment 214, how data is stored or processed within computing environment 214, among other actions.

Notably, various other devices can further be used to influence communication routing and/or processing between devices within computing environment 214 and with devices outside of computing environment 214. For example, as shown in FIG. 2, computing environment 214 may include a web server 240. Thus, computing environment 214 can retrieve data of interest, such as client information (e.g., product information, client rules, etc.), technical product details, news, current or predicted weather, and so on.

In addition to computing environment 214 collecting data (e.g., as received from network devices, such as sensors, and client devices or other sources) to be processed as part of a big data analytics project, it may also receive data in real time as part of a streaming analytics environment. As noted, data may be collected using a variety of sources as communicated via different kinds of networks or locally. Such data may be received on a real-time streaming basis. For example, network devices may receive data periodically from network device sensors as the sensors continuously sense, monitor and track changes in their environments. Devices within computing environment 214 may also perform pre-analysis on data it receives to determine if the data received should be processed as part of an ongoing project. The data received and collected by computing environment 214, no matter what the source or method or timing of receipt, may be processed over a period of time for a client to determine results data based on the client's needs and rules.

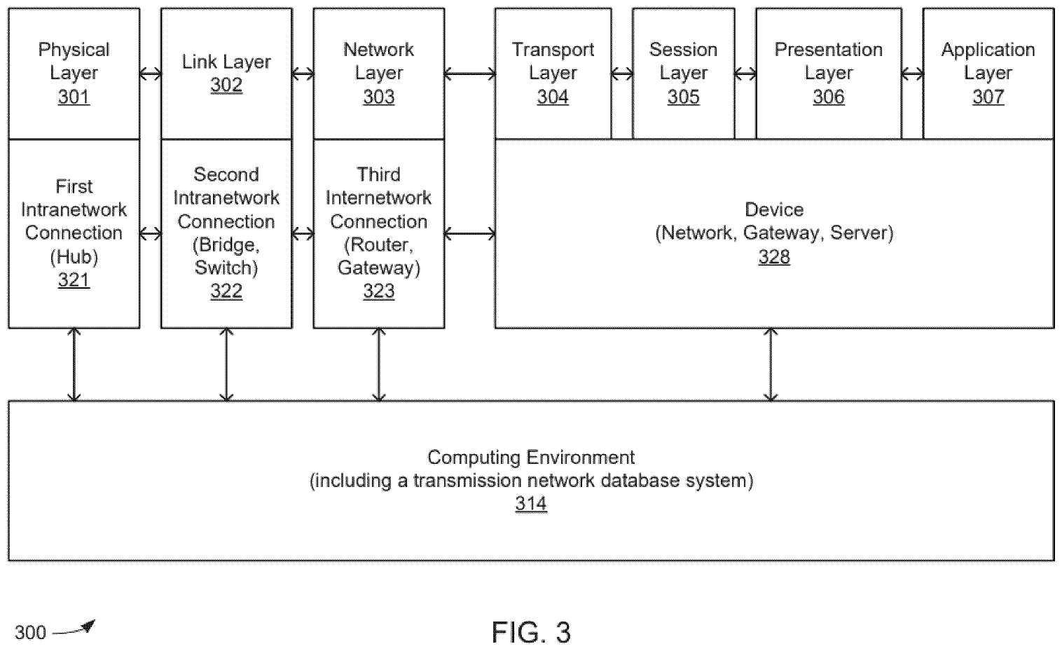

FIG. 3 illustrates a representation of a conceptual model of a communications protocol system, according to embodiments of the present technology. More specifically, FIG. 3 identifies operation of a computing environment in an Open Systems Interaction model that corresponds to various connection components. The model 300 shows, for example, how a computing environment, such as computing environment 314 (or computing environment 214 in FIG. 2) may communicate with other devices in its network, and control how communications between the computing environment and other devices are executed and under what conditions.

The model can include layers 301-307. The layers are arranged in a stack. Each layer in the stack serves the layer one level higher than it (except for the application layer, which is the highest layer), and is served by the layer one level below it (except for the physical layer, which is the lowest layer). The physical layer is the lowest layer because it receives and transmits raw bites of data, and is the farthest layer from the user in a communications system. On the other hand, the application layer is the highest layer because it interacts directly with a software application.

As noted, the model includes a physical layer 301. Physical layer 301 represents physical communication, and can define parameters of that physical communication. For example, such physical communication may come in the form of electrical, optical, or electromagnetic signals. Physical layer 301 also defines protocols that may control communications within a data transmission network.

Link layer 302 defines links and mechanisms used to transmit (i.e., move) data across a network. The link layer 302 manages node-to-node communications, such as within a grid computing environment. Link layer 302 can detect and correct errors (e.g., transmission errors in the physical layer 301). Link layer 302 can also include a media access control (MAC) layer and logical link control (LLC) layer.

Network layer 303 defines the protocol for routing within a network. In other words, the network layer coordinates transferring data across nodes in a same network (e.g., such as a grid computing environment). Network layer 303 can also define the processes used to structure local addressing within the network.

Transport layer 304 can manage the transmission of data and the quality of the transmission and/or receipt of that data. Transport layer 304 can provide a protocol for transferring data, such as, for example, a Transmission Control Protocol (TCP). Transport layer 304 can assemble and disassemble data frames for transmission. The transport layer can also detect transmission errors occurring in the layers below it.

Session layer 305 can establish, maintain, and manage communication connections between devices on a network. In other words, the session layer controls the dialogues or nature of communications between network devices on the network. The session layer may also establish checkpointing, adjournment, termination, and restart procedures.

Presentation layer 306 can provide translation for communications between the application and network layers. In other words, this layer may encrypt, decrypt and/or format data based on data types and/or encodings known to be accepted by an application or network layer.

Application layer 307 interacts directly with software applications and end users, and manages communications between them. Application layer 307 can identify destinations, local resource states or availability and/or communication content or formatting using the applications.

Intra-network connection components 321 and 322 are shown to operate in lower levels, such as physical layer 301 and link layer 302, respectively. For example, a hub can operate in the physical layer, a switch can operate in the link layer, and a router can operate in the network layer. Inter-network connection components 323 and 328 are shown to operate on higher levels, such as layers 303-307. For example, routers can operate in the network layer and network devices can operate in the transport, session, presentation, and application layers.

As noted, a computing environment 314 can interact with and/or operate on, in various embodiments, one, more, all or any of the various layers. For example, computing environment 314 can interact with a hub (e.g., via the link layer) so as to adjust which devices the hub communicates with. The physical layer may be served by the link layer, so it may implement such data from the link layer. For example, the computing environment 314 may control which devices it will receive data from. For example, if the computing environment 314 knows that a certain network device has turned off, broken, or otherwise become unavailable or unreliable, the computing environment 314 may instruct the hub to prevent any data from being transmitted to the computing environment 314 from that network device. Such a process may be beneficial to avoid receiving data that is inaccurate or that has been influenced by an uncontrolled environment. As another example, computing environment 314 can communicate with a bridge, switch, router or gateway and influence which device within the system (e.g., system 200) the component selects as a destination. In some embodiments, computing environment 314 can interact with various layers by exchanging communications with equipment operating on a particular layer by routing or modifying existing communications. In another embodiment, such as in a grid computing environment, a node may determine how data within the environment should be routed (e.g., which node should receive certain data) based on certain parameters or information provided by other layers within the model.

As noted, the computing environment 314 may be a part of a communications grid environment, the communications of which may be implemented as shown in the protocol of FIG. 3. For example, referring back to FIG. 2, one or more of machines 220 and 240 may be part of a communications grid computing environment. A gridded computing environment may be employed in a distributed system with non-interactive workloads where data resides in memory on the machines, or compute nodes. In such an environment, analytic code, instead of a database management system, controls the processing performed by the nodes. Data is co-located by pre-distributing it to the grid nodes, and the analytic code on each node loads the local data into memory. Each node may be assigned a particular task such as a portion of a processing project, or to organize or control other nodes within the grid.

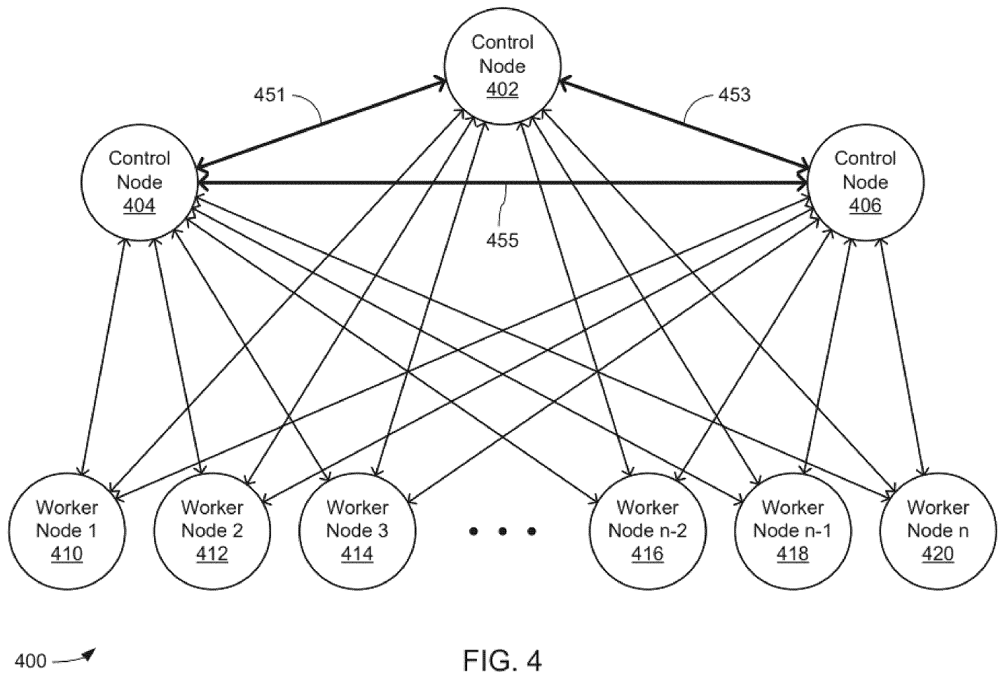

FIG. 4 illustrates a communications grid computing system 400 including a variety of control and worker nodes, according to embodiments of the present technology. Communications grid computing system 400 includes three control nodes and one or more worker nodes. Communications grid computing system 400 includes control nodes 402, 404, and 406. The control nodes are communicatively connected via communication paths 451, 453, and 455. Therefore, the control nodes may transmit information (e.g., related to the communications grid or notifications), to and receive information from each other. Although communications grid computing system 400 is shown in FIG. 4 as including three control nodes, the communications grid may include more or less than three control nodes.

Communications grid computing system (or just “communications grid”) 400 also includes one or more worker nodes. Shown in FIG. 4 are six worker nodes 410-420. Although FIG. 4 shows six worker nodes, a communications grid according to embodiments of the present technology may include more or less than six worker nodes. The number of worker nodes included in a communications grid may be dependent upon how large the project or data set is being processed by the communications grid, the capacity of each worker node, the time designated for the communications grid to complete the project, among others. Each worker node within the communications grid 400 may be connected (wired or wirelessly, and directly or indirectly) to control nodes 402-406. Therefore, each worker node may receive information from the control nodes (e.g., an instruction to perform work on a project) and may transmit information to the control nodes (e.g., a result from work performed on a project). Furthermore, worker nodes may communicate with each other (either directly or indirectly). For example, worker nodes may transmit data between each other related to a job being performed or an individual task within a job being performed by that worker node. However, in certain embodiments, worker nodes may not, for example, be connected (communicatively or otherwise) to certain other worker nodes. In an embodiment, worker nodes may only be able to communicate with the control node that controls it, and may not be able to communicate with other worker nodes in the communications grid, whether they are other worker nodes controlled by the control node that controls the worker node, or worker nodes that are controlled by other control nodes in the communications grid.

A control node may connect with an external device with which the control node may communicate (e.g., a grid user, such as a server or computer, may connect to a controller of the grid). For example, a server or computer may connect to control nodes and may transmit a project or job to the node. The project may include a data set. The data set may be of any size. Once the control node receives such a project including a large data set, the control node may distribute the data set or projects related to the data set to be performed by worker nodes. Alternatively, for a project including a large data set, the data set may be received or stored by a machine other than a control node (e.g., a HADOOP® standard-compliant data node employing the HADOOP® Distributed File System, or HDFS).

Control nodes may maintain knowledge of the status of the nodes in the grid (i.e., grid status information), accept work requests from clients, subdivide the work across worker nodes, and coordinate the worker nodes, among other responsibilities. Worker nodes may accept work requests from a control node and provide the control node with results of the work performed by the worker node. A grid may be started from a single node (e.g., a machine, computer, server, etc.). This first node may be assigned or may start as the primary control node that will control any additional nodes that enter the grid.

When a project is submitted for execution (e.g., by a client or a controller of the grid) it may be assigned to a set of nodes. After the nodes are assigned to a project, a data structure (i.e., a communicator) may be created. The communicator may be used by the project for information to be shared between the project codes running on each node. A communication handle may be created on each node. A handle, for example, is a reference to the communicator that is valid within a single process on a single node, and the handle may be used when requesting communications between nodes.

A control node, such as control node 402, may be designated as the primary control node. A server, computer or other external device may connect to the primary control node. Once the control node receives a project, the primary control node may distribute portions of the project to its worker nodes for execution. For example, when a project is initiated on communications grid 400, primary control node 402 controls the work to be performed for the project in order to complete the project as requested or instructed. The primary control node may distribute work to the worker nodes based on various factors, such as which subsets or portions of projects may be completed most efficiently and in the correct amount of time. For example, a worker node may perform analysis on a portion of data that is already local (e.g., stored on) the worker node. The primary control node also coordinates and processes the results of the work performed by each worker node after each worker node executes and completes its job. For example, the primary control node may receive a result from one or more worker nodes, and the control node may organize (e.g., collect and assemble) the results received and compile them to produce a complete result for the project received from the end user.

Any remaining control nodes, such as control nodes 404 and 406, may be assigned as backup control nodes for the project. In an embodiment, backup control nodes may not control any portion of the project. Instead, backup control nodes may serve as a backup for the primary control node and take over as primary control node if the primary control node were to fail. If a communications grid were to include only a single control node, and the control node were to fail (e.g., the control node is shut off or breaks) then the communications grid as a whole may fail and any project or job being run on the communications grid may fail and may not complete. While the project may be run again, such a failure may cause a delay (severe delay in some cases, such as overnight delay) in completion of the project. Therefore, a grid with multiple control nodes, including a backup control node, may be beneficial.

To add another node or machine to the grid, the primary control node may open a pair of listening sockets, for example. A socket may be used to accept work requests from clients, and the second socket may be used to accept connections from other grid nodes. The primary control node may be provided with a list of other nodes (e.g., other machines, computers, servers) that will participate in the grid, and the role that each node will fill in the grid. Upon startup of the primary control node (e.g., the first node on the grid), the primary control node may use a network protocol to start the server process on every other node in the grid. Command line parameters, for example, may inform each node of one or more pieces of information, such as: the role that the node will have in the grid, the host name of the primary control node, the port number on which the primary control node is accepting connections from peer nodes, among others. The information may also be provided in a configuration file, transmitted over a secure shell tunnel, recovered from a configuration server, among others. While the other machines in the grid may not initially know about the configuration of the grid, that information may also be sent to each other node by the primary control node. Updates of the grid information may also be subsequently sent to those nodes.

For any control node other than the primary control node added to the grid, the control node may open three sockets. The first socket may accept work requests from clients, the second socket may accept connections from other grid members, and the third socket may connect (e.g., permanently) to the primary control node. When a control node (e.g., primary control node) receives a connection from another control node, it first checks to see if the peer node is in the list of configured nodes in the grid. If it is not on the list, the control node may clear the connection. If it is on the list, it may then attempt to authenticate the connection. If authentication is successful, the authenticating node may transmit information to its peer, such as the port number on which a node is listening for connections, the host name of the node, information about how to authenticate the node, among other information. When a node, such as the new control node, receives information about another active node, it will check to see if it already has a connection to that other node. If it does not have a connection to that node, it may then establish a connection to that control node.

Any worker node added to the grid may establish a connection to the primary control node and any other control nodes on the grid. After establishing the connection, it may authenticate itself to the grid (e.g., any control nodes, including both primary and backup, or a server or user controlling the grid). After successful authentication, the worker node may accept configuration information from the control node.

When a node joins a communications grid (e.g., when the node is powered on or connected to an existing node on the grid or both), the node is assigned (e.g., by an operating system of the grid) a universally unique identifier (UUID). This unique identifier may help other nodes and external entities (devices, users, etc.) to identify the node and distinguish it from other nodes. When a node is connected to the grid, the node may share its unique identifier with the other nodes in the grid. Since each node may share its unique identifier, each node may know the unique identifier of every other node on the grid. Unique identifiers may also designate a hierarchy of each of the nodes (e.g., backup control nodes) within the grid. For example, the unique identifiers of each of the backup control nodes may be stored in a list of backup control nodes to indicate an order in which the backup control nodes will take over for a failed primary control node to become a new primary control node. However, a hierarchy of nodes may also be determined using methods other than using the unique identifiers of the nodes. For example, the hierarchy may be predetermined, or may be assigned based on other predetermined factors.

The grid may add new machines at any time (e.g., initiated from any control node). Upon adding a new node to the grid, the control node may first add the new node to its table of grid nodes. The control node may also then notify every other control node about the new node. The nodes receiving the notification may acknowledge that they have updated their configuration information.

Primary control node 402 may, for example, transmit one or more communications to backup control nodes 404 and 406 (and, for example, to other control or worker nodes within the communications grid). Such communications may be sent periodically, at fixed time intervals, between known fixed stages of the project's execution, among other protocols. The communications transmitted by primary control node 402 may be of varied types and may include a variety of types of information. For example, primary control node 402 may transmit snapshots (e.g., status information) of the communications grid so that backup control node 404 always has a recent snapshot of the communications grid. The snapshot or grid status may include, for example, the structure of the grid (including, for example, the worker nodes in the grid, unique identifiers of the nodes, or their relationships with the primary control node) and the status of a project (including, for example, the status of each worker node's portion of the project). The snapshot may also include analysis or results received from worker nodes in the communications grid. The backup control nodes may receive and store the backup data received from the primary control node. The backup control nodes may transmit a request for such a snapshot (or other information) from the primary control node, or the primary control node may send such information periodically to the backup control nodes.

As noted, the backup data may allow the backup control node to take over as primary control node if the primary control node fails without requiring the grid to start the project over from scratch. If the primary control node fails, the backup control node that will take over as primary control node may retrieve the most recent version of the snapshot received from the primary control node and use the snapshot to continue the project from the stage of the project indicated by the backup data. This may prevent failure of the project as a whole.

A backup control node may use various methods to determine that the primary control node has failed. In one example of such a method, the primary control node may transmit (e.g., periodically) a communication to the backup control node that indicates that the primary control node is working and has not failed, such as a heartbeat communication. The backup control node may determine that the primary control node has failed if the backup control node has not received a heartbeat communication for a certain predetermined period of time. Alternatively, a backup control node may also receive a communication from the primary control node itself (before it failed) or from a worker node that the primary control node has failed, for example because the primary control node has failed to communicate with the worker node.

Different methods may be performed to determine which backup control node of a set of backup control nodes (e.g., backup control nodes 404 and 406) will take over for failed primary control node 402 and become the new primary control node. For example, the new primary control node may be chosen based on a ranking or “hierarchy” of backup control nodes based on their unique identifiers. In an alternative embodiment, a backup control node may be assigned to be the new primary control node by another device in the communications grid or from an external device (e.g., a system infrastructure or an end user, such as a server or computer, controlling the communications grid). In another alternative embodiment, the backup control node that takes over as the new primary control node may be designated based on bandwidth or other statistics about the communications grid.

A worker node within the communications grid may also fail. If a worker node fails, work being performed by the failed worker node may be redistributed amongst the operational worker nodes. In an alternative embodiment, the primary control node may transmit a communication to each of the operable worker nodes still on the communications grid that each of the worker nodes should purposefully fail also. After each of the worker nodes fail, they may each retrieve their most recent saved checkpoint of their status and restart the project from that checkpoint to minimize lost progress on the project being executed.

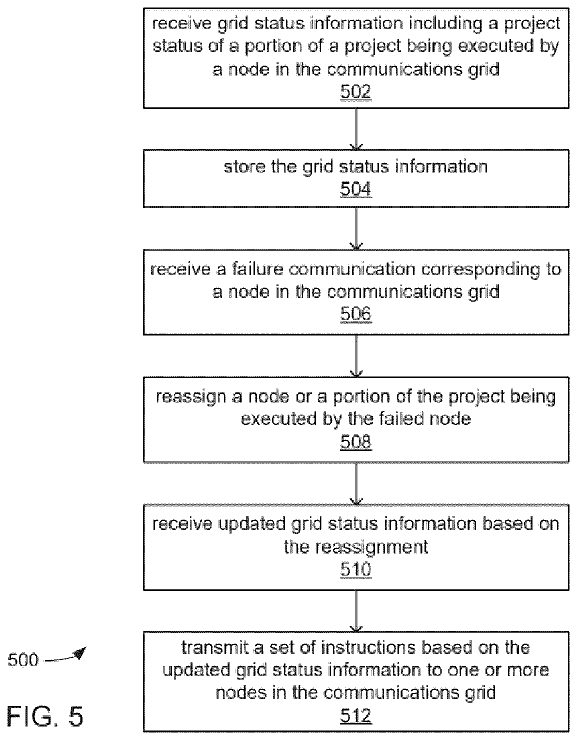

FIG. 5 illustrates a flow chart showing an example process 500 for adjusting a communications grid or a work project in a communications grid after a failure of a node, according to embodiments of the present technology. The process may include, for example, receiving grid status information including a project status of a portion of a project being executed by a node in the communications grid, as described in operation 502. For example, a control node (e.g., a backup control node connected to a primary control node and a worker node on a communications grid) may receive grid status information, where the grid status information includes a project status of the primary control node or a project status of the worker node. The project status of the primary control node and the project status of the worker node may include a status of one or more portions of a project being executed by the primary and worker nodes in the communications grid. The process may also include storing the grid status information, as described in operation 504. For example, a control node (e.g., a backup control node) may store the received grid status information locally within the control node. Alternatively, the grid status information may be sent to another device for storage where the control node may have access to the information.

The process may also include receiving a failure communication corresponding to a node in the communications grid in operation 506. For example, a node may receive a failure communication including an indication that the primary control node has failed, prompting a backup control node to take over for the primary control node. In an alternative embodiment, a node may receive a failure that a worker node has failed, prompting a control node to reassign the work being performed by the worker node. The process may also include reassigning a node or a portion of the project being executed by the failed node, as described in operation 508. For example, a control node may designate the backup control node as a new primary control node based on the failure communication upon receiving the failure communication. If the failed node is a worker node, a control node may identify a project status of the failed worker node using the snapshot of the communications grid, where the project status of the failed worker node includes a status of a portion of the project being executed by the failed worker node at the failure time.

The process may also include receiving updated grid status information based on the reassignment, as described in operation 510, and transmitting a set of instructions based on the updated grid status information to one or more nodes in the communications grid, as described in operation 512. The updated grid status information may include an updated project status of the primary control node or an updated project status of the worker node. The updated information may be transmitted to the other nodes in the grid to update their stale stored information.

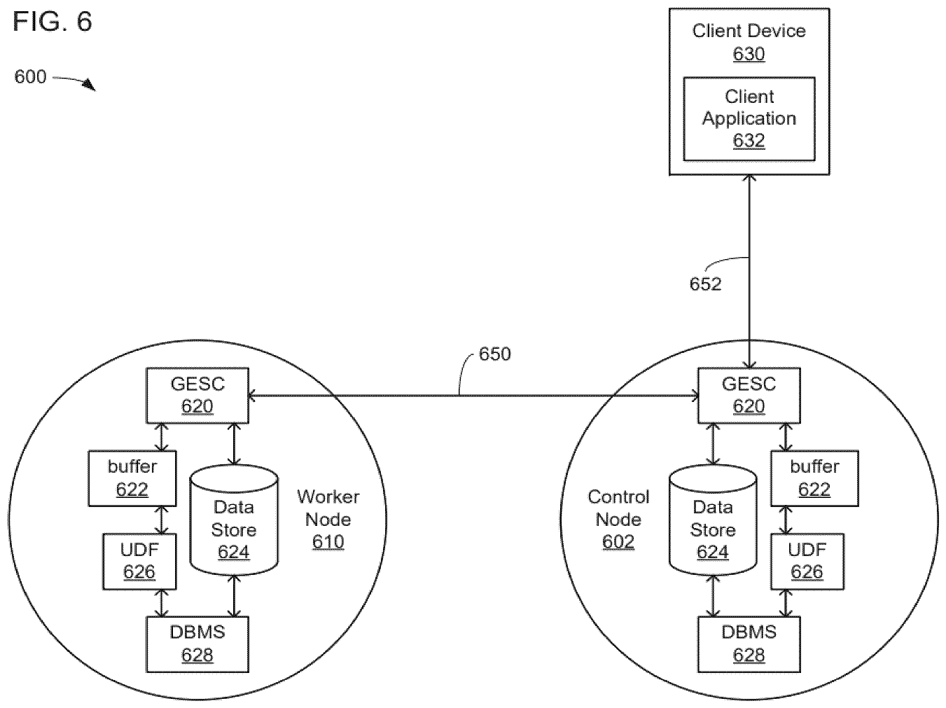

FIG. 6 illustrates a portion of a communications grid computing system 600 including a control node and a worker node, according to embodiments of the present technology. Communications grid 600 computing system includes one control node (control node 602) and one worker node (worker node 610) for purposes of illustration, but may include more worker and/or control nodes. The control node 602 is communicatively connected to worker node 610 via communication path 650. Therefore, control node 602 may transmit information (e.g., related to the communications grid or notifications), to and receive information from worker node 610 via path 650.

Similar to in FIG. 4, communications grid computing system (or just “communications grid”) 600 includes data processing nodes (control node 602 and worker node 610). Nodes 602 and 610 include multi-core data processors. Each node 602 and 610 includes a grid-enabled software component (GESC) 620 that executes on the data processor associated with that node and interfaces with buffer memory 622 also associated with that node. Each node 602 and 610 includes database management software (DBMS) 628 that executes on a database server (not shown) at control node 602 and on a database server (not shown) at worker node 610.

Each node also includes a data store 624. Data stores 624, similar to network-attached data stores 110 in FIG. 1 and data stores 235 in FIG. 2, are used to store data to be processed by the nodes in the computing environment. Data stores 624 may also store any intermediate or final data generated by the computing system after being processed, for example in non-volatile memory. However in certain embodiments, the configuration of the grid computing environment allows its operations to be performed such that intermediate and final data results can be stored solely in volatile memory (e.g., RAM), without a requirement that intermediate or final data results be stored to non-volatile types of memory. Storing such data in volatile memory may be useful in certain situations, such as when the grid receives queries (e.g., ad hoc) from a client and when responses, which are generated by processing large amounts of data, need to be generated quickly or on-the-fly. In such a situation, the grid may be configured to retain the data within memory so that responses can be generated at different levels of detail and so that a client may interactively query against this information.

Each node also includes a user-defined function (UDF) 626. The UDF provides a mechanism for the DBMS 628 to transfer data to or receive data from the database stored in the data stores 624 that are managed by the DBMS. For example, UDF 626 can be invoked by the DBMS to provide data to the GESC for processing. The UDF 626 may establish a socket connection (not shown) with the GESC to transfer the data. Alternatively, the UDF 626 can transfer data to the GESC by writing data to shared memory accessible by both the UDF and the GESC.

The GESC 620 at the nodes 602 and 620 may be connected via a network, such as network 108 shown in FIG. 1. Therefore, nodes 602 and 620 can communicate with each other via the network using a predetermined communication protocol such as, for example, the Message Passing Interface (MPI). Each GESC 620 can engage in point-to-point communication with the GESC at another node or in collective communication with multiple GESCs via the network. The GESC 620 at each node may contain identical (or nearly identical) software instructions. Each node may be capable of operating as either a control node or a worker node. The GESC at the control node 602 can communicate, over a communication path 652, with a client device 630. More specifically, control node 602 may communicate with client application 632 hosted by the client device 630 to receive queries and to respond to those queries after processing large amounts of data.

DBMS 628 may control the creation, maintenance, and use of database or data structure (not shown) within a node 602 or 610. The database may organize data stored in data stores 624. The DBMS 628 at control node 602 may accept requests for data and transfer the appropriate data for the request. With such a process, collections of data may be distributed across multiple physical locations. In this example, each node 602 and 610 stores a portion of the total data managed by the management system in its associated data store 624.

Furthermore, the DBMS may be responsible for protecting against data loss using replication techniques. Replication includes providing a backup copy of data stored on one node on one or more other nodes. Therefore, if one node fails, the data from the failed node can be recovered from a replicated copy residing at another node. However, as described herein with respect to FIG. 4, data or status information for each node in the communications grid may also be shared with each node on the grid.

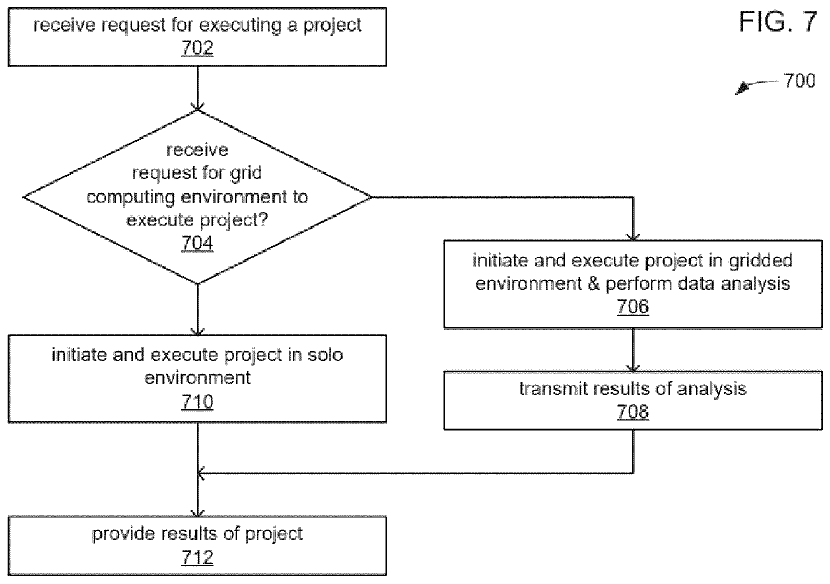

FIG. 7 illustrates a flow chart showing an example method 700 for executing a project within a grid computing system, according to embodiments of the present technology. As described with respect to FIG. 6, the GESC at the control node may transmit data with a client device (e.g., client device 630) to receive queries for executing a project and to respond to those queries after large amounts of data have been processed. The query may be transmitted to the control node, where the query may include a request for executing a project, as described in operation 702. The query can contain instructions on the type of data analysis to be performed in the project and whether the project should be executed using the grid-based computing environment, as shown in operation 704.

To initiate the project, the control node may determine if the query requests use of the grid-based computing environment to execute the project. If the determination is no, then the control node initiates execution of the project in a solo environment (e.g., at the control node), as described in operation 710. If the determination is yes, the control node may initiate execution of the project in the grid-based computing environment, as described in operation 706. In such a situation, the request may include a requested configuration of the grid. For example, the request may include a number of control nodes and a number of worker nodes to be used in the grid when executing the project. After the project has been completed, the control node may transmit results of the analysis yielded by the grid, as described in operation 708. Whether the project is executed in a solo or grid-based environment, the control node provides the results of the project, as described in operation 712.

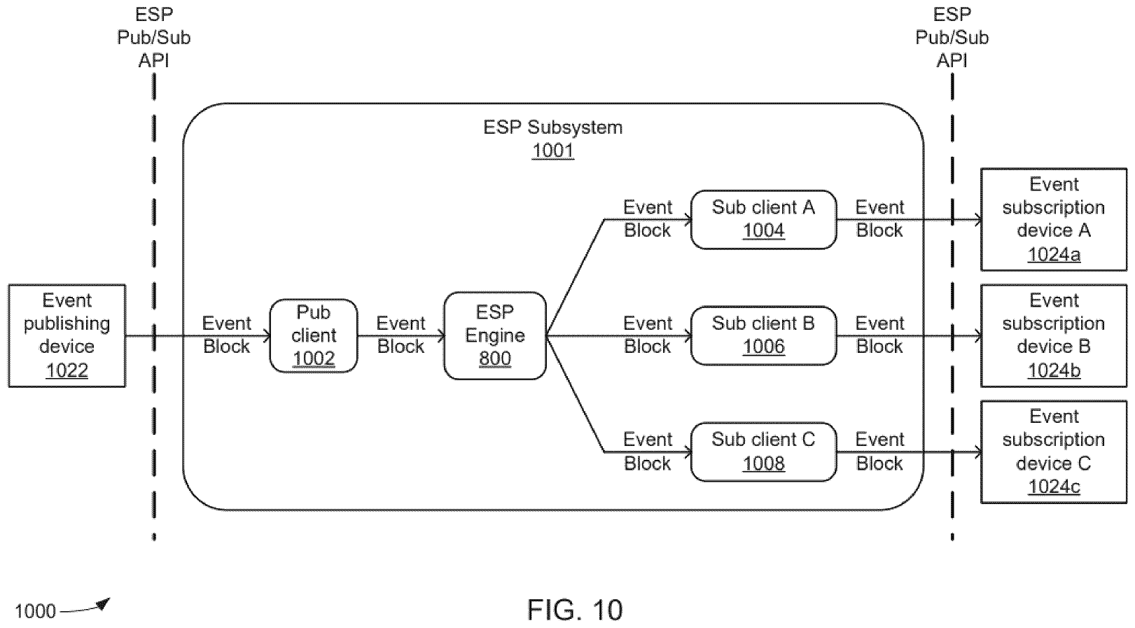

As noted with respect to FIG. 2, the computing environments described herein may collect data (e.g., as received from network devices, such as sensors, such as network devices 204-209 in FIG. 2, and client devices or other sources) to be processed as part of a data analytics project, and data may be received in real time as part of a streaming analytics environment (e.g., ESP). Data may be collected using a variety of sources as communicated via different kinds of networks or locally, such as on a real-time streaming basis. For example, network devices may receive data periodically from network device sensors as the sensors continuously sense, monitor and track changes in their environments. More specifically, an increasing number of distributed applications develop or produce continuously flowing data from distributed sources by applying queries to the data before distributing the data to geographically distributed recipients. An event stream processing engine (ESPE) may continuously apply the queries to the data as it is received and determines which entities should receive the data. Client or other devices may also subscribe to the ESPE or other devices processing ESP data so that they can receive data after processing, based on for example the entities determined by the processing engine. For example, client devices 230 in FIG. 2 may subscribe to the ESPE in computing environment 214. In another example, event subscription devices 1024a-c, described further with respect to FIG. 10, may also subscribe to the ESPE. The ESPE may determine or define how input data or event streams from network devices or other publishers (e.g., network devices 204-209 in FIG. 2) are transformed into meaningful output data to be consumed by subscribers, such as for example client devices 230 in FIG. 2.

FIG. 8 illustrates a block diagram including components of an Event Stream Processing Engine (ESPE), according to embodiments of the present technology. ESPE 800 may include one or more projects 802. A project may be described as a second-level container in an engine model managed by ESPE 800 where a thread pool size for the project may be defined by a user. Each project of the one or more projects 802 may include one or more continuous queries 804 that contain data flows, which are data transformations of incoming event streams. The one or more continuous queries 804 may include one or more source windows 806 and one or more derived windows 808.

The ESPE may receive streaming data over a period of time related to certain events, such as events or other data sensed by one or more network devices. The ESPE may perform operations associated with processing data created by the one or more devices. For example, the ESPE may receive data from the one or more network devices 204-209 shown in FIG. 2. As noted, the network devices may include sensors that sense different aspects of their environments, and may collect data over time based on those sensed observations. For example, the ESPE may be implemented within one or more of machines 220 and 240 shown in FIG. 2. The ESPE may be implemented within such a machine by an ESP application. An ESP application may embed an ESPE with its own dedicated thread pool or pools into its application space where the main application thread can do application-specific work and the ESPE processes event streams at least by creating an instance of a model into processing objects.

The engine container is the top-level container in a model that manages the resources of the one or more projects 802. In an illustrative embodiment, for example, there may be only one ESPE 800 for each instance of the ESP application, and ESPE 800 may have a unique engine name. Additionally, the one or more projects 802 may each have unique project names, and each query may have a unique continuous query name and begin with a uniquely named source window of the one or more source windows 806. ESPE 800 may or may not be persistent.

Continuous query modeling involves defining directed graphs of windows for event stream manipulation and transformation. A window in the context of event stream manipulation and transformation is a processing node in an event stream processing model. A window in a continuous query can perform aggregations, computations, pattern-matching, and other operations on data flowing through the window. A continuous query may be described as a directed graph of source, relational, pattern matching, and procedural windows. The one or more source windows 806 and the one or more derived windows 808 represent continuously executing queries that generate updates to a query result set as new event blocks stream through ESPE 800. A directed graph, for example, is a set of nodes connected by edges, where the edges have a direction associated with them.

An event object may be described as a packet of data accessible as a collection of fields, with at least one of the fields defined as a key or unique identifier (ID). The event object may be created using a variety of formats including binary, alphanumeric, XML, etc. Each event object may include one or more fields designated as a primary identifier (ID) for the event so ESPE 800 can support operation codes (opcodes) for events including insert, update, upsert, and delete. Upsert opcodes update the event if the key field already exists; otherwise, the event is inserted. For illustration, an event object may be a packed binary representation of a set of field values and include both metadata and field data associated with an event. The metadata may include an opcode indicating if the event represents an insert, update, delete, or upsert, a set of flags indicating if the event is a normal, partial-update, or a retention generated event from retention policy management, and a set of microsecond timestamps that can be used for latency measurements.

An event block object may be described as a grouping or package of event objects. An event stream may be described as a flow of event block objects. A continuous query of the one or more continuous queries 804 transforms a source event stream made up of streaming event block objects published into ESPE 800 into one or more output event streams using the one or more source windows 806 and the one or more derived windows 808. A continuous query can also be thought of as data flow modeling.

The one or more source windows 806 are at the top of the directed graph and have no windows feeding into them. Event streams are published into the one or more source windows 806, and from there, the event streams may be directed to the next set of connected windows as defined by the directed graph. The one or more derived windows 808 are all instantiated windows that are not source windows and that have other windows streaming events into them. The one or more derived windows 808 may perform computations or transformations on the incoming event streams. The one or more derived windows 808 transform event streams based on the window type (that is operators such as join, filter, compute, aggregate, copy, pattern match, procedural, union, etc.) and window settings. As event streams are published into ESPE 800, they are continuously queried, and the resulting sets of derived windows in these queries are continuously updated.

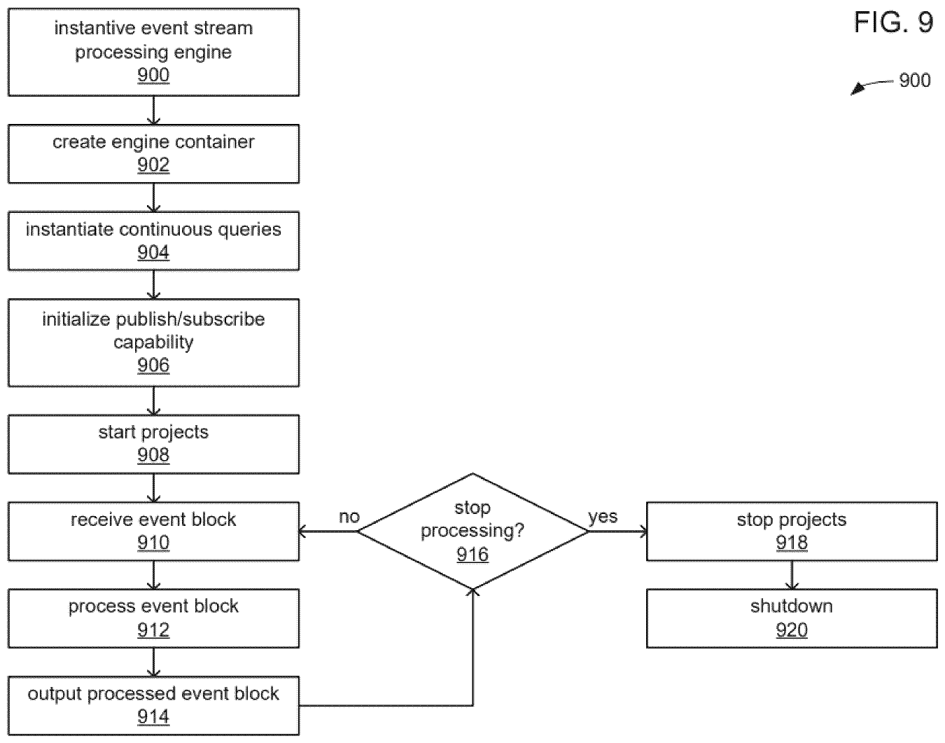

FIG. 9 illustrates a flow chart showing an example process including operations performed by an event stream processing engine, according to some embodiments of the present technology. As noted, the ESPE 800 (or an associated ESP application) defines how input event streams are transformed into meaningful output event streams. More specifically, the ESP application may define how input event streams from publishers (e.g., network devices providing sensed data) are transformed into meaningful output event streams consumed by subscribers (e.g., a data analytics project being executed by a machine or set of machines).

Within the application, a user may interact with one or more user interface windows presented to the user in a display under control of the ESPE independently or through a browser application in an order selectable by the user. For example, a user may execute an ESP application, which causes presentation of a first user interface window, which may include a plurality of menus and selectors such as drop down menus, buttons, text boxes, hyperlinks, etc. associated with the ESP application as understood by a person of skill in the art. As further understood by a person of skill in the art, various operations may be performed in parallel, for example, using a plurality of threads.

At operation 900, an ESP application may define and start an ESPE, thereby instantiating an ESPE at a device, such as machine 220 and/or 240. In an operation 902, the engine container is created. For illustration, ESPE 800 may be instantiated using a function call that specifies the engine container as a manager for the model.

In an operation 904, the one or more continuous queries 804 are instantiated by ESPE 800 as a model. The one or more continuous queries 804 may be instantiated with a dedicated thread pool or pools that generate updates as new events stream through ESPE 800. For illustration, the one or more continuous queries 804 may be created to model business processing logic within ESPE 800, to predict events within ESPE 800, to model a physical system within ESPE 800, to predict the physical system state within ESPE 800, etc. For example, as noted, ESPE 800 may be used to support sensor data monitoring and management (e.g., sensing may include force, torque, load, strain, position, temperature, air pressure, fluid flow, chemical properties, resistance, electromagnetic fields, radiation, irradiance, proximity, acoustics, moisture, distance, speed, vibrations, acceleration, electrical potential, or electrical current, etc.).

ESPE 800 may analyze and process events in motion or “event streams.” Instead of storing data and running queries against the stored data, ESPE 800 may store queries and stream data through them to allow continuous analysis of data as it is received. The one or more source windows 806 and the one or more derived windows 808 may be created based on the relational, pattern matching, and procedural algorithms that transform the input event streams into the output event streams to model, simulate, score, test, predict, etc. based on the continuous query model defined and application to the streamed data.

In an operation 906, a publish/subscribe (pub/sub) capability is initialized for ESPE 800. In an illustrative embodiment, a pub/sub capability is initialized for each project of the one or more projects 802. To initialize and enable pub/sub capability for ESPE 800, a port number may be provided. Pub/sub clients can use a host name of an ESP device running the ESPE and the port number to establish pub/sub connections to ESPE 800.

FIG. 10 illustrates an ESP system 1000 interfacing between publishing device 1022 and event subscribing devices 1024a-c, according to embodiments of the present technology. ESP system 1000 may include ESP device or subsystem 851, event publishing device 1022, an event subscribing device A 1024a, an event subscribing device B 1024b, and an event subscribing device C 1024c. Input event streams are output to ESP device 851 by publishing device 1022. In alternative embodiments, the input event streams may be created by a plurality of publishing devices. The plurality of publishing devices further may publish event streams to other ESP devices. The one or more continuous queries instantiated by ESPE 800 may analyze and process the input event streams to form output event streams output to event subscribing device A 1024a, event subscribing device B 1024b, and event subscribing device C 1024c. ESP system 1000 may include a greater or a fewer number of event subscribing devices of event subscribing devices.

Publish-subscribe is a message-oriented interaction paradigm based on indirect addressing. Processed data recipients specify their interest in receiving information from ESPE 800 by subscribing to specific classes of events, while information sources publish events to ESPE 800 without directly addressing the receiving parties. ESPE 800 coordinates the interactions and processes the data. In some cases, the data source receives confirmation that the published information has been received by a data recipient.

A publish/subscribe API may be described as a library that enables an event publisher, such as publishing device 1022, to publish event streams into ESPE 800 or an event subscriber, such as event subscribing device A 1024a, event subscribing device B 1024b, and event subscribing device C 1024c, to subscribe to event streams from ESPE 800. For illustration, one or more publish/subscribe APIs may be defined. Using the publish/subscribe API, an event publishing application may publish event streams into a running event stream processor project source window of ESPE 800, and the event subscription application may subscribe to an event stream processor project source window of ESPE 800.

The publish/subscribe API provides cross-platform connectivity and endianness compatibility between ESP application and other networked applications, such as event publishing applications instantiated at publishing device 1022, and event subscription applications instantiated at one or more of event subscribing device A 1024a, event subscribing device B 1024b, and event subscribing device C 1024c.

Referring back to FIG. 9, operation 906 initializes the publish/subscribe capability of ESPE 800. In an operation 908, the one or more projects 802 are started. The one or more started projects may run in the background on an ESP device. In an operation 910, an event block object is received from one or more computing device of the event publishing device 1022.

ESP subsystem 800 may include a publishing client 1002, ESPE 800, a subscribing client A 1004, a subscribing client B 1006, and a subscribing client C 1008. Publishing client 1002 may be started by an event publishing application executing at publishing device 1022 using the publish/subscribe API. Subscribing client A 1004 may be started by an event subscription application A, executing at event subscribing device A 1024a using the publish/subscribe API. Subscribing client B 1006 may be started by an event subscription application B executing at event subscribing device B 1024b using the publish/subscribe API. Subscribing client C 1008 may be started by an event subscription application C executing at event subscribing device C 1024c using the publish/subscribe API.

An event block object containing one or more event objects is injected into a source window of the one or more source windows 806 from an instance of an event publishing application on event publishing device 1022. The event block object may be generated, for example, by the event publishing application and may be received by publishing client 1002. A unique ID may be maintained as the event block object is passed between the one or more source windows 806 and/or the one or more derived windows 808 of ESPE 800, and to subscribing client A 1004, subscribing client B 1006, and subscribing client C 1008 and to event subscription device A 1024a, event subscription device B 1024b, and event subscription device C 1024c. Publishing client 1002 may further generate and include a unique embedded transaction ID in the event block object as the event block object is processed by a continuous query, as well as the unique ID that publishing device 1022 assigned to the event block object.

In an operation 912, the event block object is processed through the one or more continuous queries 804. In an operation 914, the processed event block object is output to one or more computing devices of the event subscribing devices 1024a-c. For example, subscribing client A 1004, subscribing client B 1006, and subscribing client C 1008 may send the received event block object to event subscription device A 1024a, event subscription device B 1024b, and event subscription device C 1024c, respectively.

ESPE 800 maintains the event block containership aspect of the received event blocks from when the event block is published into a source window and works its way through the directed graph defined by the one or more continuous queries 804 with the various event translations before being output to subscribers. Subscribers can correlate a group of subscribed events back to a group of published events by comparing the unique ID of the event block object that a publisher, such as publishing device 1022, attached to the event block object with the event block ID received by the subscriber.

In an operation 916, a determination is made concerning whether or not processing is stopped. If processing is not stopped, processing continues in operation 910 to continue receiving the one or more event streams containing event block objects from the, for example, one or more network devices. If processing is stopped, processing continues in an operation 918. In operation 918, the started projects are stopped. In operation 920, the ESPE is shutdown.

As noted, in some embodiments, big data is processed for an analytics project after the data is received and stored. In other embodiments, distributed applications process continuously flowing data in real-time from distributed sources by applying queries to the data before distributing the data to geographically distributed recipients. As noted, an event stream processing engine (ESPE) may continuously apply the queries to the data as it is received and determines which entities receive the processed data. This allows for large amounts of data being received and/or collected in a variety of environments to be processed and distributed in real time. For example, as shown with respect to FIG. 2, data may be collected from network devices that may include devices within the internet of things, such as devices within a home automation network. However, such data may be collected from a variety of different resources in a variety of different environments. In any such situation, embodiments of the present technology allow for real-time processing of such data.

Aspects of the current disclosure provide technical solutions to technical problems, such as computing problems that arise when an ESP device fails which results in a complete service interruption and potentially significant data loss. The data loss can be catastrophic when the streamed data is supporting mission critical operations such as those in support of an ongoing manufacturing or drilling operation. An embodiment of an ESP system achieves a rapid and seamless failover of ESPE running at the plurality of ESP devices without service interruption or data loss, thus significantly improving the reliability of an operational system that relies on the live or real-time processing of the data streams. The event publishing systems, the event subscribing systems, and each ESPE not executing at a failed ESP device are not aware of or effected by the failed ESP device. The ESP system may include thousands of event publishing systems and event subscribing systems. The ESP system keeps the failover logic and awareness within the boundaries of out-messaging network connector and out-messaging network device.

In one example embodiment, a system is provided to support a failover when event stream processing (ESP) event blocks. The system includes, but is not limited to, an out-messaging network device and a computing device. The computing device includes, but is not limited to, a processor and a computer-readable medium operably coupled to the processor. The processor is configured to execute an ESP engine (ESPE). The computer-readable medium has instructions stored thereon that, when executed by the processor, cause the computing device to support the failover. An event block object is received from the ESPE that includes a unique identifier. A first status of the computing device as active or standby is determined. When the first status is active, a second status of the computing device as newly active or not newly active is determined. Newly active is determined when the computing device is switched from a standby status to an active status. When the second status is newly active, a last published event block object identifier that uniquely identifies a last published event block object is determined. A next event block object is selected from a non-transitory computer-readable medium accessible by the computing device. The next event block object has an event block object identifier that is greater than the determined last published event block object identifier. The selected next event block object is published to an out-messaging network device. When the second status of the computing device is not newly active, the received event block object is published to the out-messaging network device. When the first status of the computing device is standby, the received event block object is stored in the non-transitory computer-readable medium.

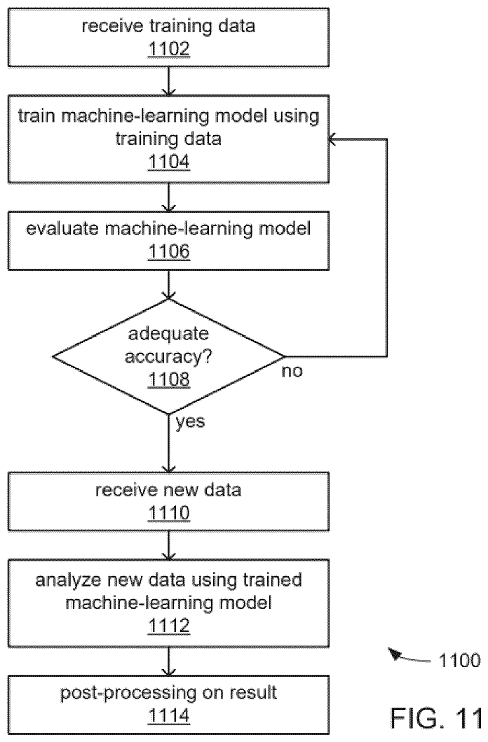

FIG. 11 is a flow chart of an example of a process for generating and using a machine-learning model according to some aspects. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bidirectional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these. Other networks may include transformers, large language models (LLMs), and agents for LLMs.

Different machine-learning models may be used interchangeably to perform a task. Examples of tasks that can be performed at least partially using machine-learning models include various types of scoring; bioinformatics; cheminformatics; software engineering; fraud detection; customer segmentation; generating online recommendations; adaptive websites; determining customer lifetime value; search engines; placing advertisements in real time or near real time; classifying DNA sequences; affective computing; performing natural language processing and understanding; object recognition and computer vision; robotic locomotion; playing games; optimization and metaheuristics; detecting network intrusions; medical diagnosis and monitoring; or predicting when an asset, such as a machine, will need maintenance.

Any number and combination of tools can be used to create machine-learning models. Examples of tools for creating and managing machine-learning models can include SAS® Enterprise Miner, SAS® Rapid Predictive Modeler, and SAS® Model Manager, SAS Cloud Analytic Services (CAS)®, SAS Viya® of all which are by SAS Institute Inc. of Cary, North Carolina.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule. An overview of training and using a machine-learning model is described below with respect to the flow chart of FIG. 11.

In block 1102, training data is received. In some examples, the training data is received from a remote database or a local database, constructed from various subsets of data, or input by a user. The training data can be used in its raw form for training a machine-learning model or pre-processed into another form, which can then be used for training the machine-learning model. For example, the raw form of the training data can be smoothed, truncated, aggregated, clustered, or otherwise manipulated into another form, which can then be used for training the machine-learning model.

In block 1104, a machine-learning model is trained using the training data. The machine-learning model can be trained in a supervised, unsupervised, or semi-supervised manner. In supervised training, each input in the training data is correlated to a desired output. This desired output may be a scalar, a vector, or a different type of data structure such as text or an image. This may enable the machine-learning model to learn a mapping between the inputs and desired outputs. In unsupervised training, the training data includes inputs, but not desired outputs, so that the machine-learning model has to find structure in the inputs on its own. In semi-supervised training, only some of the inputs in the training data are correlated to desired outputs.

In block 1106, the machine-learning model is evaluated. For example, an evaluation dataset can be obtained, for example, via user input or from a database. The evaluation dataset can include inputs correlated to desired outputs. The inputs can be provided to the machine-learning model and the outputs from the machine-learning model can be compared to the desired outputs. If the outputs from the machine-learning model closely correspond with the desired outputs, the machine-learning model may have a high degree of accuracy. For example, if 90% or more of the outputs from the machine-learning model are the same as the desired outputs in the evaluation dataset, the machine-learning model may have a high degree of accuracy. Otherwise, the machine-learning model may have a low degree of accuracy. The 90% number is an example only. A realistic and desirable accuracy percentage is dependent on the problem and the data.

In some examples, if, at 1108, the machine-learning model has an inadequate degree of accuracy for a particular task, the process can return to block 1104, where the machine-learning model can be further trained using additional training data or otherwise modified to improve accuracy. However, if, at 1108, the machine-learning model has an adequate degree of accuracy for the particular task, the process can continue to block 1110.

In block 1110, new data is received. In some examples, the new data is received from a remote database or a local database, constructed from various subsets of data, or input by a user. The new data may be unknown to the machine-learning model. For example, the machine-learning model may not have previously processed or analyzed the new data.

In block 1112, the trained machine-learning model is used to analyze the new data and provide a result. For example, the new data can be provided as input to the trained machine-learning model. The trained machine-learning model can analyze the new data and provide a result that includes a classification of the new data into a particular class, a clustering of the new data into a particular group, a prediction based on the new data, or any combination of these.

In block 1114, the result is post-processed. For example, the result can be added to, multiplied with, or otherwise combined with other data as part of a job. As another example, the result can be transformed from a first format, such as a time series format, into another format, such as a count series format. Any number and combination of operations can be performed on the result during post-processing.

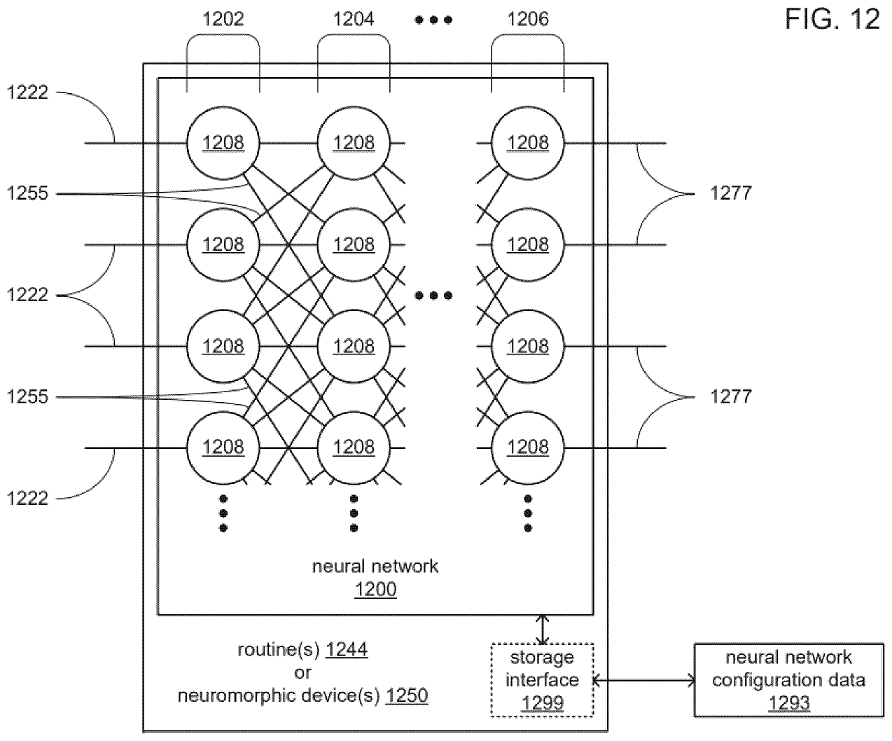

A more specific example of a machine-learning model is the neural network 1200 shown in FIG. 12. The neural network 1200 is represented as multiple layers of neurons 1208 that can exchange data between one another via connections 1255 that may be selectively instantiated thereamong. The layers include an input layer 1202 for receiving input data provided at inputs 1222, one or more hidden layers 1204, and an output layer 1206 for providing a result at outputs 1277. The hidden layer(s) 1204 are referred to as hidden because they may not be directly observable or have their inputs or outputs directly accessible during the normal functioning of the neural network 1200. Although the neural network 1200 is shown as having a specific number of layers and neurons for exemplary purposes, the neural network 1200 can have any number and combination of layers, and each layer can have any number and combination of neurons.

The neurons 1208 and connections 1255 thereamong may have numeric weights, which can be tuned during training of the neural network 1200. For example, training data can be provided to at least the inputs 1222 to the input layer 1202 of the neural network 1200, and the neural network 1200 can use the training data to tune one or more numeric weights of the neural network 1200. In some examples, the neural network 1200 can be trained using backpropagation. Backpropagation can include determining a gradient of a particular numeric weight based on a difference between an actual output of the neural network 1200 at the outputs 1277 and a desired output of the neural network 1200. Based on the gradient, one or more numeric weights of the neural network 1200 can be updated to reduce the difference therebetween, thereby increasing the accuracy of the neural network 1200. This process can be repeated multiple times to train the neural network 1200. For example, this process can be repeated hundreds or thousands of times to train the neural network 1200.

In some examples, the neural network 1200 is a feed-forward neural network. In a feed-forward neural network, the connections 1255 are instantiated and/or weighted so that every neuron 1208 only propagates an output value to a subsequent layer of the neural network 1200. For example, data may only move one direction (forward) from one neuron 1208 to the next neuron 1208 in a feed-forward neural network. Such a “forward” direction may be defined as proceeding from the input layer 1202 through the one or more hidden layers 1204, and toward the output layer 1206.

In other examples, the neural network 1200 may be a recurrent neural network. A recurrent neural network can include one or more feedback loops among the connections 1255, thereby allowing data to propagate in both forward and backward through the neural network 1200. Such a “backward” direction may be defined as proceeding in the opposite direction of forward, such as from the output layer 1206 through the one or more hidden layers 1204, and toward the input layer 1202. This can allow for information to persist within the recurrent neural network. For example, a recurrent neural network can determine an output based at least partially on information that the recurrent neural network has seen before, giving the recurrent neural network the ability to use previous input to inform the output.

In some examples, the neural network 1200 operates by receiving a vector of numbers from one layer; transforming the vector of numbers into a new vector of numbers using a matrix of numeric weights, a nonlinearity, or both; and providing the new vector of numbers to a subsequent layer (“subsequent” in the sense of moving “forward”) of the neural network 1200. Each subsequent layer of the neural network 1200 can repeat this process until the neural network 1200 outputs a final result at the outputs 1277 of the output layer 1206. For example, the neural network 1200 can receive a vector of numbers at the inputs 1222 of the input layer 1202. The neural network 1200 can multiply the vector of numbers by a matrix of numeric weights to determine a weighted vector. The matrix of numeric weights can be tuned during the training of the neural network 1200. The neural network 1200 can transform the weighted vector using a nonlinearity, such as a sigmoid tangent or the hyperbolic tangent. In some examples, the nonlinearity can include a rectified linear unit, which can be expressed using the equation y=max (x, 0) where y is the output and x is an input value from the weighted vector. The transformed output can be supplied to a subsequent layer (e.g., a hidden layer 1204) of the neural network 1200. The subsequent layer of the neural network 1200 can receive the transformed output, multiply the transformed output by a matrix of numeric weights and a nonlinearity, and provide the result to yet another layer of the neural network 1200 (e.g., another, subsequent, hidden layer 1204). This process continues until the neural network 1200 outputs a final result at the outputs 1277 of the output layer 1206.

As also depicted in FIG. 12, the neural network 1200 may be implemented either through the execution of the instructions of one or more routines 1244 by central processing units (CPUs), or through the use of one or more neuromorphic devices 1250 that incorporate a set of memristors (or other similar components) that each function to implement one of the neurons 1208 in hardware. Where multiple neuromorphic devices 1250 are used, they may be interconnected in a depth-wise manner to enable implementing neural networks with greater quantities of layers, and/or in a width-wise manner to enable implementing neural networks having greater quantities of neurons 1208 per layer.

The neuromorphic device 1250 may incorporate a storage interface 1299 by which neural network configuration data 1293 that is descriptive of various parameters and hyper parameters of the neural network 1200 may be stored and/or retrieved. More specifically, the neural network configuration data 1293 may include such parameters as weighting and/or biasing values derived through the training of the neural network 1200, as has been described. Alternatively or additionally, the neural network configuration data 1293 may include such hyperparameters as the manner in which the neurons 1208 are to be interconnected (e.g., feed-forward or recurrent), the trigger function to be implemented within the neurons 1208, the quantity of layers and/or the overall quantity of the neurons 1208. The neural network configuration data 1293 may provide such information for more than one neuromorphic device 1250 where multiple ones have been interconnected to support larger neural networks.

Other examples of the present disclosure may include any number and combination of machine-learning models having any number and combination of characteristics. The machine-learning model(s) can be trained in a supervised, semi-supervised, or unsupervised manner, or any combination of these. The machine-learning model(s) can be implemented using a single computing device or multiple computing devices, such as the communications grid computing system 400 discussed above.

Implementing some examples of the present disclosure at least in part by using machine-learning models can reduce the total number of processing iterations, time, memory, electrical power, or any combination of these consumed by a computing device when analyzing data. For example, a neural network may more readily identify patterns in data than other approaches. This may enable the neural network and/or a transformer model to analyze the data using fewer processing cycles and less memory than other approaches, while obtaining a similar or greater level of accuracy.

Some machine-learning approaches may be more efficiently and speedily executed and processed with machine-learning specific processors (e.g., not a generic CPU). Such processors may also provide energy savings when compared to generic CPUs. For example, some of these processors can include a graphical processing unit (GPU), an application-specific integrated circuit (ASIC), a field-programmable gate array (FPGA), an artificial intelligence (AI) accelerator, a neural computing core, a neural computing engine, a neural processing unit, a purpose-built chip architecture for deep learning, and/or some other machine-learning specific processor that implements a machine learning approach or one or more neural networks using semiconductor (e.g., silicon (Si), gallium arsenide (GaAs)) devices. These processors may also be employed in heterogeneous computing architectures with a number of and/or a variety of different types of cores, engines, nodes, and/or layers to achieve various energy efficiencies, processing speed improvements, data communication speed improvements, and/or data efficiency targets and improvements throughout various parts of the system when compared to a homogeneous computing architecture that employs CPUs for general purpose computing.

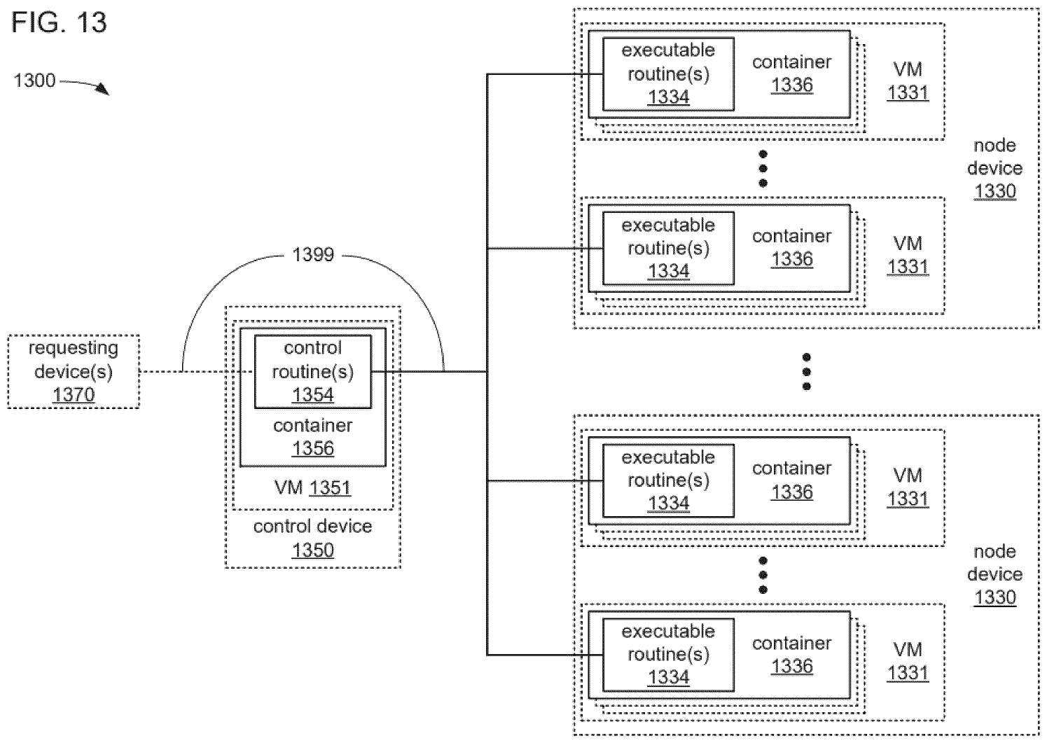

FIG. 13 illustrates various aspects of the use of containers 1336 as a mechanism to allocate processing, storage and/or other resources of a processing system 1300 to the performance of various analyses. More specifically, in a processing system 1300 that includes one or more node devices 1330 (e.g., the aforedescribed grid system 400), the processing, storage and/or other resources of each node device 1330 may be allocated through the instantiation and/or maintenance of multiple containers 1336 within the node devices 1330 to support the performance(s) of one or more analyses. As each container 1336 is instantiated, predetermined amounts of processing, storage and/or other resources may be allocated thereto as part of creating an execution environment therein in which one or more executable routines 1334 may be executed to cause the performance of part or all of each analysis that is requested to be performed.

It may be that at least a subset of the containers 1336 are each allocated a similar combination and amounts of resources so that each is of a similar configuration with a similar range of capabilities, and therefore, are interchangeable. This may be done in embodiments in which it is desired to have at least such a subset of the containers 1336 already instantiated prior to the receipt of requests to perform analyses, and thus, prior to the specific resource requirements of each of those analyses being known.

Alternatively or additionally, it may be that at least a subset of the containers 1336 are not instantiated until after the processing system 1300 receives requests to perform analyses where each request may include indications of the resources required for one of those analyses. Such information concerning resource requirements may then be used to guide the selection of resources and/or the amount of each resource allocated to each such container 1336. As a result, it may be that one or more of the containers 1336 are caused to have somewhat specialized configurations such that there may be differing types of containers to support the performance of different analyses and/or different portions of analyses.

It may be that the entirety of the logic of a requested analysis is implemented within a single executable routine 1334. In such embodiments, it may be that the entirety of that analysis is performed within a single container 1336 as that single executable routine 1334 is executed therein. However, it may be that such a single executable routine 1334, when executed, is at least intended to cause the instantiation of multiple instances of itself that are intended to be executed at least partially in parallel. This may result in the execution of multiple instances of such an executable routine 1334 within a single container 1336 and/or across multiple containers 1336.

Alternatively or additionally, it may be that the logic of a requested analysis is implemented with multiple differing executable routines 1334. In such embodiments, it may be that at least a subset of such differing executable routines 1334 are executed within a single container 1336. However, it may be that the execution of at least a subset of such differing executable routines 1334 is distributed across multiple containers 1336.

Where an executable routine 1334 of an analysis is under development, and/or is under scrutiny to confirm its functionality, it may be that the container 1336 within which that executable routine 1334 is to be executed is additionally configured assist in limiting and/or monitoring aspects of the functionality of that executable routine 1334. More specifically, the execution environment provided by such a container 1336 may be configured to enforce limitations on accesses that are allowed to be made to memory and/or I/O addresses to control what storage locations and/or I/O devices may be accessible to that executable routine 1334. Such limitations may be derived based on comments within the programming code of the executable routine 1334 and/or other information that describes what functionality the executable routine 1334 is expected to have, including what memory and/or I/O accesses are expected to be made when the executable routine 1334 is executed. Then, when the executable routine 1334 is executed within such a container 1336, the accesses that are attempted to be made by the executable routine 1334 may be monitored to identify any behavior that deviates from what is expected.

Where the possibility exists that different executable routines 1334 may be written in different programming languages, it may be that different subsets of containers 1336 are configured to support different programming languages. In such embodiments, it may be that each executable routine 1334 is analyzed to identify what programming language it is written in, and then what container 1336 is assigned to support the execution of that executable routine 1334 may be at least partially based on the identified programming language. Where the possibility exists that a single requested analysis may be based on the execution of multiple executable routines 1334 that may each be written in a different programming language, it may be that at least a subset of the containers 1336 are configured to support the performance of various data structure and/or data format conversion operations to enable a data object output by one executable routine 1334 written in one programming language to be accepted as an input to another executable routine 1334 written in another programming language.

As depicted, at least a subset of the containers 1336 may be instantiated within one or more VMs 1331 that may be instantiated within one or more node devices 1330. Thus, in some embodiments, it may be that the processing, storage and/or other resources of at least one node device 1330 may be partially allocated through the instantiation of one or more VMs 1331, and then in turn, may be further allocated within at least one VM 1331 through the instantiation of one or more containers 1336.

In some embodiments, it may be that such a nested allocation of resources may be carried out to affect an allocation of resources based on two differing criteria. By way of example, it may be that the instantiation of VMs 1331 is used to allocate the resources of a node device 1330 to multiple users or groups of users in accordance with any of a variety of service agreements by which amounts of processing, storage and/or other resources are paid for each such user or group of users. Then, within each VM 1331 or set of VMs 1331 that is allocated to a particular user or group of users, containers 1336 may be allocated to distribute the resources allocated to each VM 1331 among various analyses that are requested to be performed by that particular user or group of users.

As depicted, where the processing system 1300 includes more than one node device 1330, the processing system 1300 may also include at least one control device 1350 within which one or more control routines 1354 may be executed to control various aspects of the use of the node device(s) 1330 to perform requested analyses. By way of example, it may be that at least one control routine 1354 implements logic to control the allocation of the processing, storage and/or other resources of each node device 1300 to each VM 1331 and/or container 1336 that is instantiated therein. Thus, it may be the control device(s) 1350 that effects a nested allocation of resources, such as the aforedescribed example allocation of resources based on two differing criteria.

As also depicted, the processing system 1300 may also include one or more distinct requesting devices 1370 from which requests to perform analyses may be received by the control device(s) 1350. Thus, and by way of example, it may be that at least one control routine 1354 implements logic to monitor for the receipt of requests from authorized users and/or groups of users for various analyses to be performed using the processing, storage and/or other resources of the node device(s) 1330 of the processing system 1300. The control device(s) 1350 may receive indications of the availability of resources, the status of the performances of analyses that are already underway, and/or still other status information from the node device(s) 1330 in response to polling, at a recurring interval of time, and/or in response to the occurrence of various preselected events. More specifically, the control device(s) 1350 may receive indications of status for each container 1336, each VM 1331 and/or each node device 1330. At least one control routine 1354 may implement logic that may use such information to select container(s) 1336, VM(s) 1331 and/or node device(s) 1330 that are to be used in the execution of the executable routine(s) 1334 associated with each requested analysis.

As further depicted, in some embodiments, the one or more control routines 1354 may be executed within one or more containers 1356 and/or within one or more VMs 1351 that may be instantiated within the one or more control devices 1350. It may be that multiple instances of one or more varieties of control routine 1354 may be executed within separate containers 1356, within separate VMs 1351 and/or within separate control devices 1350 to better enable parallelized control over parallel performances of requested analyses, to provide improved redundancy against failures for such control functions, and/or to separate differing ones of the control routines 1354 that perform different functions. By way of example, it may be that multiple instances of a first variety of control routine 1354 that communicate with the requesting device(s) 1370 are executed in a first set of containers 1356 instantiated within a first VM 1351, while multiple instances of a second variety of control routine 1354 that control the allocation of resources of the node device(s) 1330 are executed in a second set of containers 1356 instantiated within a second VM 1351. It may be that the control of the allocation of resources for performing requested analyses may include deriving an order of performance of portions of each requested analysis based on such factors as data dependencies thereamong, as well as allocating the use of containers 1336 in a manner that effectuates such a derived order of performance.

Where multiple instances of control routine 1354 are used to control the allocation of resources for performing requested analyses, such as the assignment of individual ones of the containers 1336 to be used in executing executable routines 1334 of each of multiple requested analyses, it may be that each requested analysis is assigned to be controlled by just one of the instances of control routine 1354. This may be done as part of treating each requested analysis as one or more “ACID transactions” that each have the four properties of atomicity, consistency, isolation and durability such that a single instance of control routine 1354 is given full control over the entirety of each such transaction to better ensure that either all of each such transaction is either entirely performed or is entirely not performed. As will be familiar to those skilled in the art, allowing partial performances to occur may cause cache incoherencies and/or data corruption issues.

As additionally depicted, the control device(s) 1350 may communicate with the requesting device(s) 1370 and with the node device(s) 1330 through portions of a network 1399 extending thereamong. Again, such a network as the depicted network 1399 may be based on any of a variety of wired and/or wireless technologies, and may employ any of a variety of protocols by which commands, status, data and/or still other varieties of information may be exchanged. It may be that one or more instances of a control routine 1354 cause the instantiation and maintenance of a web portal or other variety of portal that is based on any of a variety of communication protocols, etc. (e.g., a restful API). Through such a portal, requests for the performance of various analyses may be received from requesting device(s) 1370, and/or the results of such requested analyses may be provided thereto. Alternatively or additionally, it may be that one or more instances of a control routine 1354 cause the instantiation of and maintenance of a message passing interface and/or message queues. Through such an interface and/or queues, individual containers 1336 may each be assigned to execute at least one executable routine 1334 associated with a requested analysis to cause the performance of at least a portion of that analysis.

Although not specifically depicted, it may be that at least one control routine 1354 may include logic to implement a form of management of the containers 1336 based on the Kubernetes container management platform promulgated by Cloud Native Computing Foundation of San Francisco, CA, USA. In such embodiments, containers 1336 in which executable routines 1334 of requested analyses may be instantiated within “pods” (not specifically shown) in which other containers may also be instantiated for the execution of other supporting routines. Such supporting routines may cooperate with control routine(s) 1354 to implement a communications protocol with the control device(s) 1350 via the network 1399 (e.g., a message passing interface, one or more message queues, etc.). Alternatively or additionally, such supporting routines may serve to provide access to one or more storage repositories (not specifically shown) in which at least data objects may be stored for use in performing the requested analyses.

The present disclosure is directed to Large Language Models (LLMs), and particularly to validating results generated from the LLMs. LLMs are useful tools to generate text. To generate text using LLMs, a prompt and a set of documents are input into the LLM. The prompt provides instructions to the LLM on how and what data to generate. LLMs suffer from many limitations when generating text. For example, LLMs are prone to hallucinations or improperly/inaccurately representing text that is not present in a set of documents. Hallucinations may refer to instances where responses generated from an LLM are factually incorrect, misleading, or entirely fabricated. Hallucinations may occur due to lack of real-time or updated knowledge. In particular, because LLMs rely on pre-trained data to generate results, the pre-trained data may not be reflective of real-time or updated knowledge base, leading to hallucinations by the LLM. In some embodiments, LLM may generate responses based on statistical probabilities instead of pattern-based predictions, also leading to hallucinations. In some embodiments, unclear or incorrect prompts to the LLM may lead to hallucinations. In some embodiments, inaccuracies or biases in the training data may lead to hallucinations. Hallucinations may occur in LLMs for other or additional reasons. Thus, LLMs have the capability to make up information or create erroneous responses. Such hallucinations may limit the usability and confidence in the LLMs. Therefore. LLMs suffer from technical problems. Accordingly, validation of the results generated by an LLM may be desirable.

Validating the result of an LLM (also referred to herein as validating an LLM) may include identifying when the LLM is hallucinating. In other words, validating the LLM may include determining or assessing the accuracy and reliability of the output generated by the LLM. Stated yet another way, validating the LLM may include determining that information generated by the LLM is in fact present in a set of documents that was input into the LLM to extract the information from.

In some situations, the problem of hallucinations in LLMs may be avoided by using models other than LLMs. For example, in some situations, Information extraction (IE) models may be used instead of LLMs. IE models are designed to convert unstructured text into structured data. While IE models may not suffer from hallucinations, these models have other limitations. For example, IE models may struggle to describe/understand contextual dependencies if there is no standardization in the input set of documents and generate sub-optimal results. Using IE models may also require building rules to be used by the IE model. Depending on the complexity of the task, building these rules may require knowledge about the task and may not be scaled well in global scenarios. Thus, using IE models instead of LLM models may not always be suitable.

In some embodiments, where use of an LLM is desired, an expert may manually validate the results generated from the LLM. Manually validating the results may entail comparing the results with the input set of documents to determine that the results are actually based upon or present in the input set of documents. However, manually validating the documents is not an easy task. Depending on the number of the input set of documents, the validations may be a time consuming, imprecise, costly, erroneous, and otherwise burdensome task, and therefore undesirable and infeasible.

The present disclosure provides technical solutions for validating LLMs. Although the present disclosure is discussed in the context of an LLM, the proposed approach may be used to validate any language models. To validate an LLM, the present disclosure computes a relevancy score for each piece of data extracted by the LLM. The relevancy score may be indicative of whether the piece of data is present in the input set of documents or not. In some embodiments, the relevancy score may also indicate how closely the piece of data matches with the information present in the input set of documents. In some embodiments, a confidence score may also be computed to determine a confidence level in the output of the LLM. In some embodiments, the present disclosure provides technical solutions to execute the LLM to extract a plurality of strings from a set of documents based on a prompt and then validate the LLM by confirming that information in the plurality of strings is found in at least one document of the set of documents. To validate the LLM, for each string of the plurality of strings, the present disclosure provides technical solutions to parse the string to generate a plurality of tokens, lemmatize each of the plurality of tokens, apply a part-of-speech label to each of the plurality of tokens, execute a filtering operation on each of the plurality of tokens that have been lemmatized and to which the part-of-speech labels have been applied to obtain a plurality of filtered tokens, automatically build a weighted categorization rule based on the plurality of filtered tokens, wherein building the weighted categorization rule comprises computing a term weight for each token of the plurality of filtered tokens, apply the weighted categorization rule to the set of documents to identify one or more text spans from the set of documents, compute a relevancy score for each of the one or more text spans extracted from the set of documents, and select the one or more text spans extracted from the set of documents having the relevancy score greater than a predetermined threshold. The greater the relevancy score, the greater a match between a text span of the one or more text spans and the string of the plurality of strings.

The proposed approach provides several advantages. For example, the present disclosure allows the use of an automatically generated rule-based categorization model to validate the output of an LLM in an information extraction task. The proposed approach may quickly create a validated set of results from an LLM to use as training or testing data for other model types. The proposed approach may allow use of optional contextual models to detect the presence of key elements like the expression of negation, doubt, historical vs. present status, fantasy vs. real situations in sentences where matches are found and incorporation of this information in the calculation of confidence scores. The proposed method allows the use of a calculation method to generate both a relevancy score and an adjusted confidence score for information extraction results generated by an LLM, with or without the use of contextual models. The proposed approach may also be used to evaluate different LLM models or different prompts by providing a quantifiable and robust metric of accuracy, providing information about the best model or prompt for the specific data or task.

The present disclosure cannot be practically performed in the human mind. In particular, an LLM cannot be validated in the human mind or using pen and paper. As discussed above, manually validating the results of an LLM is infeasible. Real-world applications may have thousands or millions of documents. A human mind is incapable of practically analyzing the large volume (e.g., 500 or greater) of textual data to validate the results of an LLM in a reasonable amount of time (e.g., a few seconds). For example, to practically and accurately validate an LLM having 500 input documents, it may take a human being several months, if they are able to do it all. The concepts of the present disclosure are not directed to any observations, evaluations, judgments, or opinions that a human mind can practically perform. Further, to be able to validate an LLM, the LLM has to be executed first to generate results. A human mind is incapable of executing a machine learning model. Thus, a computing unit is needed to perform the operations herein. Further, the present disclosure does not recite a mathematical concept but is rather based on or involves mathematical concepts. In other words, the present disclosure is not directed to mathematical relationships, any specific mathematical formulas or equations, or any particular mathematical calculations. Rather, the present disclosure is directed to systems and methods that use a novel validation technique in a non-conventional manner for validating an LLM.

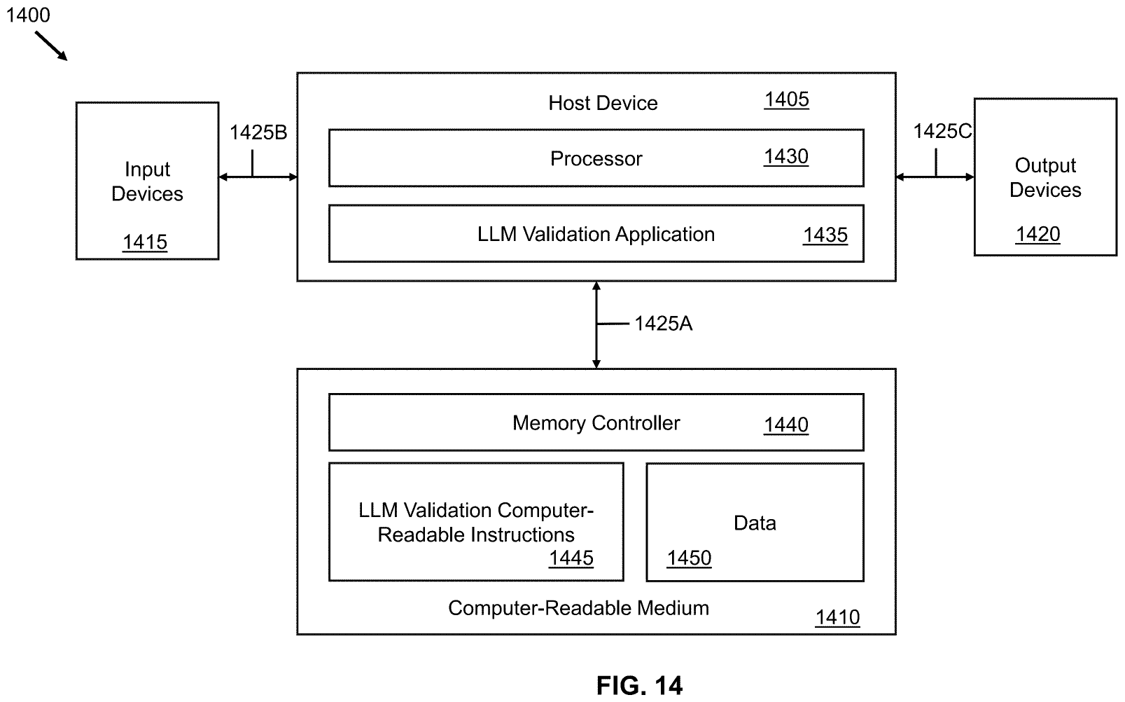

Turning now to FIG. 14, a block diagram of an example validation system 1400 is shown, in accordance with some embodiments of the present disclosure. The validation system 1400 may be part of, or otherwise associated with, the computing environment 114. The validation system 1400 includes a host device 1405 associated with a computer-readable medium 1410. The host device 1405 may be configured to receive input from one or more input devices 1415 and provide output to one or more output devices 1420. The host device 1405 may be configured to communicate with the computer-readable medium 1410, the input devices 1415, and the output devices 1420 via appropriate communication interfaces, buses, or channels 1425A, 1425B, and 1425C, respectively. The validation system 1400 may be implemented in a variety of computing devices such as computers (e.g., desktop, laptop, etc.), servers, tablets, personal digital assistants, mobile devices, wearable computing devices such as smart watches, other handheld or portable devices, or any other computing units suitable for performing operations described herein using the host device 1405.

Further, some or all of the features described in the present disclosure may be implemented on a client device, an on-premise server device, a cloud/distributed computing environment, or a combination thereof. Additionally, unless otherwise indicated, functions described herein as being performed by a computing device (e.g., the validation system 1400) may be implemented by multiple computing devices in a distributed environment, and vice versa.

The input devices 1415 may include any of a variety of input technologies such as a keyboard, stylus, touch screen, mouse, track ball, keypad, microphone, voice recognition, motion recognition, remote controllers, input ports, one or more buttons, dials, joysticks, point of sale/service devices, card readers, chip readers, and any other input peripheral that is associated with the host device 1405 and that allows an external source, such as a user, to enter information (e.g., data) into the host device and send instructions to the host device 1405. Similarly, the output devices 1420 may include a variety of output technologies such as external memories, printers, speakers, displays, microphones, light emitting diodes, headphones, plotters, speech generating devices, video devices, and any other output peripherals that are configured to receive information (e.g., data) from the host device 1405. The “data” that is either input into the host device 1405 and/or output from the host device may include any of a variety of textual data, numerical data, alphanumerical data, graphical data, video data, sound data, position data, combinations thereof, or other types of analog and/or digital data that is suitable for processing using the validation system 1400.

The host device 1405 may include a processor 1430 that may be configured to execute instructions for running one or more applications associated with the host device 1405. In some embodiments, the instructions and data needed to run the one or more applications may be stored within the computer-readable medium 1410. The host device 1405 may also be configured to store the results of running the one or more applications within the computer-readable medium 1410. One such application on the host device 1405 may be a validation application 1435. The validation application 1435 may be used to generate one or more summaries from a set of documents. For example, in some embodiments, the validation application 1435 may be configured to validate an LLM.

The validation application 1435 may be executed by the processor 1430. The instructions to execute the validation application 1435 may be stored within the computer-readable medium 1410. To facilitate communication between the host device 1405 and the computer-readable medium 1410, the computer-readable medium may include or be associated with a memory controller 1440. Although the memory controller 1440 is shown as being part of the computer-readable medium 1410, in some embodiments, the memory controller may instead be part of the host device 1405 or another element of the validation system 1400 and operatively associated with the computer-readable medium 1410. The memory controller 1440 may be configured as a logical block or circuitry that receives instructions from the host device 1405 and performs operations in accordance with those instructions. For example, to execute the validation application 1435, the host device 1405 may send a request to the memory controller 1440. The memory controller 1440 may read the instructions associated with the validation application 1435. For example, the memory controller 1440 may read validation instructions 1445 stored within the computer-readable medium 1410 and send those instructions back to the host device 1405. In some embodiments, those instructions may be temporarily stored within a memory on the host device 1405. The processor 1430 may then execute those instructions by performing one or more operations called for by those instructions.

The computer-readable medium 1410 may include one or more memory circuits. The memory circuits may be any of a variety of memory types, including a variety of volatile memories, non-volatile memories, or a combination thereof. For example, in some embodiments, one or more of the memory circuits or portions thereof may include NAND flash memory cores. In other embodiments, one or more of the memory circuits or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the computer-readable medium 1410. In some embodiments, one or more of the memory circuits or portions thereof may be configured as other types of storage class memory (“SCM”). Generally speaking, the memory circuits may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

The computer-readable medium 1410 may also be configured to store data 1450. The data 1450 may include an input set of documents. The data 1450 may also include output generated from the input set of documents by executing an LLM and/or other machine learning models described herein. The data 1450 may also include model descriptions and other information needed to implement and execute one or more machine learning models (e.g., the LLM). The data 1450 may further include any other data or information that is needed by the validation application 1435 to perform operations described herein.

It is to be understood that only some components of the validation system 1400 are shown and described in FIG. 14. However, the validation system 1400 may include other components such as various batteries and power sources, networking interfaces, routers, switches, external memory systems, controllers, etc. Generally speaking, the validation system 1400 may include any of a variety of hardware, software, and/or firmware components that are needed or considered desirable in performing the functions described herein. Similarly, the host device 1405, the input devices 1415, the output devices 1420, and the computer-readable medium 1410, including the memory controller 1440, may include hardware, software, and/or firmware components that are considered necessary or desirable in performing the functions described herein.

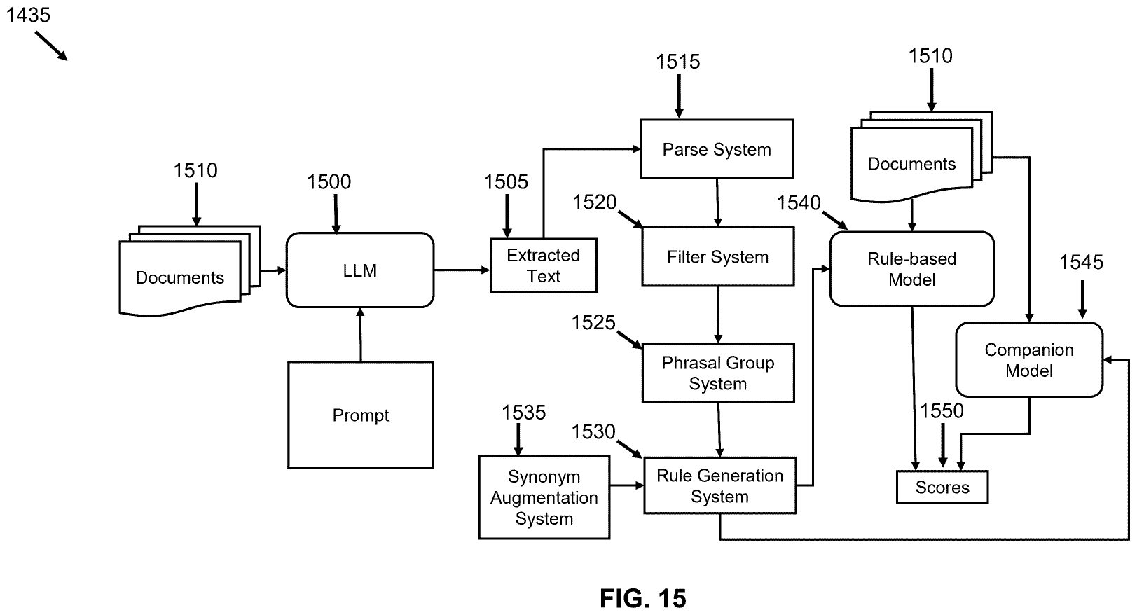

Turning now to FIG. 15, an example block diagram of the validation application 1435 is shown, in accordance with some embodiments of the present disclosure. The validation application 1435 may be used to validate an LLM 1500. Additional details about the implementation of the LLM 1500 may be found in Brown. Mann, et al. “Language Models are Few-Shot Learners” (2020), the entirety of which is incorporated by reference herein. In some embodiments, any suitable language model may be validated using the proposed approach. In some embodiments, the language model may be a Small Language Model (SLM). In some embodiments, the language model may be a Multi-Modal Large Language Model (MLLM). In some embodiments, the language model may be a visual language model. In some embodiments, the language model may be implemented in different types of human languages, including foreign human language structures and formats. In some embodiments, the language model may be another type of model that is suitable for and configured to perform the operations described herein.

To validate the LLM 1500, the validation application 1435 may determine that extracted text 1505 generated by the LLM indeed exists, matches, or is based on the text found in a set of documents 1510. Thus, to validate the LLM 1500, the set of documents 1510 may be used. In some embodiments, the set of documents 1510 may include one or more articles such as research papers, dissertations, newspapers, magazines, news, etc., customer reviews, social media posts, emails, legal documents such as contracts, patents, court filings, etc., healthcare records, books, novels, or other literary works, transcripts, reports, survey responses, cash register receipts, transcribed data, and/or any type of written record or collection of data which may be converted into textual data.

In some embodiments, the set of documents 1510 may include data other than written records. When non-textual data is to be used, the non-textual data may be converted into textual form. For example, in some embodiments, video data, audio data, image data, scanned data, etc. that is readily not technically textual data, may be converted into textual data for generating summaries therefrom. In some embodiments, image processing tools may be used to convert non-textual information into textual information. For example, in some embodiments, image processing tools may be used to detect patterns, formatting, locations, etc. of certain types of information (e.g., headings, first couple of sentences in each paragraph, beginning and ending of a document, etc.) and extract the detected information into a new document. The new document may be added to the set of documents 1510. In some embodiments, the image processing tools may be implemented as information extraction models. In other embodiments, the image processing tools may be other suitable tools.

The number of documents in the set of documents 1510 may vary as well. In some embodiments, the number of documents in the set of documents 1510 may be dependent on the LLM 1500. In some embodiments, the number of documents in the set of documents 1510 may be equal to or greater than 500 documents. In other embodiments, the number of documents in the set of documents 1510 may vary as desired. Further, in some embodiments, the set of documents 1510 may include full documents, portions of documents, summaries of documents, and/or a combination thereof.

In some embodiments, the LLM 1500 may receive the set of documents 1510 via one or more selections made through a user interface (e.g., a display associated with the output devices 1420). For example, in some embodiments, a user may provide, via a user interface, one or more selections indicating the location (e.g., file path) where the set of documents 1510 are stored. In response to the selection, the LLM 1500 may retrieve the set of documents 1510 from that location. In some embodiments, the set of documents 1510 may be provided as streaming data. Using streaming data may be advantageous when the data includes sensitive or transient information. In such situations, the relevant information may be extracted from the streaming data without needing to store the entire data, thereby preserving and safeguarding the sensitive or transient nature of the data. In some embodiments, using streaming log data may be used where only certain aspects of information from the log data are relevant. In such situations, the relevant portions of data may be extracted from the log data without needing to save the entire log data. In some embodiments, streaming data may be used where data is generated in real-time, for example, in social media context. In such cases, relevant comments may be extracted as those comments are generated, without needing to save entire conversations or data from social media. In some embodiments, the streaming data may be used in the context of ESP described above. In some embodiments, the set of documents 1510 may be provided as non-streaming data. In some embodiments, the set of documents 1510 may be directly uploaded into the LLM 1500.

The LLM 1500 may be executed to generate the extracted text 1505 from the set of documents 1510. In some embodiments, the extracted text 1505 may include a plurality of strings. In some embodiments, each string of the plurality of string may include a sequence of characters. In some embodiments, the sequence of characters may include one or more of letters, numbers, symbols, spaces, or alphanumeric characters. In some embodiments, to validate the LLM 1500, each string of the plurality of strings may be analyzed. To analyze a string of the plurality of strings to validate the LLM 1500, the string may be parsed by a parse system 1515 to generate a plurality of tokens. Each token of the plurality of tokens may be considered a unit of information (e.g., text). Each token may include one or more characters. For example, in some embodiments, a token may include a word. In some embodiments, a token may include a sub-word (e.g., half a word). In some embodiments, a token may include more than one word. In some embodiments, a token may include spaces or special characters, images, etc. The plurality of tokens may be used to validate the LLM 1500.

The plurality of tokens may be filtered using a filter system 1520. In some embodiments, the filter system 1520 may be configured to implement a first filtering operation. In some embodiments, the first filtering operation may be configured to remove tokens from the plurality of tokens that match predetermined terms in a stop list to obtain a plurality of first filtered tokens. Thus, in some embodiments, the plurality of first filtered tokens may be a subset of the plurality of tokens. In some embodiments, if none of the plurality of tokens include terms in the stop list, the plurality of first filtered tokens may be same as the plurality of tokens. The plurality of first filtered tokens may be used for a second filtering operation in a phrasal group system 1525. The phrasal group system 1525 may leverage phrasal groups such as a noun group, a verb group, an adverb group, an adjective group, or a proper noun group to filter the plurality of first filtered tokens to obtain one or more second filtered tokens. In some embodiments, the phrasal group system 1525 may use other or additional phrasal groups to implement the second filtering operation.

The one or more second filtered tokens may be used to generate one or more rules in a rule generation system 1530. The one or more rules may form the basis for validating the LLM 1500. In some embodiments, the validation application 1435 may use a synonym augmentation system 1535 to identify synonyms of the one or more second filtered tokens from the set of documents 1510. The generated/identified synonyms may be used to update the one or more rules generated by the rule generation system 1530. The one or more rules may be input into a rule-based model 1540.

In some embodiments, the rule-based model may be an information extraction (IE) model. In some embodiments, the rule-based IE model may rely on predefined patterns and rules to extract the relevant information (e.g., text segments). Unlike machine learning models, which learn from data, rule-based models use predefined rules to identify and extract information from the set of documents. For example, in some embodiments, a rule-based IE model may use pattern matching rules to identify specific sequences of text that match predetermined patterns predefined in the pattern matching rules. In some embodiments, a rule-based IE model may use linguistic rules that apply grammatical and syntactic rules to understand structure of text and identify text based on those rules. In some embodiments, a rule-based IE model may use domain-specific rules that include rules relevant to a specific domain or application (e.g., medical, legal, finance, etc.). In some embodiments, a rule-based IE model may use a combination of one or more of the pattern matching rules, linguistic rules, and domain-specific rules. In other embodiments, a rule-based IE model may use other, different, or additional types of rules. Examples of rule-based models that may be used herein may include General Architecture for Text Engineering (GATE) model, Stanford TokensRegex model, Apache Unstructured Information Management Architecture (UIMA) model, SpaCy's Matcher model, concepts model in the SAS® Visual Text Analytics provided by SAS Institute Inc. of Cary, North Carolina concepts model, etc.

In some embodiments, instead of the rule-based model 1540, a machine learning (ML) IE model may be used. An ML model may be configured to automatically learn patterns and features from the data itself to extract structured information from unstructured text. Unlike rule-based models, which rely on predefined rules to extract relevant information, ML models learn autonomously from the data (e.g., the set of documents) to extract the relevant information. In some embodiments, examples of ML models that may be used herein may include supervised learning models such as Named Entity Recognition (NER) model for identifying and classifying entities in text, Relation Extraction models like Support Vector Machines for identifying relationships between entities, Event Extraction models such as Recurrent Neural Networks (RNNs) and Transformers to identify events and associated participants, etc. In some embodiments, examples of ML models that may be used herein may also include semi-supervised learning models that may use a combination of labeled and unlabeled data to improve extraction performance, deep learning models like Bidirectional Encoder Representations from Transformers (BERT), Generative Pre-Trained Transformers (GPT), or other transformers to identify complex textual patterns, Sequence-to-Sequence models such as RNNs or transformer models for tasks like summarization and translation, etc. In some embodiments, examples of ML models that may be used herein may also include extractive summarization models that may be configured to generate summaries of text. In other embodiments, examples of ML models that may be used herein may include other, additional, or different models.

In some embodiments, a combination of one or more rule-based models may be used for the IE model. In some embodiments, a combination of one or more ML models may be used for the IE model. In some embodiments, a combination of one or more rule-based models and one or more ML models may be used. Additional details of rule-based models and ML models may be found in Tang. J . . . . Hong. M . . . . Zhang. D. L. and Li. J . . . “Information Extraction: Methodologies and Applications”, Emerging Technologies of Text Mining: Techniques and Applications (pp. 1-33) (2008), IGI Global, https://doi.org/10.4018/978-1-59904-373-9 ch001: Small S G. Medsker L, “Review of information extraction technologies and applications” (2013) Neural Computing and Applications, 25:33-548; Mooney R J. Bunescu R. “Mining Knowledge from Text Using Information Extraction,” ACM SIGKDD Explorations Newsletter, Volume 7, Issue 1 (pp 3-10) (2005), https://doi.org/10.1145/1089815.10898; Jade. Teresa. Biljana Belamaric Wilsey, and Michael Wallis. “SAS® Text Analytics for Business Applications: Concept Rules for Information Extraction Models” (2019) Cary, NC: SAS Institute Inc., the entireties of which are incorporated by reference herein. In some embodiments, a categorization model may instead be used. In some embodiments, both an IE model and a categorization model may be used such that the output of the IE Model is input into the categorization model.

The rule-based model 1540 may be executed to apply the one or more rules to the set of documents 1510 to identify one or more text spans from the set of documents. In some embodiments, each text span of the one or more text spans may include a snippet identified from the set of documents 1510 that match a rule of the one or more rules. A snippet may be a brief portion of text extracted from a document of the set of documents 1510. For example, in some embodiments, a snippet may be less than one sentence long. In some embodiments, a snippet may be greater than one word (e.g., a couple of words up to a phrase or clause in length). Thus, in some embodiments, a snippet may be greater than one word and less than one sentence. In some embodiments, a snippet may be a few sentences or a paragraph. A snippet may extract verbatim a portion of text from a document of the set of documents. In some embodiments, the one or more text spans may be used to validate the LLM 1500.

In some embodiments, a companion model 1545 may be used along with the rule-based model 1540. In some embodiments, the companion model 1545 may be an IE model (e.g., a rule-based IE model or an ML model). In some embodiments, the companion model 1545 may be a categorization model configured to categorize information from the set of documents 1510. Thus, in some embodiments, the set of documents 1510 may be input into the categorization model 1545 as well. It is to be understood that the use of the companion model 1545 is optional. In some embodiments, only the rule-based model 1540 may be used. The companion model 1545, when used, may be executed to identify presence of one or more of negation, doubt, historical status, present status, fantasy situation, or real situation in the set of documents 1510.

In some embodiments, the rules for the companion model 1545 may be generated by the rule generation system 1530. In some embodiments, the companion model 1545 may use or be associated with an additional model (e.g., a negation model). In some embodiments, the companion model 1545 and the rule-based model 1540 may be executed in parallel. In some embodiments, the output of the companion model 1545 may be used along with the output of the rule-based model 1540 to generate relevancy scores 1550. In some embodiments, the output of the companion model 1545 may be input into the rule-based model 1540 and the rule-based model may apply the one or more rules to both the set of the documents 1510 and the output of the companion model to generate the one or more text spans. In some embodiments, the output from the rule-based model 1540 may be input into the companion model 1545 and the output of the companion model may be used to generate the one or more text spans.

The relevancy scores 1550 may be used to check if the information generated in a string of the plurality of strings from the extracted text 1505 matches the information in the one or more text spans from which the relevancy scores are computed. In some embodiments, if the relevancy score of a text span is greater than a predetermined threshold, then it may be inferred that the string matches a text span of the one or more text spans. When the string matches a text span, it indicates that the string is present in the set of documents 1510, and therefore, the LLM 1500 did not hallucinate. In some embodiments, if a predetermined number of strings of the plurality of strings match the one or more text spans, then it may be inferred that the LLM is not hallucinating and therefore the LLM has been validated. In some embodiments, confidence scores may be generated to determine a confidence level in the extracted text 1505.

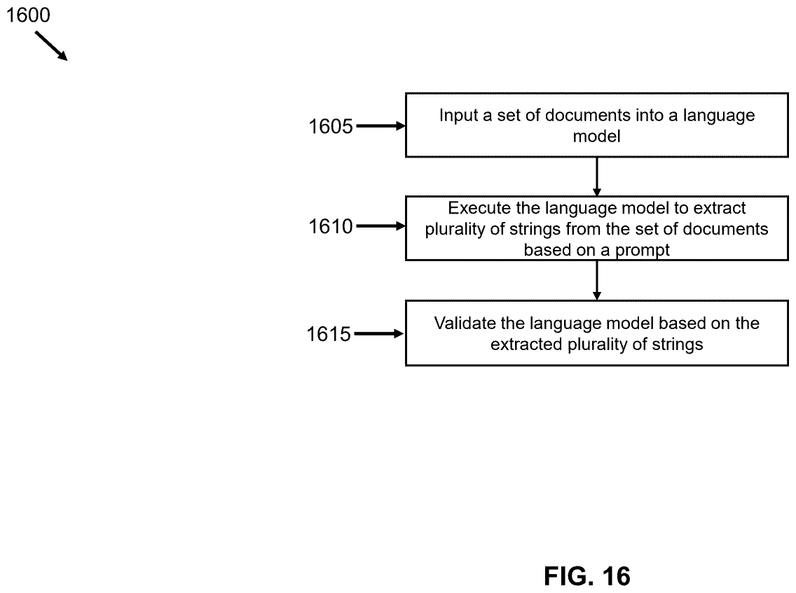

Referring now to FIG. 16, an example flowchart outlining operations of a process 1600 is shown, in accordance with some embodiments of the present disclosure. The process 1600 may be executed by one or more processors (e.g., the processor 1430) executing computer-readable instructions (e.g., the validation computer-readable instructions 1445) associated with the validation application 1435. The process 1600 may be used for validating the LLM 1500. The process 1600 may include other or additional operations in other embodiments.

At operation 1605, the processor receives a set of documents and inputs the set of documents into a language model. For example, the processor may receive the set of documents 1510 and input that set of documents in the LLM 1500.

At operation 1610, the processor executes the language model to extract a plurality of strings from the set of documents based on a prompt. In some embodiments, the prompt may be the input into the language model (e.g., the LLM 1500). In particular, the prompt may include relevant instructions to the language model on how to convert the input into an output. The language model (e.g., the LLM 1500) may be executed to extract a plurality of strings from the set of documents. For example, the LLM 1500 may be executed to generate the extracted text 1505 from the set of documents 1510. The extracted text 1505 may include a plurality of strings (e.g., a plurality of snippets). The prompt to the LLM 1500 may indicate which strings to identify from the set of documents 1510.

In some embodiments, each of the plurality of strings may be assigned a unique identifier. In some embodiments, the unique identifier may be a numerical value or index. In some embodiments the unique identifier may be an alphabetical value or an alphanumerical value. In some embodiments, the unique identifier may assume other forms. The unique identifier may be used to keep track of the string throughout the validation process. In some embodiments, the LLM (e.g., the LLM 1500) may be configured to assign each of the plurality of strings a unique identifier such that the output from the LLM includes the plurality of strings and their assigned unique identifiers. In some embodiments, the LLM may output the plurality of strings without the unique identifiers and the processor may assign the unique identifiers to the plurality of strings.

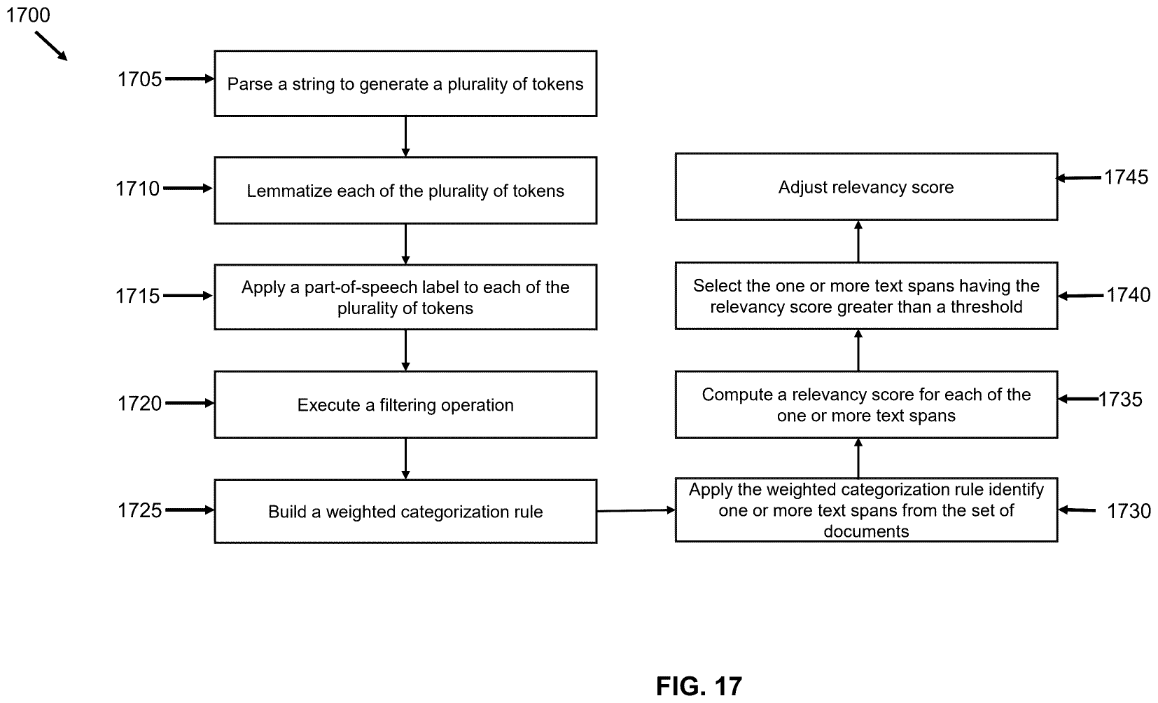

At operation 1615, the processor validates the language model by confirming that information in the plurality of strings is found in at least one document of the set of documents. For example, the processor may validate the LLM 1500 by confirming that the extracted text 1505 is indeed present in, or based on, the set of documents 1510. In some embodiments, to validate the language model, each string of the plurality of strings may be analyzed to determine presence of that string in at least one document of the set of documents 1510. In some embodiments, if a predetermined number of strings of the plurality of strings are present in, or based on, the set of documents 1510, the LLM 1500 may be validated. Validating the LLM 1500 may confirm that the LLM is not hallucinating or otherwise generating inaccurate results. Validation of the language model is discussed in greater detail in FIG. 17.

Referring to FIG. 17, an example flowchart outlining operations of a process 1700 is shown, in accordance with some embodiments of the present disclosure. The process 1700 may be executed by one or more processors (e.g., the processor 1430) executing computer-readable instructions (e.g., the validation computer-readable instructions 1445) associated with the validation application 1435. The process 1700 may be used for validating the LLM 1500. In particular, the process 1700 describes the operation 1615 in greater detail. The process 1700 may include other or additional operations in other embodiments. The process 1700 may be executed for each string of the plurality of strings extracted at the operation 1610. The description below is with respect to one string of the plurality of strings.

At operation 1705, the processor parses a string of the plurality of strings to generate a plurality of tokens. In some embodiments, the processor may apply a tokenization process to generate the plurality of tokens. In some embodiments, the processor may apply the tokenization process to determine the tokens and then identify sentences based on the tokens. Tokenization is the process of segmenting text into smaller units called tokens, corresponding to words, punctuation marks, and/or meaningful subunits. Each token may represent a single word or punctuation symbol, although in some cases, tokens may include multi-word expressions. In some embodiments, the processor may identify token boundaries by detecting whitespace and punctuation characters that separate words. In other embodiments, the processor may apply additional or alternative techniques, such as rule-based methods, machine learning models, or language-specific heuristics, to accurately segment sentences into tokens, particularly when handling contractions, abbreviations, or languages without explicit word boundaries. In some embodiments, tokenization may be performed by breaking down each sentence into the tokens. In other embodiments, the processor may apply other or additional mechanisms to generate the plurality of tokens. Additional details of tokenization may be found in Sabrina J. Mielke. Zaid Alyafeai. Elizabeth Salesky. Colin Raffel. Manan Dey. Matthias Galle. Arun Raja. Chenglei Si. Wilson Y. Lee. Benoît Sagot. Samson Tan, “Between words and characters: A Brief History of Open-Vocabulary Modeling and Tokenization in NLP” (Computing Research Repository, 2021), the entirety of which is incorporated by reference herein.

The operation 1705 may be implemented by the parse system 1515. In some embodiments, the processor may use a tokenization model to generate the plurality of tokens. For example, in some embodiments, the processor may input the string into a tokenization model and execute the tokenization model to convert the string into the plurality of tokens. The tokenization model may implement a word-based tokenization to split the string into a plurality of words, character-based tokenization to break the string into individual characters, sub-word tokenization to split the words in the string into sub-words, sentence tokenization to split the string into a plurality of sentences, or a combination thereof. In other embodiments, other or additional mechanisms may be used to parse the string into the plurality of tokens.

At operation 1710, the processor lemmatizes each of the plurality of tokens generated at the operation 1705. The operation 1710 may be implemented by the parse system 1515. Lemmatization is a process of normalizing a word to its base or root form and determining a lemma therefrom, while keeping the meaning of the word intact. In some embodiments, inflectional lemmatization may be used. In some embodiments, other types of lemmatization such as derivational lemmatization (computer, computed, computes, computational) but also (play, plays, replay, outplay, player, airplay, byplay, play book, playful, playoff, playboy), may be used. Lemmatization may help understand text better by grouping different variations of a word under a single, meaningful unit. Thus, lemmatization may recognize different forms (e.g., synonyms) of a word as the same concept. To lemmatize a token (e.g., in inflectional lemmatization), the processor may identify the token's Part-Of-Speech (POS). In some embodiments, the processor may identify the POS by analyzing a word's meaning (e.g., from a dictionary), checking for the word's position in a sentence, and/analyzing surrounding words. For example, the processor may determine whether the token is a noun, verb, adjective, adverb, etc. In some embodiments, the processor may use a POS tagging model to determine the POS of a token. In some embodiments, the POS tagging model may be a rule-based model (e.g., using predefined linguistic rules). In some embodiments, the POS tagging model may be a statistical model (e.g., using probability-based algorithms). In some embodiments, the POS tagging model may be a machine learning model (e.g., using deep learning and pre-labeled data). In some embodiments, other or additional POS tagging models may be used. An example of a POS tagging model that may be used herein may include a SpaCy POS tagging model, NLTK tagger, a POS tagging model provided by the SAS Institute Inc. of Cary, North Carolina. In other embodiments, the processor may use other or additional mechanisms to determine the POS of a token.

Responsive to determining the POS of a token, the processor may determine the root form of the token. In some embodiments, the processor may determine the root form from a dictionary accessible to the processor (e.g., the POS tagging model may be associated with a dictionary and the POS tagging model may determine the root form). In other embodiments, the processor may determine the root form in other ways. In some embodiments, the root form may be considered the most basic, irreducible part, without suffixes or prefixes, of a word. In some embodiments, the processor may then determine the lemma of the token based on the POS and the root form. For example, in some embodiments, the processor may determine the lemma from a dictionary that the processor may have access to. The processor may match the root form plus the POS from the dictionary to determine the lemma of the token. For example, the POS tagging model may be configured to determine the lemma of a token. In other embodiments, the processor may use other or additional mechanisms to determine the lemma for each token of the plurality of tokens. Additional details of lemmatization may be found in Divya Khyani. Siddhartha B S. Niveditha N M. Divya B M, “An Interpretation of Lemmatization and Stemming in Natural Language Processing” (Journal of University of Shanghai for Science and Technology, January 2021), the entirety of which is incorporated by reference herein.

At operation 1715, the processor applies a POS label to each of the plurality of tokens generated at the operation 1705. The operation 1715 may be implemented by the parse system 1515. In some embodiments, the operation 1715 may be performed simultaneously with the operation 1710 when the POS is determined. In some embodiments, the POS label may be considered a tag assigned to a token to indicate the token's grammatical role in a sentence. The POS label may help with understanding a token's structure. In some embodiments, the POS label may include one of a noun group, a verb group, an adverb group, an adjective group, a proper noun group, a noun, a verb, an adverb, an adjective, a proper noun, or a preposition. In other embodiments, other or additional POS labels may be used. In some embodiments, the POS tags for the POS labels may be NN or N for noun, V or VB for verb, JJ or ADJ for adjectives, RB for adverbs, PRP for pronouns, IN or PPOS for prepositions, CC for conjunctions, and UH for interjections. These POS tags are only an example and other notations may be used for these POS tags. In other embodiments, the POS label may include other or additional POS that may be labeled using the POS tags. In some embodiments, the POS tagging model used for lemmatization may also be used to apply the POS label to each token. In some embodiments, the POS tagging model may analyze the sentence structure and determine the syntactic role of each word in the string. Syntactic role may define the function a token plays within the structure of the string. Examples of syntactic roles may include subject (e.g., the entity performing an action), predicate (e.g., the part of the string that provides information about the subject), object (e.g., the action of the verb), modifier (e.g., adjectives, adverbs), complement (e.g., part that provides additional meaning to a verb or subject), etc. Based on the determined syntactic role, the POS tagging model may apply the POS tag to each token. In other embodiments, the processor may use other mechanisms to apply the POS labels to each token of the plurality of tokens.

Further, for each token of the plurality of tokens, the processor may associate the lemma for that token determined at the operation 1710 and the POS label for that token determined at the operation 1715 with the token. Thus, each token of the plurality of tokens may have a lemma and a POS label associated therewith. In some embodiments, the association of the lemma and the POS label with the token may be performed by the POS tagging model or in other ways. For example, in some embodiments, the POS tagging model (or another mechanism) may generate a tabular form in which each row corresponds to a token and each token may have a column for the POS label and a column for the lemma.

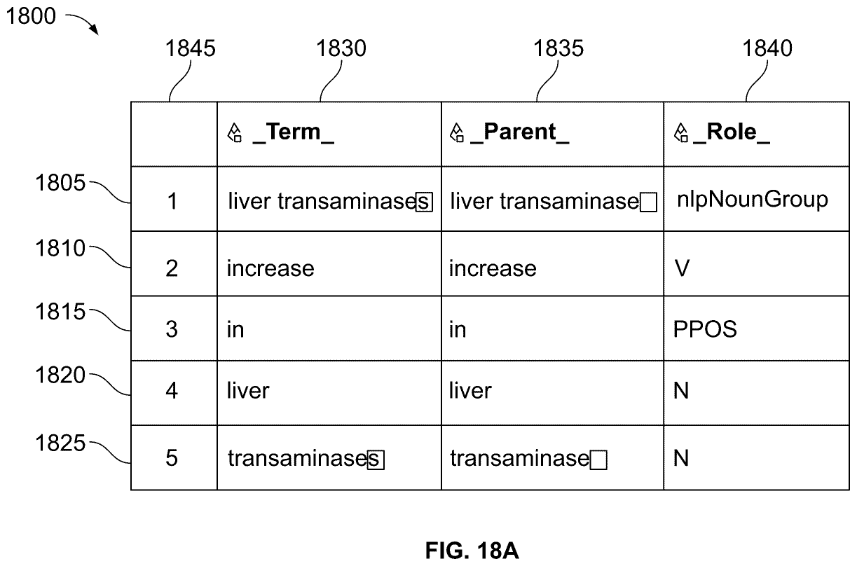

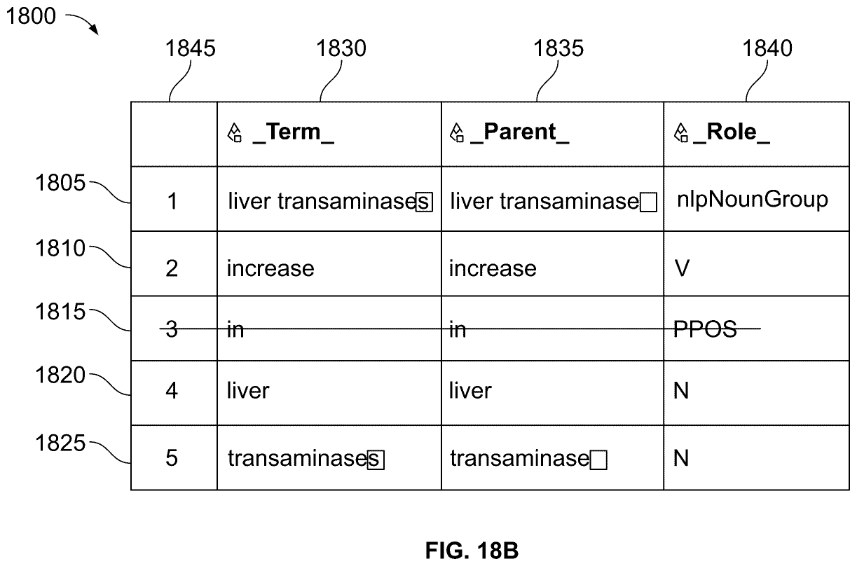

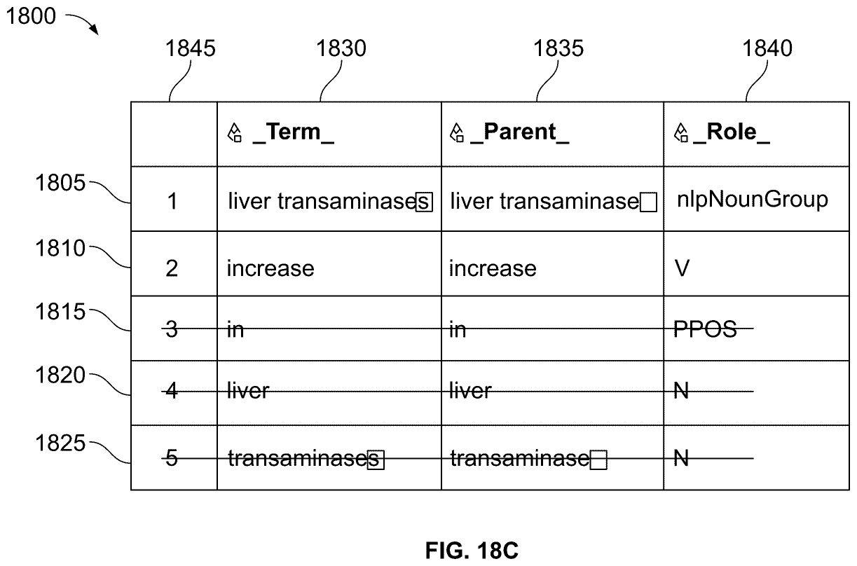

An example of the operations 1705-1715 is described in FIG. 18A. Therefore, referring to FIG. 18A in conjunction with FIG. 17, FIG. 18A is a real-world example in the health care domain for extracting adverse or undesirable effects from regulatory documents in the pharma industry. Adverse effects may include symptoms that indicate that the body is not functioning correctly or that there is an undesirable change in the body after some other action such as taking medication. The pharma industry may need to report on these effects during both the testing of new drugs as well as after the drugs have been released to the market. Therefore, understanding and acting on new findings after the release of a drug may be critical to the health of all those taking the drugs. Accordingly, expediting the process of determining the adverse effects may be meaningful to both the reputation of the pharma company and to the government agencies tasked with protecting citizens. A set of appropriate documents (e.g., the set of documents 1510) may be input into an LLM (e.g., the LLM 1500) to generate extracted text (e.g., the extracted text 1505). The LLM may be prompted to extract adverse effects from the set of documents. The text extracted by the LLM may include a plurality of strings. One such string may include “increase in liver transaminases.” The example of FIG. 18A is based on this extracted string.

FIG. 18A shows an example table 1800 listing the plurality of tokens generated at the operation 1705, the lemma for each of the tokens determined at the operation 1710, and the POS label tagged at the operation 1715. Although the information from the operations 1705-1715 is shown in a tabular form, in other embodiments, the information may be shown in other forms. The table 1800 includes a plurality of rows and a plurality of columns. Each row of the plurality of rows corresponds to one token of the plurality of tokens. For example, the string “increase in liver transaminases” may generate the following tokens: “increase.” “in,” “liver transaminases,” “liver,” and “transaminases.” Each of these tokens is listed in a separate row 1805-1825 of the table 1800 of token column 1830. The table 1800 may include a lemma column 1835 listing the lemma for each token in the rows 1805-1825. The table 1800 may also include a POS column 1840 listing the POS tag of each of the tokens in the rows 1805-1825. Thus, the information in the token column 1830 may be generated at the operation 1705, the information in the lemma column 1835 may be generated at the operation 1710, and the information in the POS column 1840 may be generated at the operation 1715. In some embodiments, the table 1800 may optionally assign each token a serial number, shown in column 1845.

It is to be understood that an example used herein is only for explanation purposes and not intended to limit the disclosure in any way.

Returning to FIG. 17, at operation 1720, the processor executes a filtering operation on each of the plurality of tokens that have been lemmatized and to which the POS labels have been applied to obtain a plurality of filtered tokens. The operation 1720 may be implemented by the filter system 1520 and the phrasal group system 1525. In some embodiments, the filtering operation may include a first filtering operation and a second filtering operation. In some embodiments, the first filtering operation and/or the second filtering operation may be optional. In some embodiments, the first filtering operation may be implemented by the filter system 1520 and the second filtering operation may be implemented by the phrasal group system 1525. In some embodiments, the first filtering operation may be performed on the plurality of tokens generated at the operation 1705 to obtain a plurality of first filtered tokens. In some embodiments, where both the first and the second filtering operations are used, the second filtering operation may be performed on the plurality of first filtered tokens to obtain one or more second filtered tokens. In some embodiments, where only the second filtering operation is used, the second filtering operation may be performed on the plurality of tokens generated at the operation 1705.

The processor may execute the first filtering operation on each of the plurality of tokens based on at least one of a stop list or the POS label to obtain a plurality of first filtered tokens. For example, in some embodiments, to execute the first filtering option, the processor may delete tokens from the plurality of tokens that match terms listed in a stop list. The stop list may be a predefined list accessible to the processor. The stop list may include certain words that may be ignored. For example, the stop list may include words that do not carry specific information such as articles, prepositions, etc. In some embodiments, the stop list may include other predefined words that are irrelevant and may be excluded. In some embodiments, the stop list may be a customizable list that may be updated by removing or adding terms to the list for a specific domain to which the set of documents (e.g., the set of documents 1510) belong. Thus, in some embodiments, the stop list may be domain specific. To execute the first filtering operation, the processor may match each token with the words in the stop list. If a token matches a word in the stop list, the processor may delete that token.

In some embodiments, instead of using a stop list, the processor may use a white list. The white list may include words that contain specific meaning and are important. In some embodiments, the white list may be based on domain. In some embodiments, when a white list is used the processor may delete all tokens of the plurality of tokens that do not match a word in the white list. In other words, the processor may keep the words in the white list and delete all others.

In some embodiments, in addition to or instead of filtering based on the stop list, the processor may execute the first filtering option by deleting tokens from the plurality of tokens whose POS label matches a predetermined POS tag. In some embodiments, the processor may consider the syntactic role of a token in deciding whether to keep or discard a token. In some embodiments, the processor may be preprogrammed to delete tokens with certain predefined syntactic roles. For example, in some embodiments, the processor may be programmed to delete tokens having articles or preposition POS tags. In some embodiments, the processor may execute the first filtering operation based on stop list and POS label simultaneously. In some embodiments, the processor may execute the first filtering operation based on stop list and POS label sequentially.

An example of the first filtering operation is shown in FIG. 18B. Thus, referring to FIG. 18B in conjunction with FIG. 17, FIG. 18B continues the example of FIG. 18A. For example, assuming the stop list includes the word “in.” Thus, the processor may determine if any of the tokens (e.g., in the token column 1830) in the table 1800 incudes only the word “in” indicated in the stop list. The processor may determine that the token in the row 1815 incudes the word “in.” Thus, the processor may delete the token “in.” For example, the processor may remove the row 1815 from the table 1800.

Returning to FIG. 17, the processor may execute the second filtering operation on the plurality of first filtered tokens based on at least one of one or more phrasal groupings or one or more entity types to obtain one or more second filtered tokens. In some embodiments, the weighted categorization rule, discussed below, may be built based on the one or more second filtered tokens. In some embodiments, the one or more phrasal groupings may include a noun group, a verb group, an adverb group, an adjective group, or a proper noun group. In some embodiments, the phrasal groupings may include other or additional groupings of syntactic roles. In some embodiments, a noun group may be a collection of words centered around a noun that function together as a unit in a sentence. In some embodiments, a noun group may not contain determiners, quantifiers, or most adverbs. In some embodiments, a noun group may not contain internal prepositions. In some embodiments, a noun group may retain close modifiers starting with nominal modifiers. In some embodiments, if nominal modifiers are not present, adverbial modifiers may be included in a noun group. In some embodiments, a noun group may not include proper nouns. In some embodiments, a verb group may include a main verb (e.g., core action), auxiliary or helping verbs (e.g., tense, aspect, voice, etc.), modals (e.g., that express ability, possibility, necessity, etc.), and particles/negations. In some embodiments, a verb group may additionally contain active/conjugated verbs and/or infinitival/unconjugated verbs and perhaps modifying adverbs. In some embodiments, an adverb group may include a main adverb and optional modifiers, intensifiers, or qualifiers. In some embodiments, an adjective group may include an adjective and any related adverbial modifiers. In some embodiments, a proper noun group is a type of a noun group and may include proper noun as a head word.

In some embodiments, the entity type may be a predefined entity type based on the domain of the set of documents. In some embodiments, the domain of the set of documents may be determined or defined by the user. In some embodiments, examples of entity types may include name, location, date, address, currency, measurement, temperature, and other relevant information for a particular domain. Based on the domain, the entity type may vary. For example, for an automobile domain, the entity type may include type of automobile (e.g., car, truck, boat, etc.), vehicle number (e.g., number plate), model of the vehicle, color of the vehicle, manufacturing location, assembly location, etc. In some embodiments, the identified entity type may be used to filter out the plurality of first filtered tokens to obtain the one or more second filtered tokens. For example, in some embodiments, each defined entity type may be treated as a phrasal group (e.g., a noun group).

To execute the second filtering option, the processor may input the plurality of first filtered tokens into an IE model (or another suitable machine learning model). The processor may execute the IE model to extract the one of one or more phrasal groupings or the one or more entity types from the plurality of first filtered tokens. The processor may identify a first filtered token from the plurality of first filtered tokens having the one or more phrasal groupings or the one or more entity types. The processor may identify each term of the first filtered token, identify other first filtered tokens from the plurality of first filtered tokens that do not have the one or more phrasal groupings or the one or more entity types as the part of speech label and that include the each term of the first filtered token. The processor may then delete each of the other first filtered tokens to obtain the one or more second filtered tokens. Thus, in the second filtering operation, tokens in the plurality of first filtered tokens that are part of a phrasal group are dropped when considered separately and just retained as part of the phrasal group.

FIG. 18C describes an example of the second filtering operation. Thus, referring to FIG. 18C in conjunction with FIG. 17, FIG. 18C continues the example of FIG. 18A. The example of FIG. 18C is based on noun groups. The processor may review the POS column 1840 to determine if any of the tokens has a noun group POS tag. In the example of FIG. 18C, the processor may determine that the token in the row 1805 has a noun group POS tag listed in the POS column 1840 (e.g., nlpNounGroup). Thus, the processor may determine that the token “liver transaminases” (e.g., the first filtered token) is a noun group. The processor may also determine that the terms of the token “liver transaminases” includes the words “liver” and “transaminases.” The processor may determine if any of the remaining tokens in the table 1800 include only the words “liver” or the word “transaminases” by analyzing the token column 1830. The processor may determine that the row 1820 includes the token “liver” and the row 1825 includes the token “transaminases.” Because both tokens are included in the noun group token of the row 1805, the tokens in the rows 1820 and 1825 are redundant and may be deleted. Thus, the processor may delete the token “liver” and “transaminases.” For example, the processor may remove the rows 1820 and 1825 during the second filtering operation along with the row 1815 deleted as part of the first filtering operation from the table 1800. Thus, at the end of the operation 1720, the plurality of tokens may include two tokens “increase” and “liver transaminases,” which may be used at the next operation.

Returning to FIG. 17, at operation 1725, the processor automatically builds a weighted categorization rule based on the plurality of filtered tokens from the operation 1720. For ease of explanation below, the weighted categorization rule is described as being created from the plurality of filtered tokens. The plurality of filtered tokens that are used for creating the weighted categorization rule may vary based upon whether a filtering operation is performed or not. For example, if the operation 1720 is not performed, then the plurality of filtered tokens may be same as the plurality of tokens generated at the operation 1705 to which lemmatization and POS labels have been applied at the operations 1710 and 1715, respectively. If only the first filtering operation is performed at the operation 1720, then the plurality of filtered tokens may include the plurality of first filtered tokens. If both the first and second filtering operations (or only the second filtering operation) are performed at the operation 1720, then the plurality of filtered tokens may include the one or more second filtered tokens.

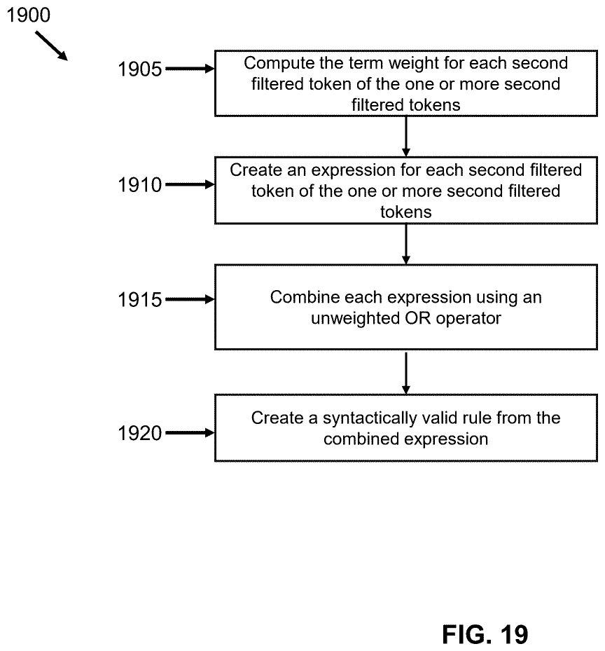

In some embodiments, the building of the weighted categorization rule may include computing a term weight for each token used for creating the weighted categorization rule. In some embodiments, each weighted categorization rule is a linguistic rule that allows analyzing the token in a broader context. In some embodiments, the weighted categorization rule may be automatically generated by the rule generation system 1530 upon receiving the tokens from which to generate the weighted categorization rule. In some embodiments, a single rule may be generated from all the tokens in the plurality of filtered tokens. For example, in some embodiments, the tokens in the plurality of filtered tokens may be concatenated using appropriate operators and the tokens may be used as arguments. For example, in the example above, the tokens “increase” and “liver transaminases” may be concatenated to create the weighted categorization rule. In some embodiments, the weighted categorization rule may also encode the unique identifier assigned to the string for which the weighted categorization rule is created for tracking purposes. The building of the weighted categorization rule is discussed in greater detail in FIG. 19.

Referring to FIG. 19 in conjunction with FIG. 17, an example flowchart outlining operations of a process 1900 is shown, in accordance with some embodiments of the present disclosure. The process 1900 may be executed by one or more processors (e.g., the processor 1430) executing computer-readable instructions (e.g., the validation computer-readable instructions 1445) associated with the validation application 1435. The process 1900 may be used for building the weighted categorization rule at the operation 1725. The process 1900 may include other or additional operations in other embodiments.

At operation 1905, the processor computes the term weight for each second filtered token of the one or more second filtered tokens. In some embodiments, the processor may compute the term weight using the following formula:

$$term weight = 1 / number\_of \_terms \qquad Equation 1$$

In Equation 1 above, term weight is the term weight for each token of the one or more second filtered tokens and the number_of_terms is a number of tokens in the one or more second filtered tokens. For example, using the example of FIGS. 18A-18C in which the one or more second filtered tokens included the tokens “increase” and “liver transaminases,” the term weight may be computed as ½ or 0.5 (since there are 2 tokens “increase” and “liver transaminases” in the one or more second filtered tokens). In some embodiments, each token in the one or more second filtered tokens may be assigned the same term weight. Thus, in some embodiments, both the token “increase” and “liver transaminases” may have a term weight of 0.5. In some embodiments, some tokens may be assigned a higher weight than other tokens. For example, in some embodiments, noun groups or other designated POS labels may be assigned a higher or lower weight than other POS labels. For example, in some embodiments, the noun group may be given a predefined multiplier (e.g., 2). In some embodiments, the multiplier may additionally or alternatively be based on the number of component tokens. In such instances, assigning the term weights may include identifying the weight of all the tokens and then multiplying the weight value by the multiplier. As an example, say a noun group includes two tokens. These two tokens may be counted as two elements in the rule. If the rule includes one other element, then the rule may be said to include three elements. The term weights in the rule may then each be about 0.3. Using a multiplier of 2 for the noun group, the element that is not part of the noun group is assigned a term weight of 0.3 and 0.6 (0.3*2) to each of the two elements in the noun group to weight the noun group higher.

At operation 1910, the processor creates an expression for each second filtered token of the one or more second filtered tokens. In some embodiments, each expression includes the second filtered token, the term weight computed for the second filtered token, and a weighted AND operator. Continuing the example above, to create an expression for the tokens “increase” and “liver transaminases,” the processor may place those tokens in double quotes as arguments of an AND operator with a term weight of 0.5. For example, the processor may create an expression for the token “increase” and an expression for the token “liver transaminases,” as follows:
(AND[0.5]. “increase @”)
(AND[0.5]. “liver transaminase @;”)

In the expressions above, the symbol “(@)” may be used to signify that all variants of the parent term must match the rule.

At operation 1915, the processor combines each expression using an unweighted OR operator. In particular, the processor may combine the expressions generated at the operation 1910 using the OR operator. For example and continuing the example above, the processor may combine the (AND[0.5]. “increase@”) and (AND[0.5]. “liver transaminase @”) expressions using the OR operator as follows:
OR (AND[0.5], “increase @;”) (AND[0.5], “liver transaminase @;”)

The OR operator is unweighted. In other words, unlike the AND operator which includes the term weight of the associated token, the OR operator does not include the term weight. The weighting of the AND operator provides information to the processor about how many terms from the rule are found in the match in the form of a relevancy score.

At operation 1920, the processor creates a syntactically valid rule from the combined expression. The syntax may include operators and their arguments being placed within parentheses and separated by commas. Arguments may be surrounded by double quotes. Weights on operators may be placed as a suffix to the operator and surrounded by square brackets. Rule IDs may be placed in front of the rule and separated by colons. For example, the combined expression may be converted into a syntactically valid rule as follows:
1:rule_1:(OR, (AND[0.5], “increase @;”), (AND[0.5], “liver transaminase (@”))

In the rule above, “1:rule_1” may be the rule ID.

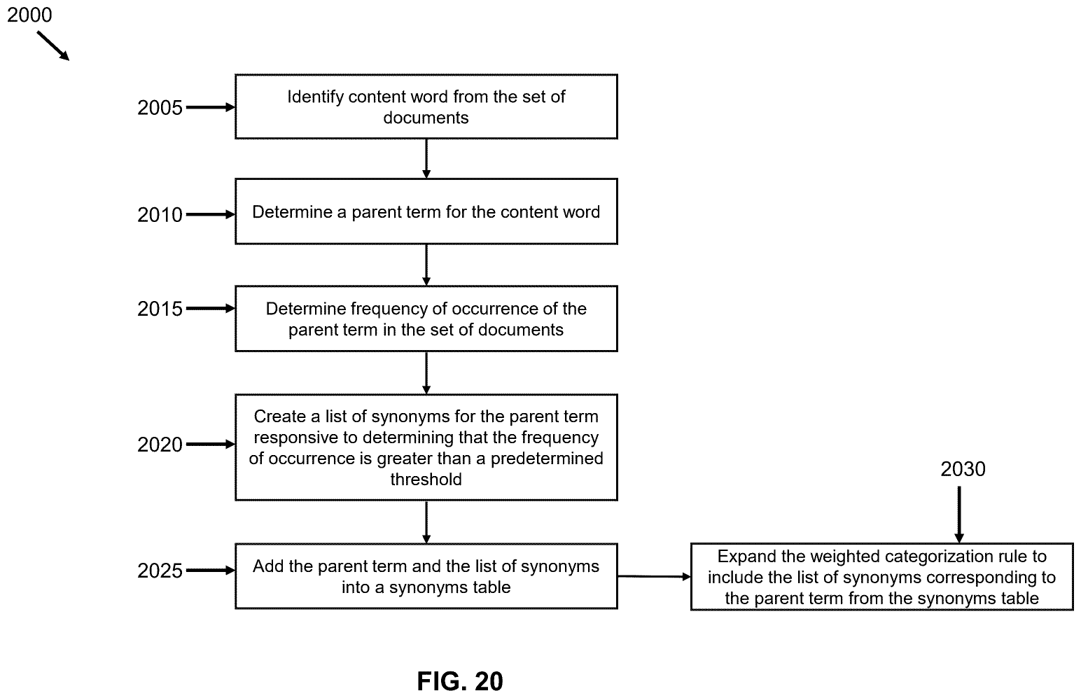

In some embodiments, the processor may use synonym augmentation to expand the rule to include synonyms. In some embodiments, the synonym augmentation may allow matching of words that are not exact matches but synonyms of a word. In other words, if a token is not an exact match in the set of documents, but a synonym of that token is found in the set of documents, the processor may determine that the token is a match with the set of documents. For example, instead of the token “increase,” in some embodiments, when synonym augmentation is implemented, if the set of documents includes the word “elevate” instead of “increase,” the processor may determine that “elevate” is a synonym of “increase” and infer a match. In some embodiments, the processor may perform synonym augmentation using a synonyms table. Synonym augmentation via the use of a synonyms table is explained in greater detail in FIG. 20. Thus, referring to FIG. 20 in conjunction with FIGS. 17 and 19, an example flowchart outlining operations of a process 2000 is shown, in accordance with some embodiments of the present disclosure. The process 2000 may be executed by one or more processors (e.g., the processor 1430) executing computer-readable instructions (e.g., the validation computer-readable instructions 1445) associated with the validation application 1435. The process 2000 may be used to build a synonyms table for performing synonym augmentation at the operation 1725. The process 2000 may include other or additional operations in other embodiments.

At operation 2005, the processor identifies a content word from the set of documents (e.g., the set of documents 1510). Content words are a technical linguistic term that may be contrasted with function words. Function words may be considered grammatical words that connect elements within and across sentences. For example, auxiliary verbs (e.g., are, have, can, etc.), prepositions (e.g., to, from, or, of, etc.), conjunctions (e.g., and, but if, etc.,), pronouns (e.g., her, I, etc.), articles (a, an, the) may be considered function words. In contrast, content words may be words that carry clear meaning. For example, main verbs (e.g., go, speak, think, etc.), nouns (e.g., cat, house, etc.), adjectives (e.g., big, difficult, etc.), and adverbs (e.g., slowly, clearly, etc.) may be content words. Additional details of identifying content words may be found in H. Bird et al . . . “Little Words”—not really: function and content words in normal and aphasic speech” (J. Neurolinguistics, 2002), the entirety of which is incorporated by reference herein.

At operation 2010, the processor determines a parent term for the content word. In some embodiments, the processor may determine the parent term in the same way as described above at the operation 1710.

At operation 2015, the processor determines a frequency of occurrence of the parent term in the set of documents. In some embodiments, the frequency of occurrence may be both for all the child forms (variants) and those counts may be added together to get the count for the parent term. In some embodiments, the processor may determine the frequency of use of a parent term in the set of documents to identify how frequently a certain parent term occurs in the document. In some embodiments, to keep the synonyms table a manageable size, in some embodiments, the synonyms table may include only those terms that are most frequently occurring in the set of documents. Thus, in some embodiments, if a parent term occurs across the set of documents greater than a predetermined threshold number of times, the processor may add the parent term to the synonyms table (e.g., hash). In some embodiments, the processor may determine the frequency of use of the parent term in the set of documents based on the lemma of a term or some other representative form.

In particular, in some embodiments, the processor may determine the set of content words from the extracted strings. For example, the processor may find a lemma and group inflectional variants under the lemma such as increases, increase, increasing, increased, etc. The processor may then identify a list of potential synonyms (lemmas) for each content word of the set of content words. In some embodiments, the processor may determine the list of potential synonyms (lemmas) based on a thesaurus or other resource (e.g., WordNet) accessible to the processor. For example, for the content word increases, increase, increasing, increased, the processor may determine the list of potential synonyms (lemmas) as elevate, grow, enlarge, expand, rise, surge, shoot up, etc. In some embodiments, the processor may run a profiling process over the set of documents to identify each content word, lemmatize (group) the content word, and count each “type” based on each form under that type that appears in the corpus. In some embodiments, this may result in a set of words (by lemma) in the data with a frequency count of each.

At operation 2020, the processor creates a list of potential synonyms for the parent term responsive to determining that the frequency of occurrence is greater than a predetermined threshold. The processor may discard the parent term if the parent term does not occur greater than the predetermined threshold number of times across the set of documents. In some embodiments, the processor may identify a minimum frequency threshold to create a list of a more manageable length. For example, in some embodiments, the processor may cut off the list at 3 counts. This means that the word (or its variants) must appear at least 3 times in all documents of the set of documents to be considered as a candidate synonym. Continuing the example above, this list may contain: surge, grow, and elevate. The processor may hash the list by lemma, then for each synonym candidate determine whether the candidate is in the hashed list. If it is, the processor may add the candidate to a new dictionary as a value associated with the extracted lemma. Using the example above, the processor may add the following to the new dictionary as follows: increase: [surge, grow, elevate]

Each of these terms may be a lemma representing a set of word forms. Then, when an extracted string contains the word “increase”, the processor may build the rule to include the other three words (surge, grow, elevate) as well. In some embodiments, the process to create the list of potential synonyms may include tokenizing the text, identifying the lemma of each word form, counting both the forms and the types (lemmas), and creating a result table of that information about the data. In some embodiments, the processor may use the procedure textprofile in SAS® Visual Text Analytics provided by SAS Institute Inc. of Cary, North Carolina, which may also profile the data set in additional ways, such as by collecting or calculating number or length of sentences, word length, document length by sentence, word type, etc.

At operation 2025, the processor adds the parent term (if not already added) and the list of synonyms into the synonyms table. The synonyms table may then be used at the operation 1725. For example, in some embodiments, the processor may determine if any of the one or more second filtered tokens match a term in the synonyms table. If so, at operation 2030, the processor expands the weighted categorization rule to include the synonyms from the synonyms table for that token. In some embodiments, the operations 2005-2025 may be executed before the process 1600 or the process 1700, or simultaneously therewith before the operation 1725. The operation 2030 may be performed along with the operation 1725. As an example, if the processor determines that the word “increase” in the one or more second filtered tokens is found in the synonyms table, the processor may expand the rule 1:rule_1:(OR, (AND[0.5], “increase (@)”), (AND[0.5], “liver transaminase (@”)) created at the operation 1725. In particular, the processor may consult the synonyms table to determine that the word “elevate” is included in the synonyms table for the word “increase.” Thus, the processor may expand the created rule to include the word “elevate” as follows:

1:rule_1:(OR, (AND[0.5], (OR, ″increase@)″, “elevate@”), (AND[0.5],
″liver transaminase@″))

In some embodiments, synonym augmentation may be performed in other ways. For example, in some embodiments, a synonym list may be used. The synonym list may include variants for each parent term that extends beyond its inflectional variants and includes the variants of the synonym. The synonym list may be then applied during the operations 1705-1715. In such an instance, the weighted categorization rule when created at the operation 1725 may automatically accommodate matches for variant forms and any synonyms when matching text in the documents. An extra synonym augmentation operation may not be needed. For example, if “elevate” is made a synonym of “increase”, then only “increase@” would be needed in the rule and would still match all variants of both parent terms.

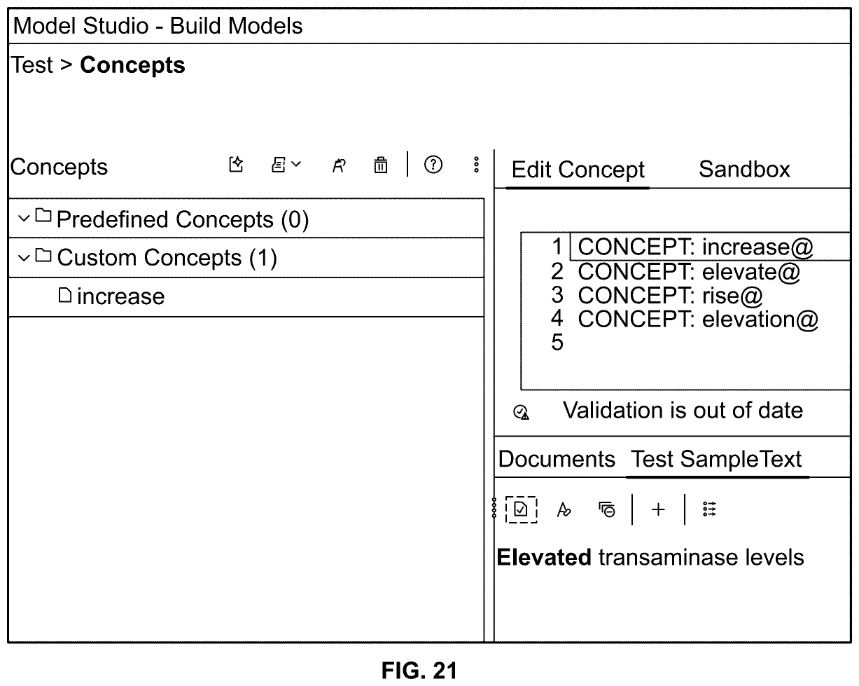

In some embodiments, certain synonyms may be put in place in a separate synonym model ahead of time and that model may be leveraged when generating the weighted categorization rule at the operation 1725. For example, in some embodiments, a companion model (e.g., the companion model 1545) may be used to perform synonym augmentation. An example screenshot of the synonym model that may be used for synonym augmentation is shown in FIG. 21. In FIG. 21, the synonym model generates the synonyms “elevate,” “rise,” and “elevation” for the token “increase.” The synonym model may generate other or additional synonyms. When a synonym model is used for synonym augmentation, the only change in the generated weighted categorization rule may be to add square brackets around any term that may use the new synonym model. For example, the weighted categorization rule 1:rule_1:(OR, (AND[0.5], “increased,”), (AND[0.5], “liver transaminase d”)) may change to 1:rule_1:(OR, (AND[0.5] “[increase]”), (AND[0.5] “liver transaminase@”)).

In some embodiments, the companion model 1545 may be used for other purposes as well. For example, if an extracted string is “increase in liver transaminases” and a text span indicates “there was no increase in liver transaminases,” then the extracted string is not a match to the text span. The companion model 1545 may be used to recognize that the text span includes a negation word (e.g., no). As another example, in the medical domain, the extracted string may be “patient has a history of elevated liver transaminases.” If the prompt to the LLM (e.g., the LLM 1500) was to look for side effects of current medical treatments, the extracted string does not indicate whether the patient experienced this symptom as a side effect of current treatments. The companion model 1545 may be used to tag the extracted string as a doubtful match, indicating a reduced confidence in the match. In some embodiments, the companion model 1545 may be used to identify other or additional sentiments.

When using the companion model 1545, in some embodiments, it may be desirable to input the plurality of strings extracted from the LLM (e.g., the LLM 1500) into the companion model 1545 (in addition to or instead of the set of documents 1510). In some embodiments, the companion model 1545 may analyze the plurality of strings using a sentence-based operator. Once the matches for this process are identified, they can be incorporated into the score calculation process. For example, in some embodiments, for each extracted string, when a match is found in the set of documents, the location of that match in a document may be marked and the companion model 1545 may be run on that same sentence (e.g., marked location). In some embodiments, the original rule may be generated and a modified version of the rule with sentence boundaries may be generated as well. The text string with the closest match to the extracted string may then be used in the process as described. In some embodiments, the sentence that contains the matched text may be run against the companion model 1545. In some embodiments, the original rule may be used to identify every sentence in the data with a negation marker and track the matches for the automatically generated rules by sentence. If the sentence of a match is also the sentence with a negation match, the confidence score may be decreased.

For example, for the companion model 1545 targeting negation scenarios for the medical domain, the companion model may implement rules such as:

```
NegationMarker:
  CLASSIFIER: not
  CLASSIFIER: history of
  CLASSIFIER: no
  CONCEPT: never report@
  CONCEPT: denied experience@
SymptomNegation:
  CONCEPT_RULE: (SENT, (SENTSTART_1, “_w”), (ORD,
  “NegationMarker”, “_c{ExtractedSymptom}”),
  (SENTEND_1, “_w”))
```

An example code for creating the weighted categorization rule may be as follows:

```
  Session set up
  libname casuser cas;
  Set up the data set with all of the extracted text strings from the LLM(s):
  data casuser.answer;
      infile datalines delimiter = ‘|’ missover;
      length side_effects varchar(*);
      input id side_effects $;
      datalines;
      1 |Changes of blood count such as thrombocytopenia and agranulocytosis
      2 |Changes of blood count such as thrombocytopenia, leucopenia and
agranulocytosis
      3 |Changes of blood count such as thrombocytopenia, leucopenia,
pancytopenia and agranulocytosis
  ;
  run;
  Parse the extracted text strings.
  proc cas;
    textParse.tpParse /
      docId=“id”
      offset={name=“pos”, replace=TRUE}
      outComplexTag=TRUE
      table={name=“answer”}
      text=“side effects”
      entities = “STD”
      language = “ENGLISH”
      ;
    run;
  /* Load stoplist*/
      table.loadTable/
        path=“en_stoplist.sashdat”, caslib = “ReferenceData”,
        casout={name=“stoplist”, caslib=“casuser”, replace = True};
      run;
    textParse.tpAccumulate /
      child={name=“child”, replace = True}
      offset={name=“pos”}
      parent={name=“parent”, replace = True}
      reduce=1
      terms={name=“terms”, replace = True}
        stoplist = {name=‘stoplist’};
    run;
  quit;
  Remove the terms from the stop list
  data casuser.terms_to_query;
      merge casuser.pos (in=a) casuser.stoplist (in=b rename=(term= _Parent_));
      by _Parent_;
      if not b;
  run;
  Filtering operation to select the terms targeted for the rule:
  data casuser.terms_to_query;
      set casuser.terms_to_query;
      where _role_in (‘nlpMeasure’,‘nlpNounGroup’,‘N’,‘V’,‘NUM’,‘PN’);
      where _parent_not in (“reaction”,“symptom”);
  run;
  If noun groups are found, then remove the terms that duplicate the noun group
tokens.
  data casuser.terms_to_query_filter;
  set casuser.terms_to_query;
  retain ng_end;
  by _document_ _start_descending_end_;
  if first._document_ then ng_end=.;
  if _role_=“nlpNounGroup” then ng_end=_end_;
  if _role_ne “nlpNounGroup” and _start_lt ng_end then delete=1;
    if delete ne 1;
  run;
  Generate rules, by first sorting the terms, so they are used in order. This enables
use of ORD or ORDDIST operators, if desired.
  proc sort data=casuser.terms_to_query_filter out=work.pos;
      by _Document_ _Start_;
  run;
  data rule;
      set pos;
      by _Document_;
      retain string;
      length string $ 800;
      length rule $ 800;
      if first._Document_ then string = ‘(OR’;
      string = catx(‘,’,strip(string),catt(‘(AND[0.5],“‘,strip(_Parent_),’@”)’));
      if last._Document_ then
          do;
            string = catx(“,strip(string),’)’);
            rule = catt(_Document ,‘:rule_’,_Document_,‘:’,string);
            output;
          end;
  run;
  data casuser.category_rules;
      set work.rule;
  run;
```

Returning to FIG. 17, at operation 1730, the processor applies the weighted categorization rule to the set of documents to identify one or more text spans from the set of documents. In some embodiments, the processor may input the weighted categorization rule into the rule-based model 1540 and the rule-based model may apply the weighted categorization rule to the set of documents (e.g., the set of documents 1510). In some embodiments, the rule-based model 1540 may identify one or more text spans from the set of documents that match the weighted categorization rule. In some embodiments, the one or more text spans may include one or more snippets from the set of documents. In some embodiments, a text span of the one or more text spans may be longer in length than a snippet. For example, in some embodiments, a text span may include a couple sentences.

At operation 1735, the processor computes a relevancy score for each of the one or more text spans extracted from the set of documents. In some embodiments, the relevancy score may be used as a metric to compare the output (e.g., the extracted text 1505) from the LLM (e.g., the LLM 1500) with the information present in the set of documents (e.g., the set of documents 1510). The one or more text spans identified at the operation 1730 may be indicative of the information present in the set of documents. By comparing the output of the LLM with the identified one or more text spans, the processor may determine whether the output matches, or is based upon, the information in the set of documents. In some embodiments, the relevancy score may be computed based on the plurality of filtered tokens used at the operation 1725 to create the weighted categorization rule and the term weight for each token of the plurality of filtered tokens used when creating the weighted categorization rule.

In some embodiments, a normalized formula may be used to compute the relevancy score. For example, in some embodiments, to compute the relevancy score for each of the one or more text spans extracted from the set of documents, the processor may compute:

$$Relevancy Score = \frac{1}{1 + {e}^{( - k ( - 0.5 + {\sum }_{x ∈ A} term {weight}_{x} ) )}} \qquad Equation 2$$

In Equation 2 above, the relevancy score is the normalized relevancy score for each text span of the one or more text spans, k is a predefined positive coefficient value (e.g., 10), term weight is the term weight for each token, x, of the plurality of filtered tokens (e.g., terms found in the document by the rule), and A is a set of found tokens in the plurality of filtered tokens that match terms found in a text span of the one or more text spans. In some embodiments, a greater value of k may make the relevancy score more concentrated on 0 or 1. In some embodiments, the relevancy score may range between (and including) 0 and 1. The higher the relevancy score, the higher the likelihood that the extracted text 1505 is found in the set of documents 1510.

Continuing with the example of FIGS. 18A-18C, if a text span identified at the operation 1730 from a set of documents includes the text “elevation in liver transaminase” and the plurality of filtered tokens from which the weighted categorization rule is created at the operation 1725 includes the tokens “increase,” and “liver transaminase,” the relevancy score for the text span may be computed as follows:

Assuming synonyms are not considered, the processor may determine the set of found tokens, A. In this example, since the word “liver transaminase” is found in the text span “elevation in liver transaminase”, the set of found tokens, A, may include “liver transaminase.” The processor may determine the term weight computed for the set of found tokens at the operation 1725. For example, the processor may determine that the term weight for “elevation in liver transaminase” was computed as 0.5. Assuming k=10, the processor may compute the relevancy score as follows:

$$Relevancy Score = \frac{1}{1 + {e}^{( - 10 ( - 0.5 + 0.5 )}} = 0.5$$

In contrast, if a text span identified at the operation 1730 from a set of documents includes the text “increase in liver transaminase,” and the plurality of filtered tokens from which the weighted categorization rule is created at the operation 1725 includes the tokens “increase,” and “liver transaminase,” the processor may determine that the set of found tokens, A, includes both “increase” and “liver transaminase.” Each of these tokens' term weight was computed as 0.5 at the operation 1725. Assuming k=10, the processor may compute the relevancy score as follows:

$$Relevancy Score = \frac{1}{1 + {e}^{( - 10 ( - 0.5 + 1. )}} \approx 0.9933$$

As another example, if the text spans include:
1) “elevated liver transaminase levels”
2) “increased liver transaminase levels”
3) “increasing liver transaminases after consumptions,” and
4) “it has been reported that liver transaminases increased in multiple cases,”

Assuming k=10, the computed relevancy scores may be as shown in Table 1 below:

TABLE 1

| | | | | Normalized |
|---|---|---|---|---|
| | | | Relevancy | Relevancy |
| Doc_Id | Result_Id | Rule | Score | Score |
| 1 | 1 | Rule_1 | 0.5 | 0.5 |
| 2 | 2 | Rule_1 | 1 | 0.9933071491 |
| 3 | 3 | Rule_1 | 1 | 0.9933071491 |
| 4 | 4 | Rule_1 | 1 | 0.9933071491 |

In some embodiments, when the processor implements synonym augmentation, the computed scores may consider synonyms and adjust the scores. For example, in some embodiments, in the text span “elevated liver transaminase levels,” the processor may consider that “elevated” is a synonym of “increased” and adjust the relevancy score to indicate that the token “increased” is also a match. Thus, at the operation 1735, the processor may compute the relevancy score for each rule for each of the one or more text spans extracted from the set of documents. An example code for computing the relevancy score may be as follows:

```
    Session set up:
    libname casuser cas;
    Place each rule that has been generated into a data set to use to score the text
documents.
    data casuser.config;
      length config $200;
      infile cards delimiter=‘|’ missover;
      input config$ id;
    cards;
    1:rule_1:(SENT, (OR, (AND[0.5], “increase@”), (AND[0.5], “liver
transaminase@”))) | 1
    ;
    run;
    Compile the rules.
    proc cas;
      loadactionset “ruledev”;
      ruledev.compileCategory
      table=“config”
      config=“config”
      ruleId=“id”
      language=“english”
      casOut={name=“mco”, replace=true}
      ;
    run;
    Apply the rules to the documents to find matches. In this example, one rule is
applied to 3 documents.
    data casuser.testing;
      length _text_$200;
      infile cards delimiter=‘|’ missover;
      input _text_$_doc_id_;
    cards;
    Medicines taken to lower fever, such as aspirin and acetaminophen, can
sometimes lead to sweating. | 1
    Medicines taken to lower fever, such as acetaminophen, can lead to sweating. | 2
    Increase in liver transaminases was discovered in some cases | 3
    ;
    run;
    proc cas;
      loadactionset “rulesco”;
      rulesco.applyCategory
      model=“mco”,
      table=“testing”
      docId=“_doc_id_”
      text=“_text_”
      scoringAlgorithm=“WEIGHTED”
      casOut={name=“casOut”, replace=true}
      matchOut={name=“matchOut”, replace=true}
      modelOut={name=“modelOut”, replace=true}
      groupedMatchOut={name=“groupedMatchOut”, replace=true}
      ;
    run;
    Normalize relevancy scores
    data casuser.casout_normalized;
  set casuser.casout;
  k = 10;
  score_normalized = 1 / (1 + exp(−k * (_score_ − 0.5)));
  drop k;
run;
```

In some embodiments, the relevancy scores may be normalized using a logistic function with the following steps: (1) Data Step: The data statement creates a new dataset called casuser.casout_normalized based on the existing dataset casuser.casout, (2) Set Statement: The set statement reads in the data from casuser.casout, (3) Parameter Initialization: The variable k is set to 10. This parameter controls the steepness of the logistic function, and (4) Normalization Calculation is performed, (5) Drop Statement:
The drop statement removes the variable k from the output dataset, as it is no longer needed, and (6) Run Statement: The run statement executes the data step.

At operation 1740, the processor selects the one or more text spans extracted from the set of documents having the relevancy score greater than a predetermined threshold. Relevancy scores that are greater than the predetermined threshold may be indicative of a greater match of the string with the text found in the set of documents. Thus, in some embodiments, the greater the relevancy score, the greater the match between a text span of the one or more text spans and the string of the plurality of strings. In some embodiments, to select the one or more text spans extracted from the set of documents (e.g., the set of documents 1510) having the relevancy score greater than the predetermined threshold, the processor may select a first plurality of text spans from the one or more text spans whose relevancy score is greater than the predetermined threshold. In some embodiments, the processor may determine a number of terms in each of the first plurality of text spans and then select one or more second text spans from the first plurality of text spans having a smallest number of terms in the first plurality of text spans. In other words, once the relevancy score for every match of a rule is found, the shortest sequence of words with the highest relevancy score may be selected. This match may contain all the terms to be found in the match. In some embodiments, the relevancy score may also be used as a basic confidence score. In some embodiments, an additional confidence score may be computed as discussed below.

In some embodiments, to select the shortest sequence, the one or more text spans may be sorted by the relevancy score and the text spans having the relevancy score greater than the predetermined threshold may be selected. If multiple text spans have the relevancy score greater than the predetermined threshold, the number of tokens in each of the multiple text spans may be determined and the text span with the smallest number of tokens may be selected. For example, in the example of Table 1 above, the processor may select any of the text spans having the relevancy score of 1 to validate the string extracted by the LLM (e.g., the LLM 1500). However, when the shortest sequence is to be selected, text span #2 may be selected. In some embodiments, if there are two or more text spans with the same relevancy score greater than the predetermined threshold and also the same length (e.g., same number of tokens), in some embodiments, any of the two or more text spans (e.g., the first one in the list) may be selected as representative of the results.

In some embodiments, each of the plurality of strings extracted by the LLM (e.g., the LLM 1500) may be validated as described herein. In some embodiments, the LLM may be said to be validated based on the compiling all the individual validations of each string of the plurality of strings. For example, in some embodiments, if a predetermined number of the plurality of strings have been validated, it may be determined that the LLM (e.g., the LLM 1500) has been validated.

At operation 1745, the processor optionally adjusts the relevancy scores. In some embodiments, the processor may determine that a text span selected at the operation 1740 is not the shortest text span but has a relevancy score greater than the predetermined threshold. In particular, the processor may determine that the text span has at least one extra term relative to the extracted string. In other words, the text span is longer than the string. Thus, responsive to determining that the text span includes at least one extra term, the processor may compute a confidence score using:

$$Confidence = Relevancy Score * ( 1 - \vert 1 - ( \frac{T * Relevancy Score}{M} ) \vert ) \qquad Equation 3$$

In Equation 3 above, Confidence is the confidence score for the text span, T is a maximum number of terms in the text span, and M is a number of terms in the text span that match a number of terms in the string. In some embodiments, the confidence score greater than a confidence threshold may be indicative of a greater match between the string and the set of documents (e.g., the set of documents 1510). The confidence score is intended to penalize the relevancy score when extra context is included in the text span. For example, if a text span included “increased or decreased liver transaminase levels,” and the plurality of filtered tokens from which the weighted categorization rule is created at the operation 1725 includes the tokens “increase,” and “liver transaminase,” the processor may determine that the text span includes an extra term “decreased.” Thus, the processor may compute the confidence score for the text span as 0.7401 (e.g., based on 4 matched terms when 3 matches are expected). The resulting confidence score is, thus, lower than the computed relevancy score of 0.99, thereby indicating a lower confidence (e.g., lower likelihood) that the string is matched with the text span.

In some embodiments, when synonym augmentation is implemented, the resulting confidence score may also consider synonyms when calculating the confidence scores. This approach may mean that as long as the LLM “extracted” text with a valid meaning in the documents, the LLM may be validated even if different wording is used in the set of documents.

In some embodiments, the confidence score (and/or the relevancy score) may be used to create training data for training other LLMs. For example, in some embodiments, the processor may compute a confidence score for each of the one or more text spans extracted at the operation 1730. In some embodiments, the processor may identify each of the one or more text spans having the confidence score greater than a threshold to obtain a subset of the one or more text spans. In some embodiments, the processor may then identify the plurality of strings corresponding to the subset of the one or more text spans to obtain a subset of the plurality of strings. The subset of the plurality of strings may indicate a match with the text found in the LLM. In some embodiments, the confidence score (and/or the relevancy score) may be used to label data for training a machine learning model or a small language model. Labeling data in such a way may enhance the power of this method because running those models over lots of data may be cheaper and faster and using am LLM to label data may be faster than human labeling. Thus, in some embodiments, the processor may train, or facilitate training of, another language model using the subset of the plurality of strings.

In some embodiments, the process 1700 may be used to compare two LLMs. For example, in some embodiments, to compare LLM 1 and LLM 2, the processor may execute the process 1700 on both the LLM 1 and LLM 2 using the same set of documents and the same prompt. The processor may compute the relevancy scores (and/or the confidence scores) for both the LLMs. For example, for LLM 1, the processor may execute a language model to extract a plurality of strings from a set of documents based on a prompt. For each string of the plurality of strings, the processor may parse the string to generate a plurality of tokens, lemmatize each of the plurality of tokens, apply a part-of-speech label to each of the plurality of tokens, execute a filtering operation on each of the plurality of tokens that have been lemmatized and to which the part-of-speech labels have been applied to obtain a plurality of filtered tokens, automatically build a weighted categorization rule based on the plurality of filtered tokens, wherein building the weighted categorization rule comprises computing a term weight for each token of the plurality of filtered tokens, apply the weighted categorization rule to the set of documents to identify one or more text spans from the set of documents, and compute a relevancy score for each of the one or more text spans extracted from the set of documents.

For LLM 2, the processor may execute a second language model to extract a plurality of second strings from the set of documents based on the prompt. For each second string of the plurality of second strings, the processor may parse the second string to generate a plurality of second tokens, lemmatize each of the plurality of second tokens, apply the part-of-speech label to each of the plurality of second tokens, execute a second filtering operation to each of the plurality of second tokens to obtain a plurality of second filtered tokens, automatically build a second weighted categorization rule from the plurality of second filtered tokens, apply the weighted categorization rule to the set of documents to identify one or more second text spans from the set of documents, and compute the relevancy score for each of the one or more second text spans extracted from the set of documents. The processor may then compare the relevancy score of the one or more second text spans with the relevancy score of the one or more text spans to compare the second language model with the language model. In some embodiments, the language model or the second language model that has a higher relevancy score has better performance.

As an example, if a set of documents includes the following text (referred to herein as true extraction): “changes of blood count such as thrombocytopenia and agranulocytosis,” that set of documents may be input into multiple LLMs along with a prompt to extract text. The extracted text from each LLM may be compared to determine the performance. Using 3 LLM models, experiments were performed, and Table 2 gives an example of the extracted text from each LLM:

TABLE 2

| | |
|---|---|
| True extraction | Changes of blood count such as thrombocytopenia |
| | and agranulocytosis |
| LLM #1 | Changes of blood count such as thrombocytopenia |
| | and agranulocytosis |
| LLM #2 | Changes of blood count such as thrombocytopenia, |
| | leucopenia and agranulocytosis |
| LLM #3 | Changes of blood count such as thrombocytopenia, |
| | leucopenia, pancytopenia and agranulocytosis |

To compare the performance of the 3 LLMs, the same weighted categorization rule was used. In some embodiments, this weighted categorization rule was created using the true extraction:

2:rule_2:(SENT, (OR,(AND[0.25],“change@”),(AND[0.25], “blood
count@”),(AND[0.25],“thrombocytopenia”),(AND[0.25],“agranulocytosis”)))

The above rule has 4 terms used as arguments connected by 4 AND operators. Applying this rule to LLM #1, LLM #2, and LLM #3, the computed relevancy and confidence scores are shown in Table 3 below and the extracted string from each LLM is shown in Table 4 below:

TABLE 3

| | | | | Normalized | |
|---|---|---|---|---|---|
| | | | Relevancy | Relevancy | Confidence |
| Doc_Id | Result_Id | Rule | Score | Score | Score |
| 1 | 1 | Rule_2 | 1 | 0.9933071491 | 0.9867 |
| 2 | 1 | Rule_2 | 1 | 0.9933071491 | 0.7893 |
| 3 | 1 | Rule_2 | 1 | 0.9933071491 | 0.6578 |

TABLE 4

| | |
|---|---|
| True Extraction | Changes of blood count such as thrombocytopenia |
| | and agranulocytosis |
| LLM #1 | Changes of blood count such as thrombocytopenia |
| | and agranulocytosis |
| LLM #2 | Changes of blood count such as thrombocytopenia, |
| | leucopenia and agranulocytosis |
| LLM #3 | Changes of blood count such as thrombocytopenia, |
| | leucopenia, pancytopenia and agranulocytosis |

Comparing the extracted string in each of the LLMs with the true extraction, it may be seen from Table 4 that LLM #2 hallucinates one additional term: “leucopenia” and the LLM #3 hallucinates two additional terms: “leucopenia” and “pancytopenia”. Since neither of those terms were in the set of documents, both those LLMs get a lower confidence score for the extraction task. Thus, it may be said that the performance of LLM #1 is superior to the performance of LLM #2 and LLM #3.

In another set of experiments inventors conducted, they looked for two entities and a relationship. Each of these items may be validated separately. In these experiments, the concatenated string containing all the elements extracted by the LLM was validated. In other words, string starting with the first element and ending with the final element as the extracted text was used. The goal was to identify the relationship between any drug and disease. The LLM was asked to extract drug names, disease or symptom names, relations, relation cue words, and the full text span. Below is an example of a few-shot prompt that was used:

_unit_id,text
711477194,”
You are expert in information extraction, and only return extractions from the given text. If
you do not find any related information in the given text, simply return ‘N/A’.
### Task:
Extract the {““drug_name””, ““disease/symptom_name””, ““relation””.
““relation_cue_words””, and the text ““match snippet”” between the drug and the
disease/symptom to indicate a relation from the given text. The relation types are [““Caused
side effect””, ““Is prescibed for””, ““Was effective against””, ““Is contraindicated in””,
““Other””].
### Examples:
**Example 1:**
**Text:** ““Ricobord, I have heard Lyme disease can get worse with steroids.””
**Output:** {““drug_name””: ““steroids””, ““disease/symptom_name””: ““Lyme disease””,
““relation””: ““Is contraindicated in””, ““relation_cue_words””: ““get worse””,
““match_snippet””: ““ have heard Lyme disease can get worse with steroids””}
**Example 2 :**
**Text:** ““I only purchased the Advair and it did help with the cough.””
**Output:** {““drug_name””: ““Advair””, ““disease/symptom_name””:
““cough””, ““relation””: ““Was effective against””, ““relation_cue_words””: ““did help””,
““match_snippet””: ““purchased the Advair and it did help with the cough””}
**Example 3:**
**Text:** ““Metformin is often prescribed to manage Type 2 diabetes.””
**Output:** {““drug_name””: ““Metformin””, ““disease/symptom_name””: ““Type 2
diabetes””, ““relation””: ““Is prescibed for””, ““relation_cue_words””: ““is often prescribed
to””, ““match_snippet””: ““Metformin is often prescribed to manage Type 2 diabetes.””}
**Example 4:**
**Text:** ““If you are on insulin and your dosage isn't right you could have low blood
sugars.””
**Output:** {““drug_name””: ““insulin””, ““disease/symptom_name””: ““low blood
sugars””, ““relation””: ““Caused side effect””, ““relation_cue_words””: ““could have””,
““match_snippet””: ““If you are on insulin and your dosage isn't right you could have low
blood sugars.””}
**Example 5:**
**Text:** ““The patient was prescribed Ibuprofen for headache relief, which significantly
reduced the pain.””
**Output:** {““drug_name””: ““Ibuprofen””, ““disease/symptom_name””: ““headache””,
““relation””: [““Is prescribed for””, ““Was effective against””], ““relation_cue_words””:
[““was prescribed””, ““significantly reduced the pain””], ““match_snippet””: ““was prescribed
Ibuprofen for headache relief, which significantly reduced the pain””}
**Example 6:**
**Text:** ““The lithium caused stomach problems, and he is now taking depakote, seraquel,
clonazapam, and remeron.””
**Output:** {““drug_name””: ““depakote””, ““disease/symptom_name””: ““stomach
problems””, ““relation””: ““Other””, ““relation_cue_words””: ““N/A””, ““match_snippet””:
““The lithium caused stomach problems, and he is now taking depakote, seraquel,
clonazapam, and remeron.””}
### Now, extract the information from the following text:
**Text:**
Medicines taken to lower fever, such as aspirin and acetaminophen, can sometimes lead to
sweating.”

Based on the above prompt, the LLM generated a plurality of responses, similar to the response below:

{ “drug_name”: [“aspirin”, “acetaminophen”], “disease/symptom_name”:
“sweating”, “relation”: “Caused side effect”, “relation_cue_words”: “can sometimes lead to”,
“match_snippet”: “ aspirin and acetaminophen, can sometimes lead to sweating.” }

The process 1700 was then applied to each of the generated responses. In particular, each of the responses from the LLM was output into the following format and saved into a file:

```
  id,Data,_unit_id,Run_date,Model_name,Is_result_generated,Extracted_result,Sent
ence
  Below is an example result: 1,../data/prompt/drug-
relation_prompt_0904.csv,711477195,2024-09-03_2317,gpt3510,Yes,“{““drug_name””:
““aspirin and acetaminophen””, ““disease/symptom_name””: ““sweating””, ““relation””:
““Caused side effect””, ““relation_cue_words””: ““can sometimes lead to””,
““match_snippet””: ““aspirin and acetaminophen, can sometimes lead to sweating.””},
{““sentence””: ““Medicines taken to lower fever, such as aspirin and acetaminophen, can
sometimes lead to sweating.”}
```

Here is the result of running parsing over the match snippet:

```
  Term_,_Role_,_Attribute_,_Parent_,_Start_,_End_,_Sentence_,_Paragraph_,_Do
cument_{—}
  aspirin,N,1.0,aspirin,40.0,46.0,1.0,0.0,711477195.0
  and,CONJ,1.0,and,48.0,50.0,1.0,0.0,711477195.0
  acetaminophen,N,1.0,acetaminophen,52.0,64.0,1.0,0.0,711477195.0
  can,V,1.0,can,67.0,69.0,1.0,0.0,711477195.0
  sometimes,ADV,1.0,sometimes,71.0,79.0,1.0,0.0,711477195.0
  lead,V,1.0,lead,81.0,84.0,1.0,0.0,711477195.0
  to,PPOS,1.0,to,86.0,87.0,1.0,0.0,711477195.0
  sweating,V,1.0,sweat,89.0,96.0,1.0,0.0,711477195.0
  Here is the result of running the filtering process over the results of parsing:
  _Term_,_Role_,_Attribute_,_Parent_,_Start_,_End_,_Sentence_,_Paragraph_,_Do
cument_{—}
  aspirin,N,1.0,aspirin,40.0,46.0,1.0,0.0,711477195.0
  acetaminophen,N,1.0,acetaminophen,52.0,64.0,1.0,0.0,711477195.0
  can,V,1.0,can,67.0,69.0,1.0,0.0,711477195.0
  sometimes,ADV,1.0,sometimes,71.0,79.0,1.0,0.0,711477195.0
  lead,V,1.0,lead,81.0,84.0,1.0,0.0,711477195.0
  sweating,V,1.0,sweat,89.0,96.0,1.0,0.0,711477195.0
```

Using the above extracted strings, an example rule generated from these terms:

```
  rule_num,category,rule_definition
  2:rule_711477195:“(OR,(AND[0.2],““aspirin@””),(AND[0.2],““acetaminophen@
””),(AND[0.2],““can@””),(AND[0.2],““sometimes@””),(AND[0.2],““lead@””),(AND[0.2],““
sweat@””))”
```

There are 6 terms in the rule. The term weight was rounded up to the nearest tenth after applying the basic term weight calculation using the following modified formula:

$$term weight = ⌈ ( \frac{1}{{number}_{{of}_{terms}}} ) * 10 ⌉ / 10 \qquad Equation 5$$

Below is an example with a relevancy score calculation for the sentence:
“Medicines taken to lower fever, such as aspirin and acetaminophen, can sometimes lead to sweating”

TABLE 5

| | | | Normalized |
|---|---|---|---|
| Doc_Id | Result_Id | Rule | Relevancy Score |
| 0 | 1 | Rule_711477195 | 0.9990889492 |

A categorization model from all the rules was built (e.g., using the textRuleDevelop action in SAS® Visual Text Analytics provided by SAS Institute Inc. of Cary, North Carolina). The textRuleScore action was executed to apply the model to each matched text segment. For the experiments, here are the matchout table results for the selected document:

```
  _unit_id,_result_id_,_start_,_end_,_match_text_{—}
  711477195.0,1.0,40.0,46.0,aspirin
  711477195.0,1.0,52.0,64.0,acetaminophen
711477195.0,1.0,67.0,69.0,can
711477195.0,1.0,71.0,79.0,sometimes
711477195.0,1.0,81.0,84.0,lead
711477195.0,1.0,89.0,96.0,sweating
```

Here is the output of the example after calculating the confidence score:

_unit_id,match,sentence,category,confidence

711477195.0, “aspirin and acetaminophen, can sometimes lead to sweating”, “Medicines taken to lower fever, such as aspirin and acetaminophen, can sometimes lead to sweating”,rule_711477195,1.0

Table 6 below shows an output table detailing results for 30 extractions from two different LLMs:

TABLE 6

| | | Confidence | Confidence |
|---|---|---|---|
| | | Scores of | Scores of |
| | _unit_id | GPT model | PH13 Model |
| 1 | 711477194 | 1.000000 | 0.076923 |
| 2 | 711477195 | 1.000000 | 0.076923 |
| 3 | 711477196 | 1.000000 | 0.230769 |
| 4 | 711477197 | 1.000000 | N/A |
| 5 | 711477198 | 0.888889 | 0.076923 |
| 6 | 711477199 | 1.000000 | N/A |
| 7 | 711477200 | 1.000000 | N/A |
| 8 | 711477201 | 1.000000 | 0.230769 |
| 9 | 711477202 | 1.000000 | 0.230769 |
| 10 | 711477203 | 1.000000 | N/A |
| 11 | 711477204 | 1.000000 | N/A |
| 12 | 711477205 | 1.000000 | 0.076923 |
| 13 | 711477206 | 1.000000 | N/A |
| 14 | 711477207 | 1.000000 | 0.153846 |
| 15 | 711477208 | 1.000000 | 0.307692 |
| 16 | 711477209 | 0.857143 | 0.076923 |
| 17 | 711477210 | 1.000000 | 0.076923 |
| 18 | 711477211 | 1.000000 | 0.230769 |
| 19 | 711477212 | 1.000000 | 0.230769 |
| 20 | 711477213 | 1.000000 | 0.307692 |
| 21 | 711483482 | 0.916667 | 0.307692 |
| 22 | 711483483 | 1.000000 | 0.230769 |
| 23 | 711483484 | 1.000000 | N/A |
| 24 | 711483485 | 1.000000 | 0.307692 |
| 25 | 711483486 | 0.900000 | N/A |
| 26 | 711483487 | 1.000000 | 0.076923 |
| 27 | 711483488 | 1.000000 | 0.076923 |
| 28 | 711483489 | 1.000000 | 0.307692 |
| 29 | 711483490 | 1.000000 | N/A |
| 30 | 711483491 | 0.875000 | 0.230769 |

Comparing the confidence scores of the GPT model with that of the PHI3 model from Table 6 above, it may be seen that the GPT model performed better at extracting these items than the PHI3 model. Table 7 below summarizes the performance of each model:

TABLE 7

| | name | count | mean | std | min | max |
|---|---|---|---|---|---|---|
| 1 | gpt3510_match | 30 | 0.981257 | 0.043464 | 0.857143 | 1.000000 |
| 2 | Phi3_match | 21 | 0.186813 | 0.095989 | 0.076923 | 0.307692 |

As seen from Table 7 above, the number of properly extracted items was lower for the PHI3 model at a count of 21. For the extracted items, the confidence average was 98% for the GPT model and only 18% for the PHI3 model. This experiment shows that the process 1700 is a useful methodology to compare model behavior for a given model. The proposed approach may also be used to tune prompts for a given task by applying the approach to each prompt provided to the same model and calculating the table above per prompt.

It is to be understood that although all examples used herein are English language examples, in some embodiments, the teachings of the present disclosure are equally applicable to other languages to validate language models.

The herein described subject matter illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected.” or “operably coupled,” to each other to achieve the desired functionality, and any two components capable of being so associated can also be viewed as being “operably couplable.” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the disclosure be defined by the claims appended hereto and their equivalents. The word “illustrative” is used herein to mean serving as an example, instance, or illustration. Any aspect or design described herein as “illustrative” is not necessarily to be construed as preferred or advantageous over other aspects or designs.

What is claimed is:

1. A non-transitory computer-readable medium comprising computer-readable instructions stored thereon that when executed by a processor cause the processor to:
execute a language model to extract a plurality of strings from a set of documents based on a prompt; and
validate the language model by confirming that information in the plurality of strings is found in at least one document of the set of documents, wherein to validate the language model, for each string of the plurality of strings, the computer-readable instructions further cause the processor to:
parse the string to generate a plurality of tokens;
lemmatize each of the plurality of tokens;
apply a part-of-speech label to each of the plurality of tokens;
execute a filtering operation on each of the plurality of tokens that have been lemmatized and to which the part-of-speech labels have been applied to obtain a plurality of filtered tokens;
automatically build a weighted categorization rule based on the plurality of filtered tokens, wherein building the weighted categorization rule comprises computing a term weight for each token of the plurality of filtered tokens;
apply the weighted categorization rule to the set of documents to identify one more text spans from the set of documents;
compute a relevancy score for each of the one or more text spans extracted from the set of documents; and
select the one or more text spans extracted from the set of documents having the relevancy score greater than a predetermined threshold, wherein the greater the relevancy score, the greater a match between a text span of the one or more text spans and the string of the plurality of strings.

2. The non-transitory computer-readable medium of claim 1, wherein the language model is a Large Language Model (LLM).

3. The non-transitory computer-readable medium of claim 1, wherein the computer-readable instructions further cause the processor to:
execute a second language model to extract a plurality of second strings from the set of documents based on the prompt;
for each second string of the plurality of second strings:
parse the second string to generate a plurality of second tokens;
lemmatize each of the plurality of second tokens;
apply the part-of-speech label to each of the plurality of second tokens;
execute a second filtering operation to each of the plurality of second tokens to obtain a plurality of second filtered tokens;
automatically build a second weighted categorization rule from the plurality of second filtered tokens;
apply the weighted categorization rule to the set of documents to identify one or more second text spans from the set of documents;
compute the relevancy score for each of the one or more second text spans extracted from the set of documents; and
compare the relevancy score of the one or more second text spans with the relevancy score of the one or more text spans to compare the second language model with the language model, wherein the language model or the second language model that has a higher relevancy score has better performance.

4. The non-transitory computer-readable medium of claim 1, wherein the computer-readable instructions further cause the processor to:
compute a confidence score for each of the one or more text spans;
identify each of the one or more text spans having the confidence score greater than a threshold to obtain a subset of the one or more text spans;
identify the plurality of strings corresponding to the subset of the one or more text spans to obtain a subset of the plurality of strings; and
label a training data set based on the subset of the plurality of strings to train another language model.

5. The non-transitory computer-readable medium of claim 1, wherein to generate the plurality of tokens, lemmatize each of the plurality of tokens, and apply the part-of-speech label to each of the plurality of tokens, the computer-readable instructions further cause the processor to:
input the string into a tokenization model;
execute the tokenization model to convert the string into the plurality of tokens;
input the plurality of tokens into a part-of-speech tagging model;
execute the part-of-speech tagging model to:
determine a lemma for each of the plurality of tokens;
determine the part of speech label for each of the plurality of tokens; and
associate the lemma and the part of speech label with each of the plurality of tokens.

6. The non-transitory computer-readable medium of claim 5, wherein the part of speech label comprises one of a noun group, a verb group, an adverb group, an adjective group, a proper noun group, a noun, a verb, an adverb, an adjective, a proper noun, or a preposition.

7. The non-transitory computer-readable medium of claim 1, wherein to execute the filtering operation, the computer-readable instructions further cause the processor to:
execute a first filtering operation on each of the plurality of tokens based on at least one of a stop list or the part-of-speech label to obtain a plurality of first filtered tokens; and
execute a second filtering operation on the plurality of first filtered tokens based on at least one of one or more phrasal groupings or one or more entity types to obtain one or more second filtered tokens, wherein the weighted categorization rule is built based on the one or more second filtered tokens.

8. The non-transitory computer-readable medium of claim 7, wherein to execute the first filtering option, the computer-readable instructions further cause the processor to delete tokens from the plurality of tokens that match terms listed in the stop list.

9. The non-transitory computer-readable medium of claim 7, wherein to execute the first filtering option, the computer-readable instructions further cause the processor to delete tokens from the plurality of tokens whose part of speech label matches a predetermined part of speech label.

10. The non-transitory computer-readable medium of claim 7, wherein the one or more entity types are based on a domain of the set of documents.

11. The non-transitory computer-readable medium of claim 7, wherein to execute the second filtering option, the computer-readable instructions further cause the processor to:
input the plurality of first filtered tokens into an information extraction model;
execute the information extraction model to extract the one of one or more phrasal groupings or the one or more entity types;
identify a first filtered token from the plurality of first filtered tokens having the one or more phrasal groupings or the one or more entity types;
identify each term of the first filtered token;
identify other first filtered tokens from the plurality of first filtered tokens that do not have the one or more phrasal groupings or the one or more entity types as the part of speech label and that include the each term of the first filtered token; and
delete each of the other first filtered tokens to obtain the one or more second filtered tokens.

12. The non-transitory computer-readable medium of claim 11, wherein the one or more phrasal groupings comprises a noun group, a verb group, an adverb group, an adjective group, or a proper noun group.

13. The non-transitory computer-readable medium of claim 1, wherein to automatically build the weighted categorization rule from the one or more second filtered tokens, the computer-readable instructions further cause the processor to:
compute the term weight for each second filtered token of the one or more second filtered tokens using term weight=1/number_of_terms, where the term weight is the term weight for each token of the one or more second filtered tokens, and the number_of_terms is a number of tokens in the one or more second filtered tokens;
create an expression for each second filtered token of the one or more second filtered tokens, wherein each expression comprises the second filtered token, the term weight computed for the second filtered token, and a weighted AND operator;
combine each expression using an unweighted OR operator; and
create a syntactically valid rule from the combined expression.

14. The non-transitory computer-readable medium of claim 1, wherein to compute the relevancy score for each of the one or more text spans extracted from the set of documents, the computer-readable instructions further cause the processor to compute:
$$Relevancy Score = \frac{1}{1 + {e}^{( - k ( - 0.5 + {\sum }_{x ∈ A} term {weight}_{x} ) )}}$$
where the relevancy score is the relevancy score for each text span of the one or more text spans, k is a predefined positive coefficient value, term weight is the term weight for each token, x, of the plurality of filtered tokens, and A is a set of found tokens in the plurality of filtered tokens.

15. The non-transitory computer-readable medium of claim 1, wherein to select the one or more text spans extracted from the set of documents having the relevancy score greater than the predetermined threshold, the computer-readable instructions further cause the processor to:
select a first plurality of text spans from the one or more text spans whose relevancy score is greater than the predetermined threshold;
determine a number of terms in each of the first plurality of text spans; and
select one or more second text spans from the first plurality of text spans having a smallest number of terms in the first plurality of text spans.

16. The non-transitory computer-readable medium of claim 1, wherein the computer-readable instructions further cause the processor to:
determine that the text span comprises an extra term relative to a corresponding string of the plurality of strings; and
responsive to determining that the text span comprises the extra term, compute a confidence score using:
$$Confidence = Relevancy Score * ( 1 - \vert 1 - ( \frac{T * Relevancy Score}{M} ) \vert )$$
where Confidence is the confidence score for the text span, T is a maximum number of terms in the text span, and M is a number of terms in the text span that match a number of terms in the string, wherein the confidence score greater than a confidence threshold is indicative of a greater match between the string and the set of documents.

17. The non-transitory computer-readable medium of claim 1, wherein to automatically build the weighted categorization rule, the computer-readable instructions further cause the processor to perform synonym augmentation using a synonyms table.

18. The non-transitory computer-readable medium of claim 17, wherein the computer-readable instructions further cause the processor to create the synonyms table by:
identifying a content word from the set of documents;
determining a parent term for the content word;
determining a frequency of occurrence of one or more variants of the parent term in the set of documents;
creating a list of synonyms for the parent term responsive to determining that the frequency of occurrence is greater than a predetermined threshold; and
adding the parent term and the list of synonyms into the synonyms table.

19. The non-transitory computer-readable medium of claim 1, further comprising a companion model, wherein the companion rule is configured to detect presence of one or more of negation, doubt, historical status, present status, fantasy situation, or real situation in the set of documents, wherein output from the companion model is input into the rule-based model, and wherein the extracted one or more phrases from the set of documents are based on the one or more second filtered tokens and the output from the companion model.

20. The non-transitory computer-readable medium of claim 19, wherein the companion model is an information extraction model or a categorization model.

21. A system comprising:
a memory having computer-readable instructions stored thereon; and
a processor that executes the computer-readable instructions to:
execute a language model to extract a plurality of strings from a set of documents based on a prompt; and
validate the language model by confirming that information in the plurality of strings is found in at least one document of the set of documents, wherein to validate the language model, for each string of the plurality of strings, the computer-readable instructions further cause the processor to:
parse the string to generate a plurality of tokens;
lemmatize each of the plurality of tokens;
apply a part-of-speech label to each of the plurality of tokens;
execute a filtering operation on each of the plurality of tokens that have been lemmatized and to which the part-of-speech labels have been applied to obtain a plurality of filtered tokens;
automatically build a weighted categorization rule based on the plurality of filtered tokens, wherein building the weighted categorization rule comprises computing a term weight for each token of the plurality of filtered tokens;
apply the weighted categorization rule to the set of documents to identify one or more text spans from the set of documents;
compute a relevancy score for each of the one or more text spans extracted from the set of documents; and
select the one or more text spans extracted from the set of documents having the relevancy score greater than a predetermined threshold, wherein the greater the relevancy score, the greater a match between a text span of the one or more text spans and the string of the plurality of strings.

22. The system of claim 21, wherein the language model is a Large Language Model (LLM).

23. The system of claim 21, wherein the computer-readable instructions further cause the processor to:
execute a second language model to extract a plurality of second strings from the set of documents based on the prompt;
for each second string of the plurality of second strings:
parse the second string to generate a plurality of second tokens;
lemmatize each of the plurality of second tokens;
apply the part-of-speech label to each of the plurality of second tokens;
execute a second filtering operation to each of the plurality of second tokens to obtain a plurality of second filtered tokens;
automatically build a second weighted categorization rule from the plurality of second filtered tokens;
apply the weighted categorization rule to the set of documents to identify one or more second text spans from the set of documents;
compute the relevancy score for each of the one or more second text spans extracted from the set of documents; and
compare the relevancy score of the one or more second text spans with the relevancy score of the one or more text spans to compare the second language model with the language model, wherein the language model or the second language model that has a higher relevancy score has better performance.

24. The system of claim 21, wherein the computer-readable instructions further cause the processor to:
compute a confidence score for each of the one or more text spans;
identify each of the one or more text spans having the confidence score greater than a threshold to obtain a subset of the one or more text spans;
identify the plurality of strings corresponding to the subset of the one or more text spans to obtain a subset of the plurality of strings; and
label a training data set based on the subset of the plurality of strings to train another language model.

25. The system of claim 21, wherein to generate the plurality of tokens, lemmatize each of the plurality of tokens, and apply the part-of-speech label to each of the plurality of tokens, the computer-readable instructions further cause the processor to:
input the string into a tokenization model;
execute the tokenization model to convert the string into the plurality of tokens;
input the plurality of tokens into a part-of-speech tagging model;
execute the part-of-speech tagging model to:
determine a lemma for each of the plurality of tokens;
determine the part of speech label for each of the plurality of tokens, wherein the part of speech label comprises one of a noun group, a verb group, an adverb group, an adjective group, a proper noun group, a noun, a verb, an adverb, an adjective, a proper noun, or a preposition; and
associate the lemma and the part of speech label with each of the plurality of tokens.

26. The system of claim 21, wherein to execute the filtering operation, the computer-readable instructions further cause the processor to:
execute a first filtering operation on each of the plurality of tokens based on at least one of a stop list or the part-of-speech label to obtain a plurality of first filtered tokens, wherein to execute the first filtering option, the computer-readable instructions further cause the processor to delete tokens from the plurality of tokens that match terms listed in the stop list or delete tokens from the plurality of tokens whose part of speech label matches a predetermined part of speech label; and
execute a second filtering operation on the plurality of first filtered tokens based on at least one of one or more phrasal groupings or one or more entity types to obtain one or more second filtered tokens, wherein the weighted categorization rule is built based on the one or more second filtered tokens.

27. The system of claim 26, wherein to execute the second filtering option, the computer-readable instructions further cause the processor to:
input the plurality of first filtered tokens into an information extraction model;
execute the information extraction model to extract the one of one or more phrasal groupings or the one or more entity types, wherein the one or more phrasal groupings comprises a noun group, a verb group, an adverb group, an adjective group, or a proper noun group;
identify a first filtered token from the plurality of first filtered tokens having the one or more phrasal groupings or the one or more entity types;
identify each term of the first filtered token;
identify other first filtered tokens from the plurality of first filtered tokens that do not have the one or more phrasal groupings or the one or more entity types as the part of speech label and that include the each term of the first filtered token; and
delete each of the other first filtered tokens to obtain the one or more second filtered tokens.

28. The system of claim 21, wherein to automatically build the weighted categorization rule from the one or more second filtered tokens, the computer-readable instructions further cause the processor to:
compute the term weight for each second filtered token of the one or more second filtered tokens using term weight=1/number_of_terms, where the term weight is the term weight for each token of the one or more second filtered tokens, and the number_of_terms is a number of tokens in the one or more second filtered tokens;
create an expression for each second filtered token of the one or more second filtered tokens, wherein each expression comprises the second filtered token, the term weight computed for the second filtered token, and a weighted AND operator;
combine each expression using an unweighted OR operator; and
create a syntactically valid rule from the combined expression.

29. A method comprising:
executing, by a processor executing computer-readable instructions stored on a memory, a language model to extract a plurality of strings from a set of documents based on a prompt; and
validating, by the processor, the language model by confirming that information in the plurality of strings is found in at least one document of the set of documents, wherein to validate the language model, for each string of the plurality of strings, the method comprises:
parsing, by the processor, the string to generate a plurality of tokens;
lemmatizing, by the processor, each of the plurality of tokens;
applying, by the processor, a part-of-speech label to each of the plurality of tokens;
executing, by the processor, a filtering operation on each of the plurality of tokens that have been lemmatized and to which the part-of-speech labels have been applied to obtain a plurality of filtered tokens;
automatically building, by the processor, a weighted categorization rule based on the plurality of filtered tokens, wherein building the weighted categorization rule comprises computing a term weight for each token of the plurality of filtered tokens;
applying, by the processor, the weighted categorization rule to the set of documents to identify one or more text spans from the set of documents;
computing, by the processor, a relevancy score for each of the one or more text spans extracted from the set of documents; and
selecting, by the processor, the one or more text spans extracted from the set of documents having the relevancy score greater than a predetermined threshold, wherein the greater the relevancy score, the greater a match between a text span of the one or more text spans and the string of the plurality of strings.

30. The method of claim 29, wherein the language model is a Large Language Model (LLM).
